(19) United States
(12) Patent Application Publication
(10) Pub. No.: US 2007/0043577 A1
(43) Pub. Date: Feb. 22, 2007

(54) Apparatus and method of enabling a victim of identity theft to resolve and prevent fraud

(76) Inventor: Sheldon Kasower, Canoga Park, CA (US)

Correspondence Address: MARC E. HANKIN, ESQ., 11414 THURSTON CIRCLE, LOS ANGELES, CA, 90049, US

(21) Appl. No.: 11/205,549

(22) Filed: Aug. 16, 2005

(51) Int. Cl. G06Q 99/00

(52) U.S. Cl. 705/1

(57) ABSTRACT

A web-based application method that allows victims of identity theft to rectify and prevent further fraudulent activity is comprised of communicating with a central system and receiving a series of actions and prompts by the system. The invention also allows the user to obtain general information relating to the various types of fraud and gives the user the ability to store and be able to archive all information relating to the fraud in one convenient place. Once the user has been guided through all of these actions, all necessary action will have been taken to rectify the present fraud, and also to prevent further fraudulent activity from occurring.

### FIELD OF INVENTION

This invention relates, generally, to a method of rectifying and preventing further fraudulent activity once a user realizes s/he has been exposed to identity theft. More particularly the invention relates to a web based application that enables a user to communicate in appropriate form, directly through a web browser, to police departments, federal and state agencies, credit grantors and credit bureaus. The communication steps include mail, email, telephone, and other appropriate methods including in-person visits, as necessary. The invention also gives the user the ability to upload and store related documents for effective organization and ease of retrieval.

### BACKGROUND

Identity theft is a crime in which an imposter obtains key pieces of information, such as Social Security and driver's license numbers, and uses it for his or her improper personal gain. The imposters can obtain new credit accounts; re-direct the mail and telephone calls from existing credit accounts; sign up for unwanted and often expensive services; order subscriptions; order and take delivery of products; and otherwise “become” the individual whose identity has been stolen, minus the conscience and fiscal responsibility. Currently, people can only determine if they are (or may have been) victims of identity theft through frequent monitoring of their credit information on file with the three major credit bureaus. Unfortunately, even if they discover a problem, often these victims do not realize what is necessary to do to bring an offender to justice. Effective communication is often the key to rectifying and preventing further fraudulent activity. Victims undergoing identity theft must determine which agency to contact because failure to do so timely will result in exacerbation of the fraud. Resolving these theft issues also requires access to pertinent information, which is typically not available from a single source.

The three credit bureaus currently offer to add a “fraud alert message” on the victim's credit report. However, this type of fraud alert must be placed with each credit bureau individually and may remain on the victim's credit report for ninety days to a period of seven years. While this is useful for preventing some additional attempts of identity theft, it does not protect the consumer completely. A lot of creditors report to only one of the bureaus, and sometimes to none. Therefore, additional steps have to be taken to make sure that the individual does not become a victim of additional fraud. Moreover, the bureaus make suggestions to the victim, for instance to inform all creditors of the fraud, and to document all contacts made with creditors. Nevertheless, these bureaus do not offer a centralized system to perform all of these actions, or to store and archive such communications.

Therefore, there has been a long felt need in the art for a method that enables victims of identity theft to rectify such fraud and to defend themselves against further violations.

### SUMMARY OF THE INVENTION

This invention is directed towards providing a system that users/victims of identity theft can use to communicate with appropriate agencies, and to maintain and organize their communications for evidentiary and personal purposes.

The invention discloses a method of notifying appropriate agencies by entering information into a system computer via an internet connection, determining a case action plan to be performed by the System based on analysis of the information, displaying in the web browser window of a user a case action plan as determined by the System, electing an action to take by the user based on the case action plan, completing a service report, and notifying an appropriate agency once the action elected by the user is transmitted back to the System.

In an embodiment of the invention, the information entered is obtained from a case profile interview. In another embodiment, information entered is obtained from a scope profile interview.

In a further embodiment, the System emails the user confirmation of user's position in the entire process.

In another embodiment, the invention maintains the transaction information persistent across multiple independent transaction sessions.

In an embodiment, the invention allows the user to upload documents into the System.

In one embodiment of the invention, the user is able to contact the System's representative for help with the process.

In a further embodiment of the invention, the user is able to access web links that contain information relevant to fraud.

In yet another embodiment, the invention archives transactions. Further, the invention can print records of sessions and other information.

Accordingly, it is an object of the present invention to enable victims of identify theft to rectify their corrupt records and defend their credit from further misuse by an unauthorized third party.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the many figures.

FIG. 1 is a block diagram overview of the basic system configuration.

FIG. 2 is a flow chart of a Case Profile Interview part 1.

FIG. 3 is a flow chart of a Case Profile Interview part 2.

FIG. 4 is a flow chart of a Case Profile Interview part 3.

FIG. 5 is a flow chart of a Case Profile Interview part 4.

FIG. 6 is a flow chart of a Case Profile Interview part 5.

FIG. 7 is a flow chart of a Case Profile Interview part 6.

FIG. 8 is a flow chart of a Scope Interview part 1.

FIG. 9 is a flow chart of a Scope Interview part 2.

FIG. 10 is a flow chart of a Scope Interview part 3.

FIG. 11 is a flow chart of a Scope Interview part 4.

FIG. 12 is a flow chart of a Scope Interview part 5.

FIG. 13 is a flow chart of a Scope Interview part 6.

FIG. 14 is a flow chart of a Case Action Plan part 1.

FIG. 15 is a flow chart of a Case Action Plan part 2.

FIG. 16 is a flow chart of a Case Action Plan part 3.

FIG. 17 is a flow chart of a Case Action Plan part 4.

FIG. 18 is a flow chart of a Service Police report part 1.

FIG. 19 is a flow chart of a Service Police report part 2.

FIG. 20 is a flow chart of a Service Police report part 3.

FIG. 21 is a flow chart of a Service Credit Bureau report 1.

FIG. 22 is a flow chart of a Service Credit Bureau report 2.

FIG. 23 is a flow chart of a Service Credit Bureau report 3.

FIG. 24 is a flow chart of a Service Credit Bureau report 4.

FIG. 25 is a flow chart of a Social Security report.

FIG. 26 is a flow chart of a Service IFC report.

FIG. 27 is a flow chart of a Service card issuer report part 1.

FIG. 28 is a flow chart of a Service card issuer report part 2.

FIG. 29 is a flow chart of a Service card issuer report part 3.

FIG. 30 is a flow chart of a Service card issuer report part 4.

FIG. 31 is a flow chart of a Service card issuer report part 5.

FIG. 32 is a flow chart of a Service card issuer report part 6.

FIG. 33 is a flow chart of a Service card issuer report part 7.

FIG. 34 is a flow chart of a Service Mail affect report.

FIG. 35 is a flow chart of a Service Banks report 1.

FIG. 36 is a flow chart of a Service Banks report 2.

FIG. 37 is a flow chart of a Service Banks report 3.

FIG. 38 is a flow chart of a Service Banks report 4.

FIG. 39 is a flow chart of a Service Banks report 5.

FIG. 40 is a flow chart of a Service Banks report 6.

FIG. 41 is a flow chart of a Service DMV report 1.

FIG. 42 is a flow chart of a Service DMV report 2.

FIG. 43 is a flow chart of a Service DMV report 3.

FIG. 44 is a flow chart of a Service IRS report 1.

FIG. 45 is a flow chart of a Service IRS report 2.

FIG. 46 is a flow chart of a Service IRS report 3.

FIG. 47 is a flow chart of a Service IRS report 4.

FIG. 48 is a flow chart of a Service State Tax Board report 1.

FIG. 49 is a flow chart of a Service State Tax Board report 2.

FIG. 50 is a flow chart of a Service State Tax Board report 3.

FIG. 51 is a flow chart of a Service State Tax Board report 4.

FIG. 52 is a flow chart of a Service Utilities report 1.

FIG. 53 is a flow chart of a Service Utilities report 2.

FIG. 54 is a flow chart of a Service US State Department report.

FIG. 55 is a flow chart of a Service Collection Agency report 1.

FIG. 56 is a flow chart of a Service Collection Agency report 2.

FIG. 57 is a flow chart of a Service Collection Agency report 3.

FIG. 58 is a flow chart of a Service FTC report.

FIG. 59 is a flow chart of a Service Auto Insurer report 1.

FIG. 60 is a flow chart of a Service Auto Insurer report 2.

FIG. 62 is a flow chart of a Service Miscellaneous report 1.

FIG. 63 is a flow chart of a Service Check verification companies report.

FIG. 64 shows an email to be sent back to user under the category of social security notifications.

FIG. 65 shows a formatted letter that user will use to notify the Social Security Administration Department.

FIG. 66 shows emails formatted to be automatically generated for user under the category of bank notifications.

FIG. 67 shows additional emails formatted to be automatically generated for user under the category of bank notifications.

FIG. 68 shows a user signature block that is automatically generated for the user under the category of bank notifications.

FIG. 69 shows letters formatted to be automatically generated for user under the category of bank notifications.

FIG. 70 shows emails formatted to be automatically generated for user under the category of credit bureau notifications.

FIG. 71 shows additional emails formatted to be automatically generated for user under the category of credit bureau notifications.

FIG. 72 shows additional emails formatted to be automatically generated for user under the category of credit bureau notifications.

FIG. 73 shows additional emails formatted to be automatically generated for user under the category of credit bureau notifications.

FIG. 74 shows additional emails automatically generated for the user under the category of credit bureau notifications.

FIG. 75 shows emails automatically generated for user under the category of credit bureau notifications.

FIG. 76 shows additional emails automatically generated for user under the category of credit bureau notifications and a signature block.

FIG. 77 shows emails formatted to be automatically generated for user under the category of credit bureau notifications.

FIG. 78 shows emails formatted to be automatically generated for user under the category of credit bureau notifications.

FIG. 79 shows emails formatted to be automatically generated for user under the category of credit bureau notifications.

FIG. 80 shows emails formatted to be automatically generated for user under the category of credit bureau notifications.

FIG. 81 shows emails formatted to be automatically generated for user under the category of credit DMV notifications.

FIG. 82 shows a signature block to be automatically generated for user under the category of credit DMV notifications.

FIG. 83 shows an email and a letter formatted to be automatically generated for user under the category of Postal Inspector notifications.

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

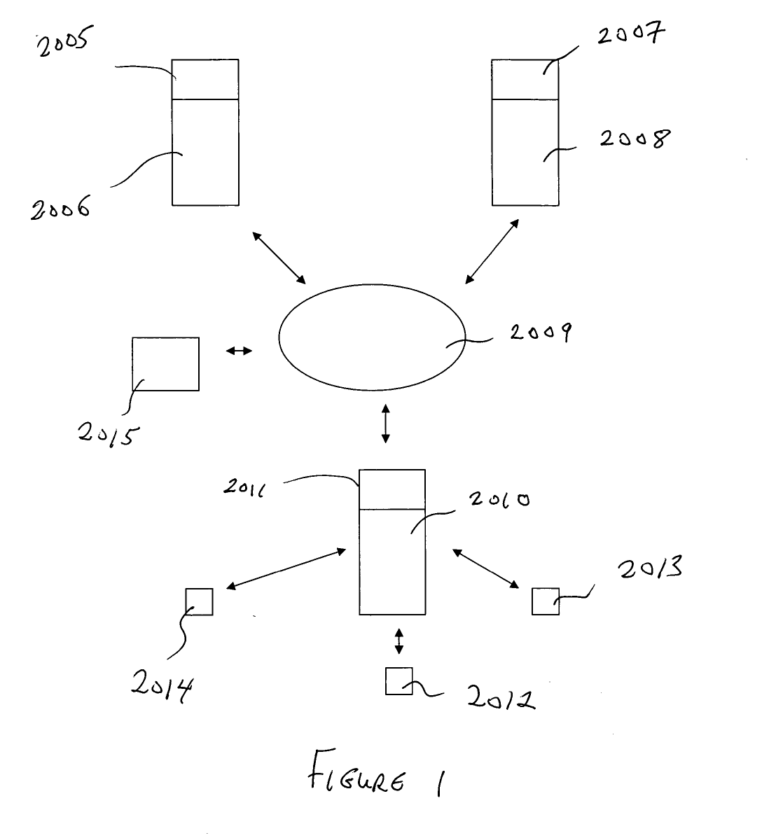

FIG. 1 illustrates a preferred embodiment of Applicant's invention wherein a basic system configuration is provided for entering data, determining a case action plan, election by user of an action to take, and notification to an appropriate agency.

The System 2010 can be used with an internet network 2009, and more particularly, the World Wide Web (web) to connect up with the user or appropriate agencies 2015. According to one construction, users' computers 2006 and 2008, are linked to system 2010. The users' computers 2006 and 2008 include web browsers 2005 and 2007, respectively, and a web document. The web browsers comprise software programs configured to enable a user to access files from any computer that is connected with the Internet 2009.

The System 2010 comprises a web server 2011, database 2012, and processor 2013. For purposes of this disclosure, the term “web server” is understood to include one or more computers located at one or more physical locations and having a hardware component that serves code and data to the web. The web server computer has a software program that receives, manages, and responds to requests for documents and files. Furthermore, it is understood that web servers 2005, 2007, and 2013 can include other hardware such as one or more data storage devices, such as a hard disk drive (HDD); memory, such as random access memory (RAM); interface devices, such as a display screen, keyboard, and/or a tactile input device; and a web site 2014.

The web site 2014 is viewable by a user with a web browser, and includes a database and one or more web pages. The web pages allow the users to submit and obtain information related to the identity theft incident. These web pages comprise electronic pages or documents that includes text and/or graphics, audio, video, and/or other dynamic media. For purposes of this disclosure, individual web pages can be active and include “hot buttons”, “clickable icons”, and/or “links” which will also be referred to hereinafter as “triggers”. Triggers enable the launching of a simple application-software program and/or access to linked pages, linked web pages, and/or scanning and uploading (using PDF or similar formats) documents they receive from an appropriate agency. This uploading function permits all documents related to the identity theft to be stored, archived and retrieved from one convenient location, the System 2010. There are also triggers that allow the user to request assistance from the System representative and/or request an in-person visit when necessary.

It is understood that the database within the web site includes a collection of inter-related and/or non-related data including links (including web links) that are stored together on the web server computer data base. Such data is accessible by user 2006 and/or user 2008. Further, these links allow users to search their own records and access other pertinent information related to the issue of identity thefts in general.

Other than using desk-top computers, users can also use wireless web appliances to remotely communicate with the System 2010 over the Internet 2009. It is understood that the wireless web-enabled appliance can be a telephone, an electronic organizer and any of a number of types of computers, or any other device capable of displaying computer-generated information on a screen.

In one embodiment, the entire process for the victim of identity theft begins with a user/victim connecting up to the System 2010 and viewing the System's pages. The user then opens a new case profile, enters data into the corresponding Case Profile Interview and Scope Interview pages. Once the System has this information, it will produce a Case Action Plan. After the Case Action Plan is complete, the user will be directed to the appropriate Service plan(s) which s/he is to use. Moreover, every time the user logs into the System, the user will see the recommended Services plans (or steps) to follow, and the status of their progress.

Throughout the process, the user will be prompted with options by the System 2010. These options fall into the “essential”, “recommended” or “optional” categories. Further, the System 2010 will remind the user of the time when certain actions are required to be taken by the user.

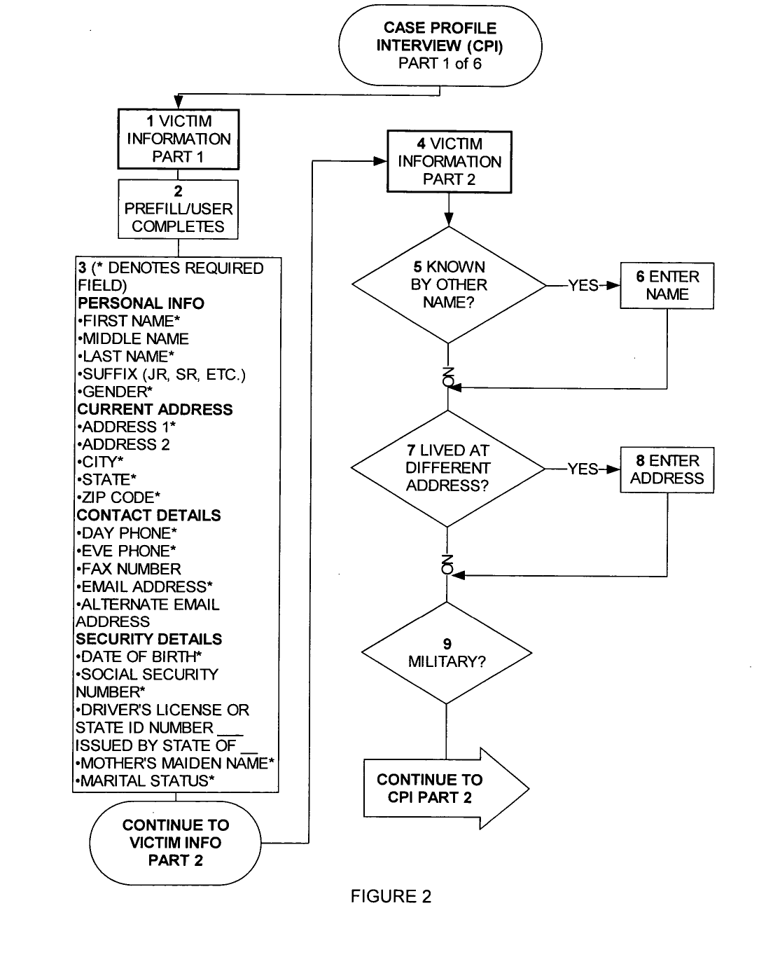

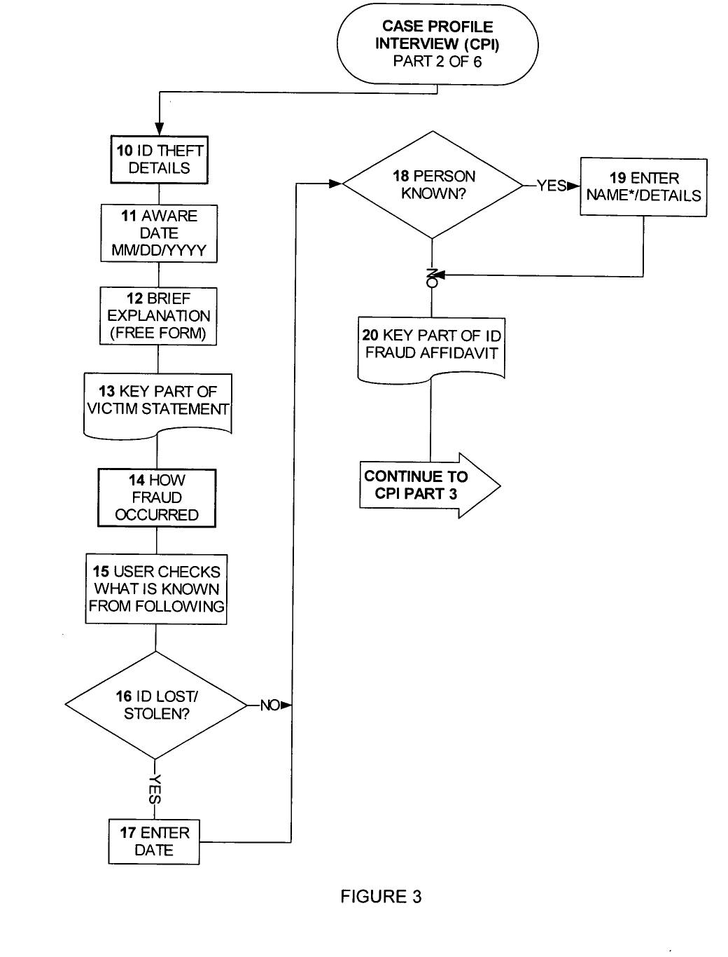

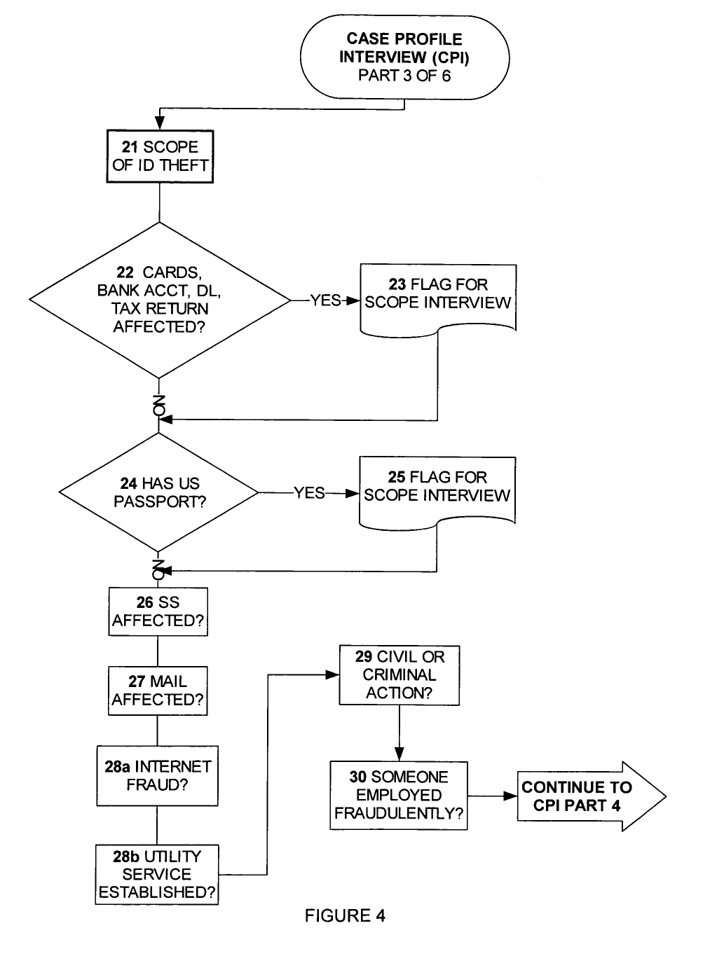

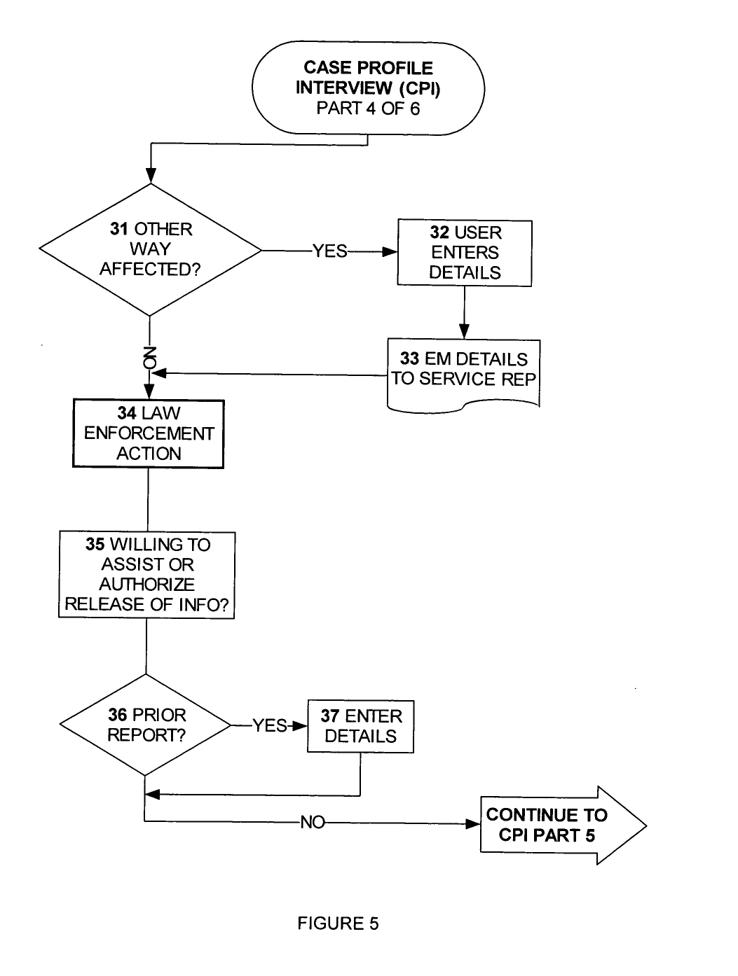

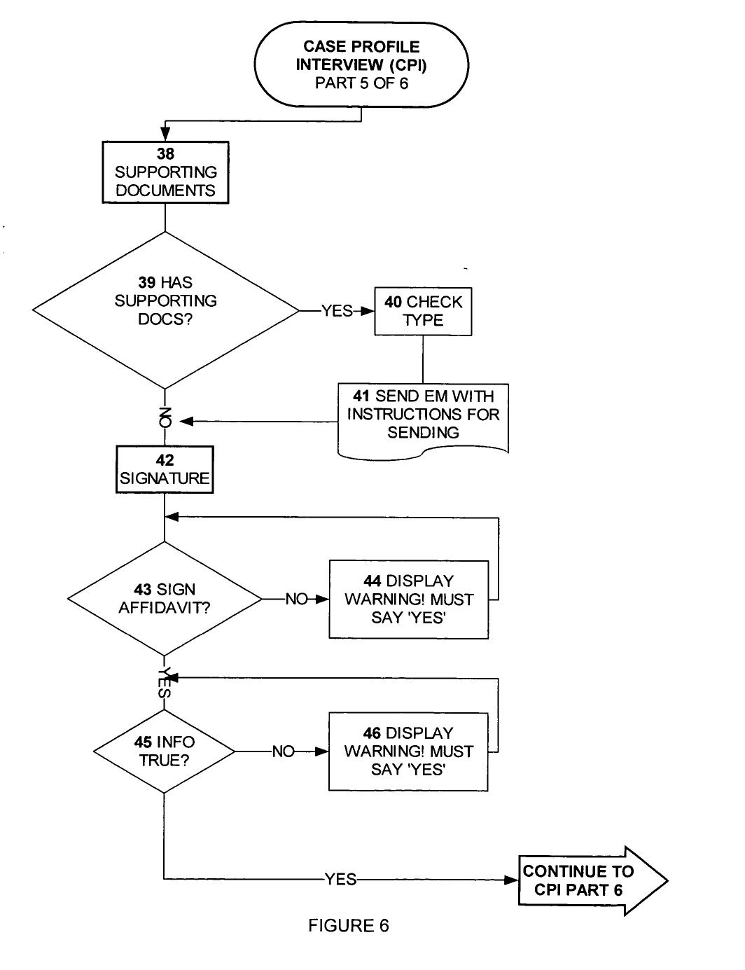

FIG. 2 shows the first part of a three part flow chart of typical information a user is required to complete at the Case Profile Interview stage of the process. Certain responses by the user within the Case Profile Interview will act as a positive “flag” to be used by the System when it generates other web pages for the user. For instance, in FIG. 4 step 24 when the user informs the System that US passports were stolen, the System will issue a positive “flag” for user in the later Scope Interview stage of the process. Alternatively, if the user informs the System that US postal mail is affected 27, the System will issue a positive “flag” for the user at the Case Profile Interview stage of the process.

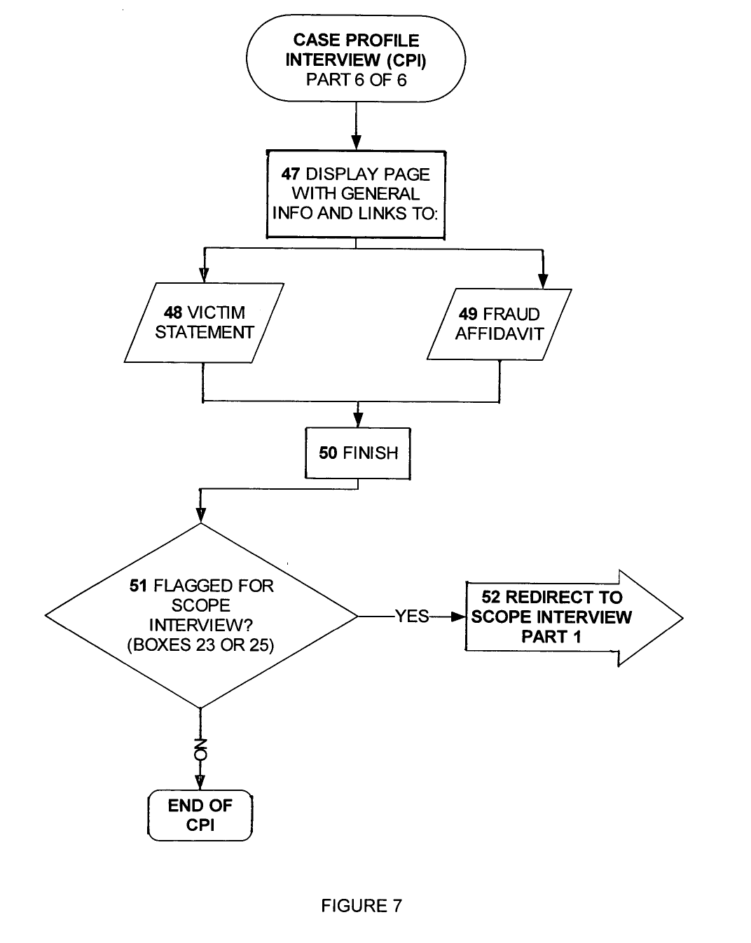

In FIG. 7, at the end of the Case Profile Interview stage, the user is asked to electronically sign an affidavit of the details of the fraud incident and affirm that all the details entered are true and correct. The user then has the ability to leave the Case Interview Profile in an unfinished state and return to complete the process at a later time, or it may canceled altogether.

If the user answered certain responses in the positive during the Case Interview Profile, the System will prompt the user that more information will be needed at the Scope Interview stage. All positive responses in the Scope Interview stage will trigger a Case Action Plan.

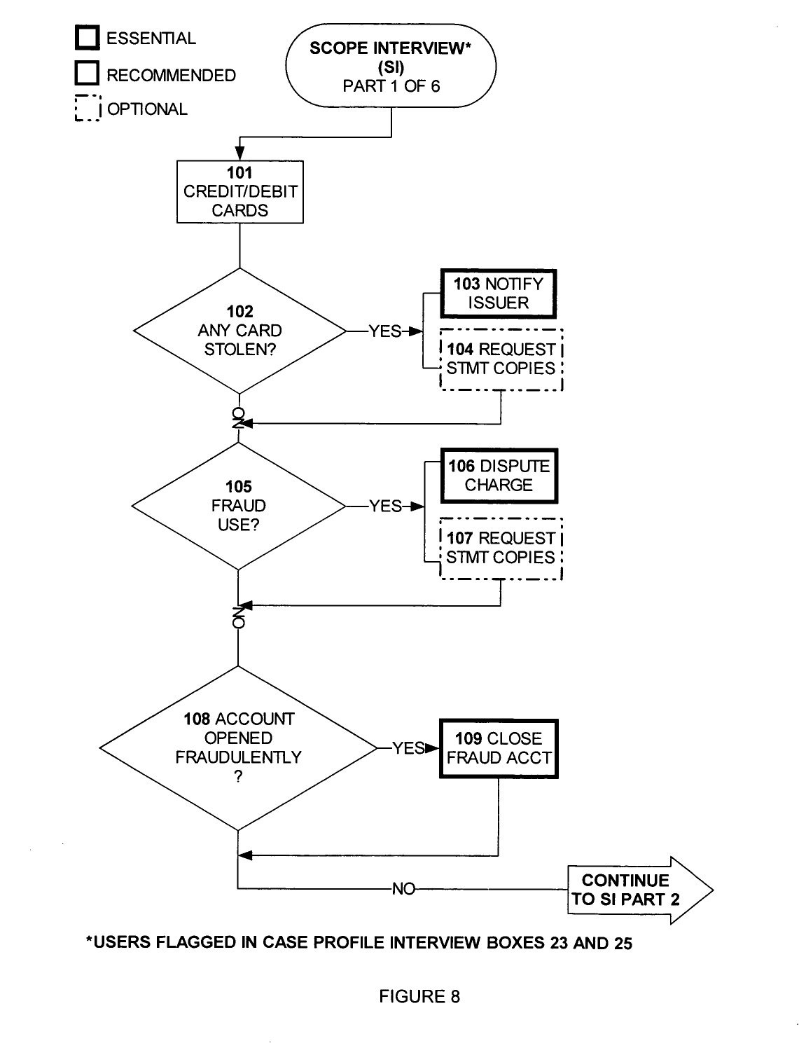

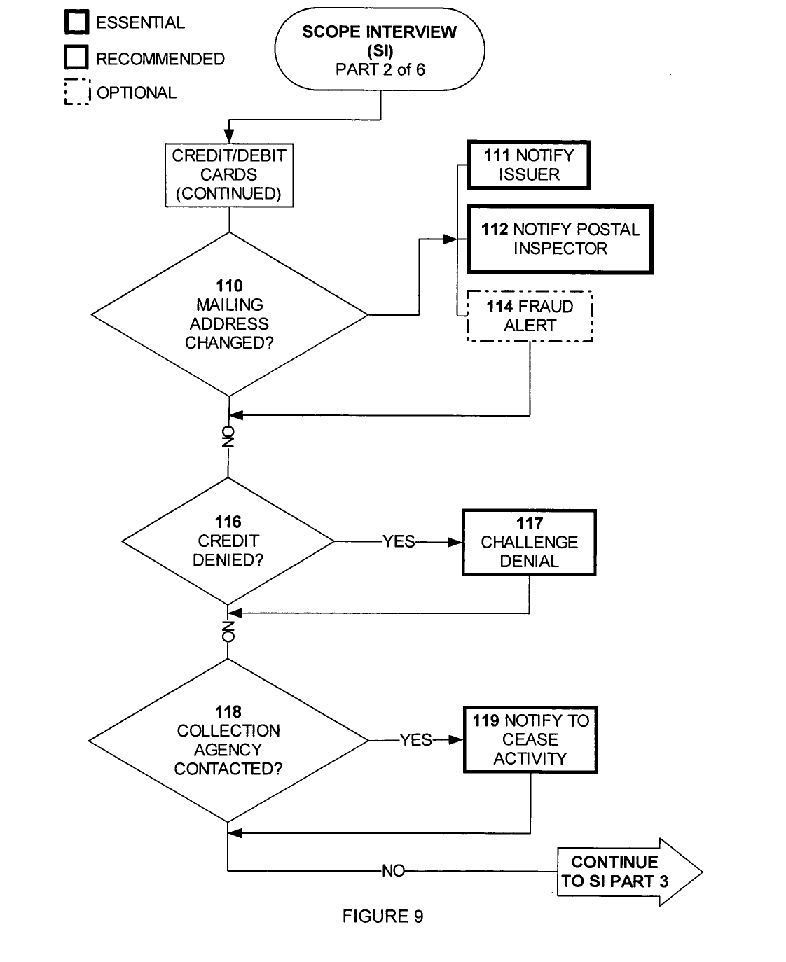

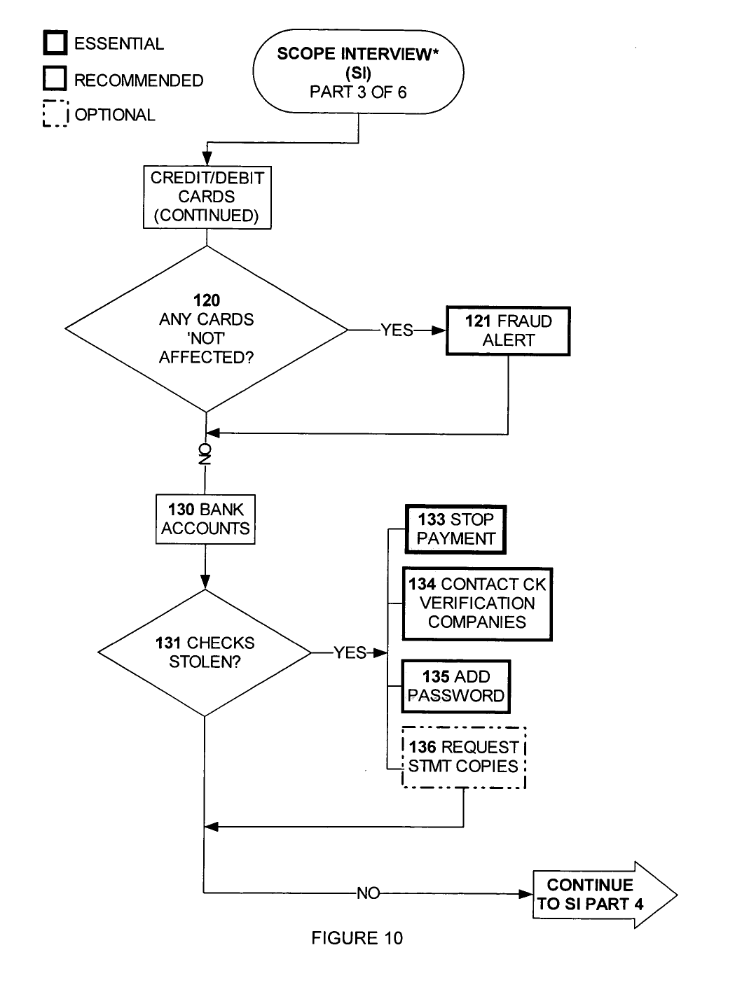

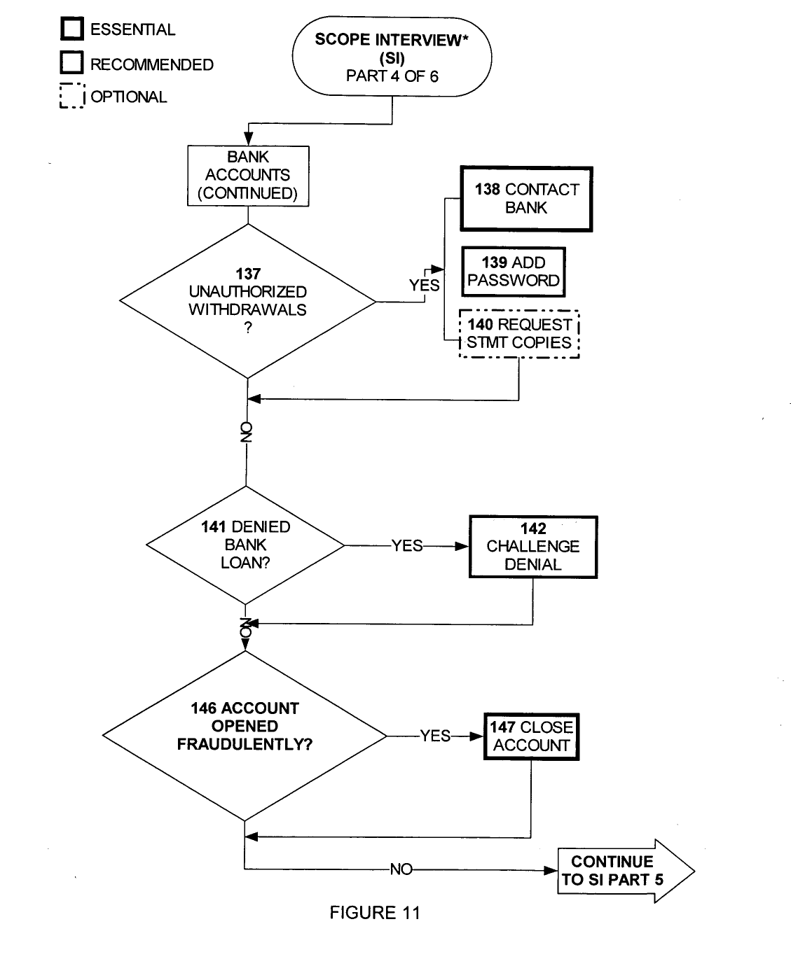

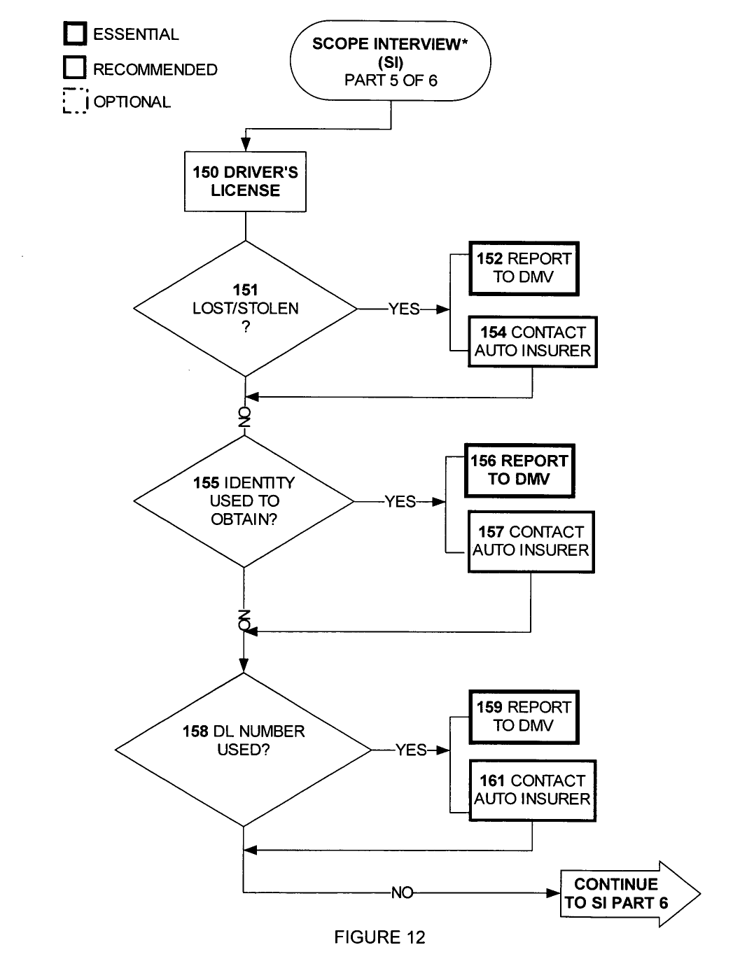

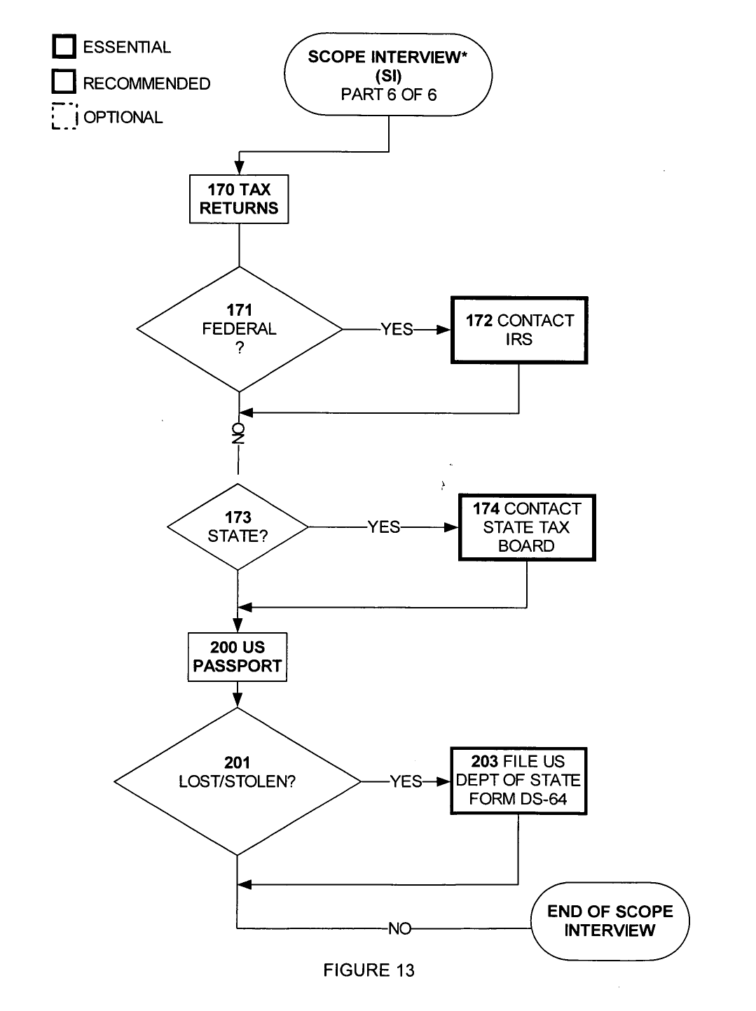

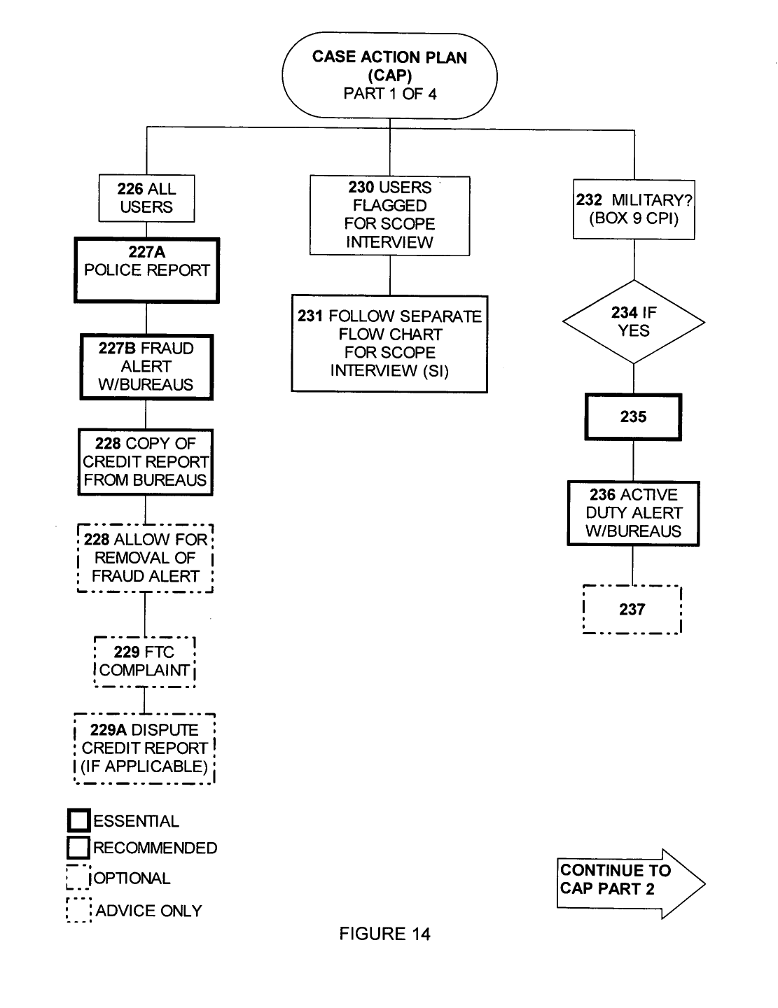

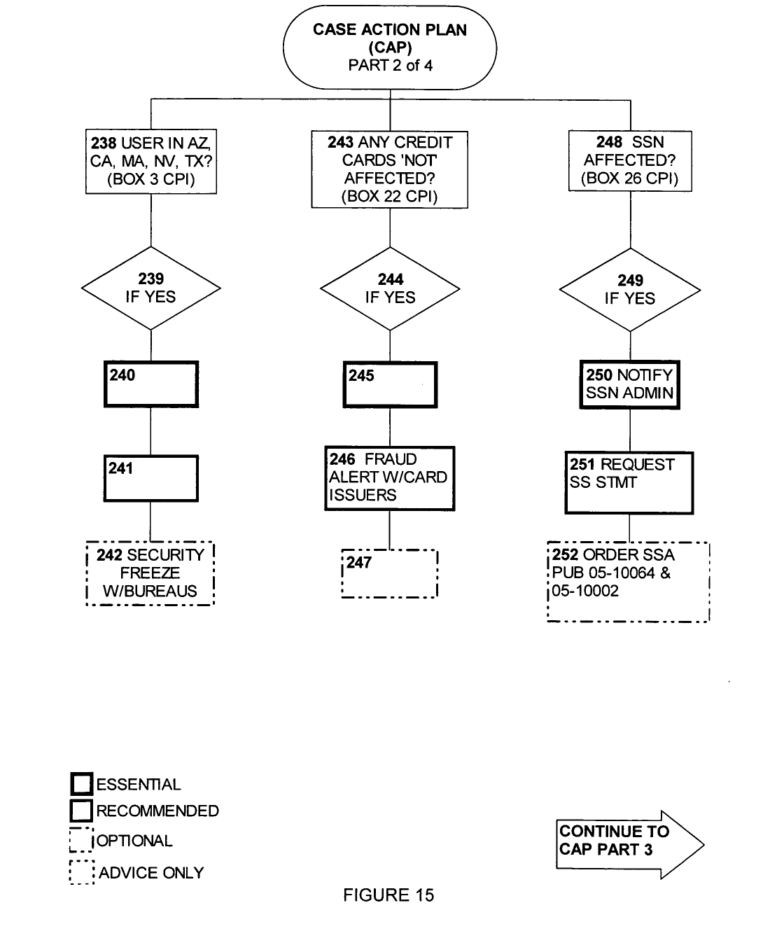

The System 2010 requests from the user information relating to, but not limited to, whether credit cards were lost or stolen; credit cards were used fraudulently; a new card account was opened fraudulently; the mailing address has been changed; credit has been denied; some credit cards have not been affected; checks have been stolen; there has been an unauthorized withdrawal; a bank loan has been denied; a new bank account has been opened fraudulently; a driver's license has been lost or stolen; an identity has been used to obtain a driver's license; a driver's license number has been used fraudulently; a federal tax return has been affected; and/or whether a state tax return has been affected. These questions are shown on FIGS. 8-13.

In FIG. 8, steps 101 and 102, once the user informs the System that his credit cards have been stolen, the System will prompt the user that an “essential” action is for the user to notify the issuer of these stolen cards 103, and that an “optional” action is for the user to request credit card statement copies 104. Alternatively, if the user informs the System that a bank account was opened during the fraud, the System will prompt that an “essential” option is for the user to close the fraudulent account 109.

Once both the Case Profile Interview and the Scope Interview have been completed by the user, the System will produce a Case Action Plan for the user, consisting of essential actions, recommended actions, optional actions, and further web links that provide general information on fraud.

The Case Action Plan will maintain uploaded information and notes entered by the user; determine items requiring follow-up by the user; determine system notifications to agencies and entities; and monitor the progress of the user's advancement through the System's identity theft process.

The System 2010 also allows any letters or documents sent by agencies, in response to user's initial communications, to be scanned as PDF documents (or in any other appropriate form), and then be uploaded into the System 2010 using the appropriate “button” on the web page. This uploading function allows the user to organize all communications relating to the fraud in one convenient place, the System 2010.

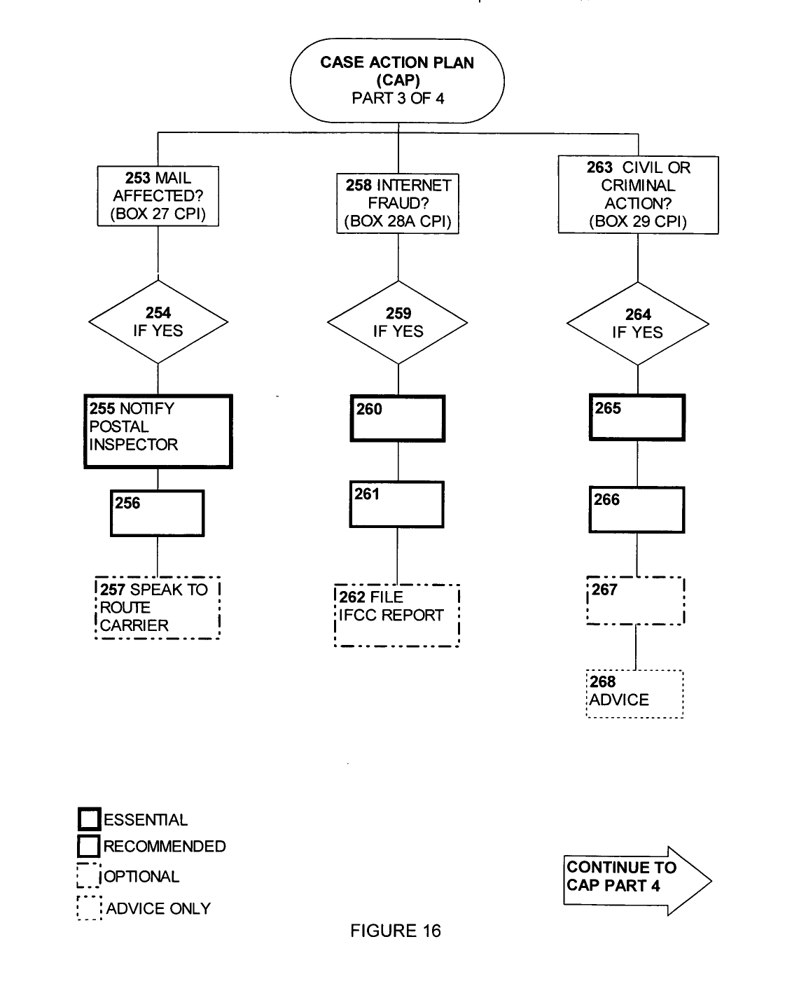

FIG. 16 shows the outcome when a user informs the System that the fraud affects mail 253. In response, the System prompts the user in the Case Action Plan that an “essential” action for the user is to inform the Postal Inspector 255, and an “optional” action will be for the user to notify the postal route carrier 257. Alternatively, if the user informs the System that his or her social security number has been affected 248, then the System prompts that an “essential” action for the user is to notify the Social Security Administration 250, whereas a “recommended” action will be to request a social security statement 251, and an “optional” action will be to order publications 05-10064 and 05-10002 from the Social Security Administration 252.

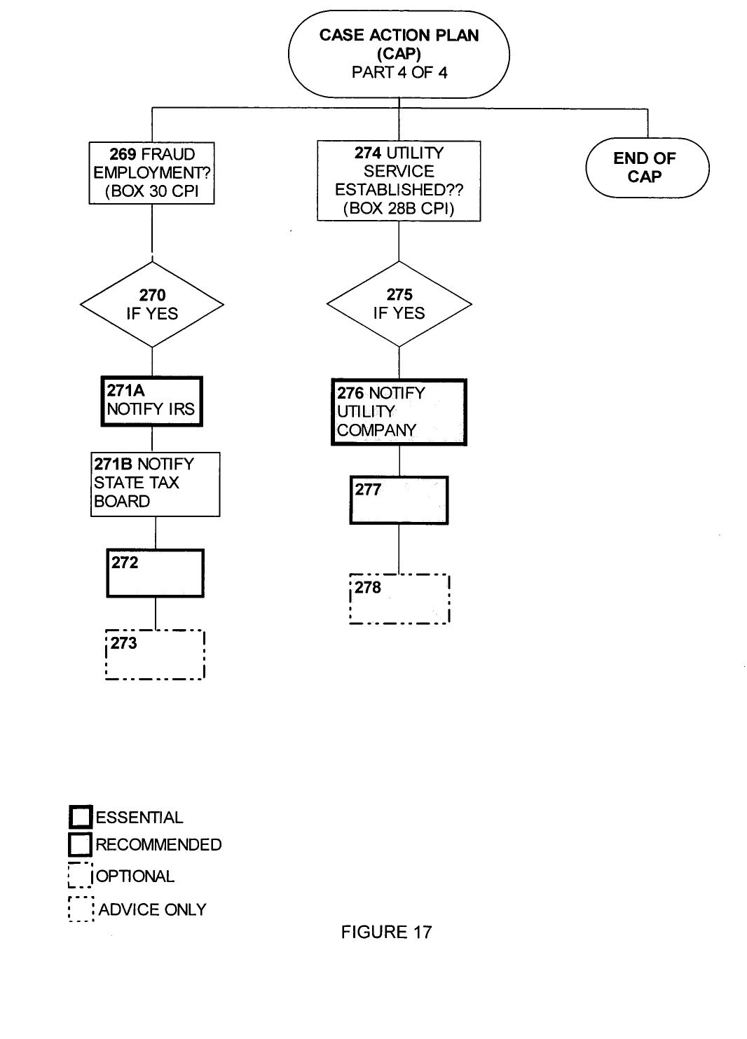

In FIG. 17 when the user informs the System that the fraud affects his or her employment 269, the System prompts the user that an “essential” action for user to take is to notify the IRS and the State Tax Board 271.

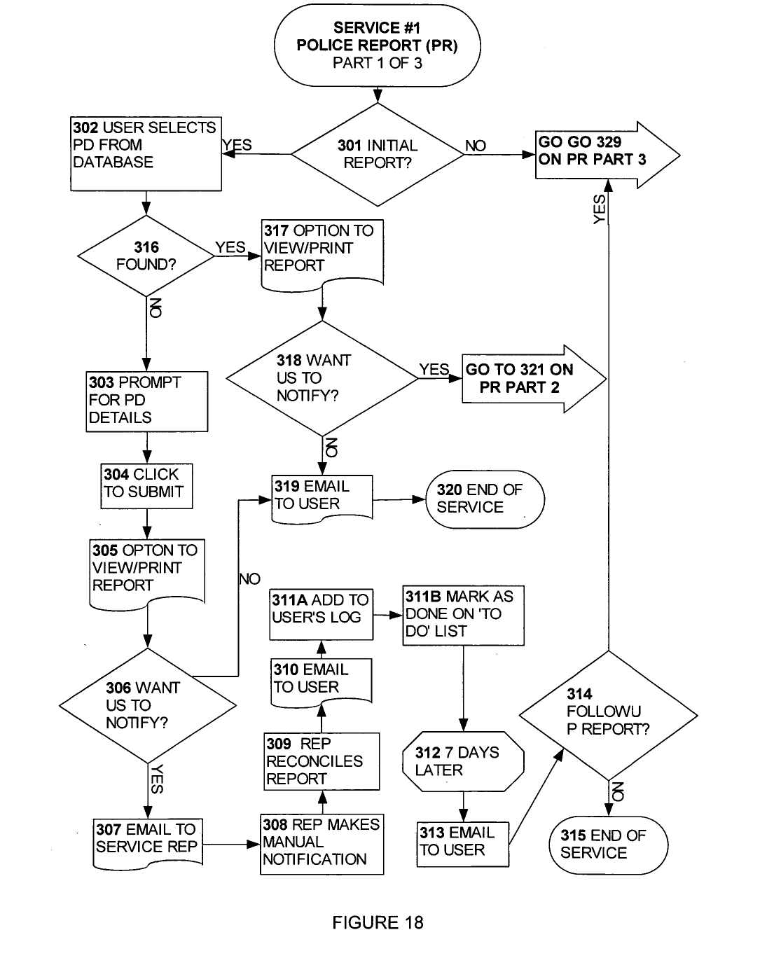

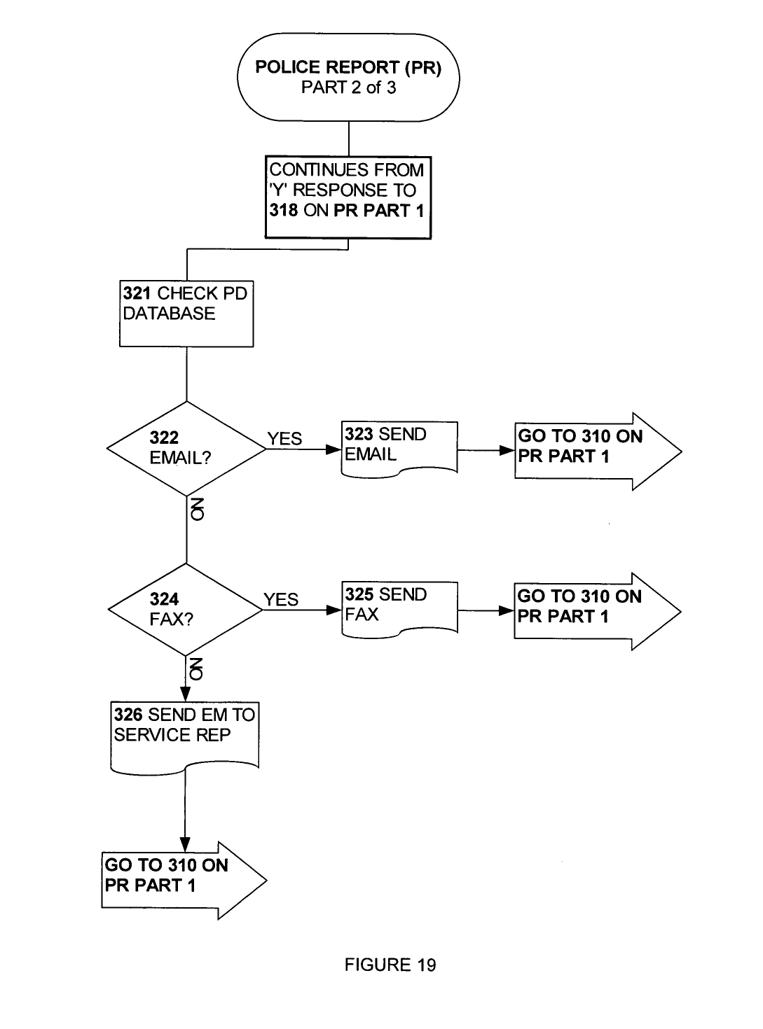

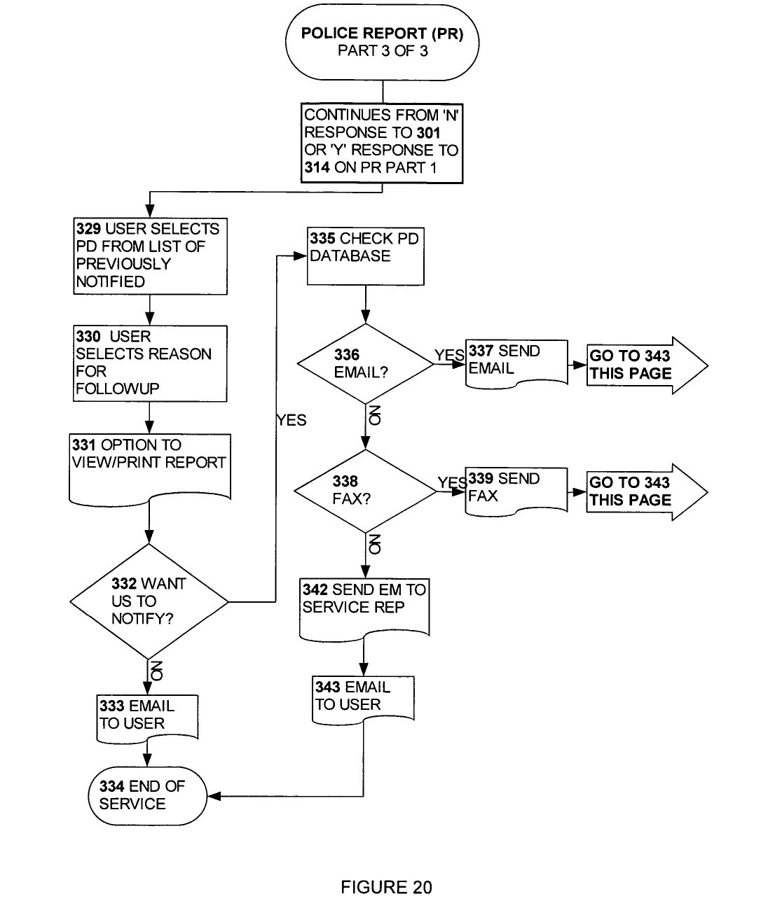

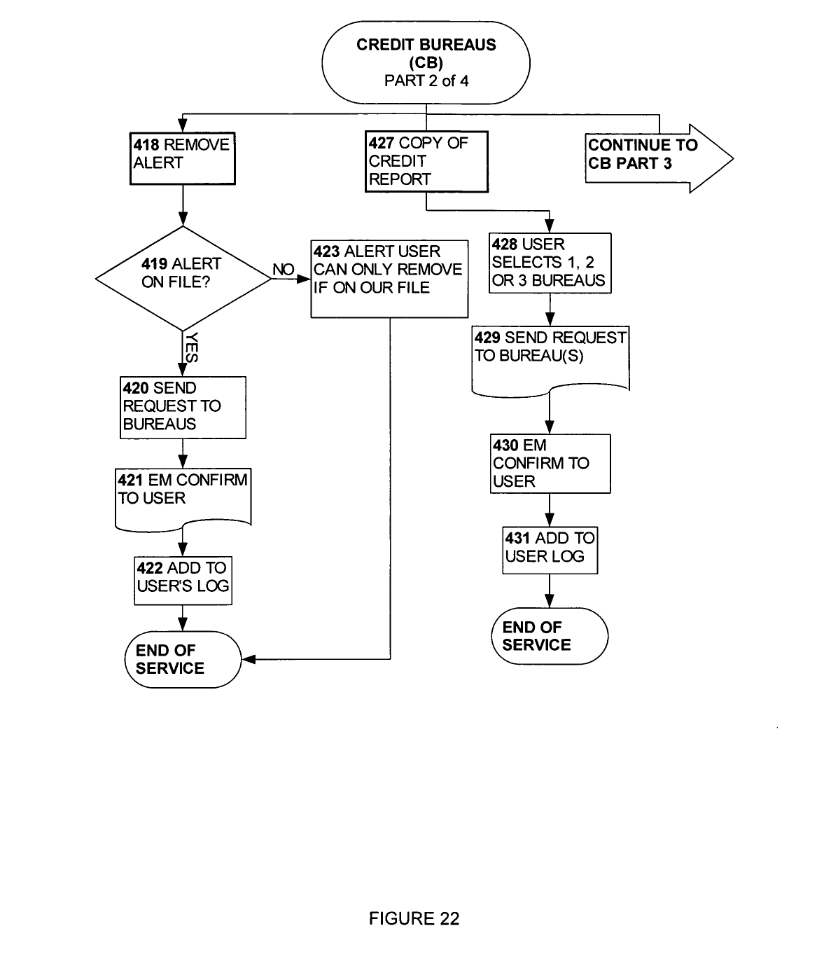

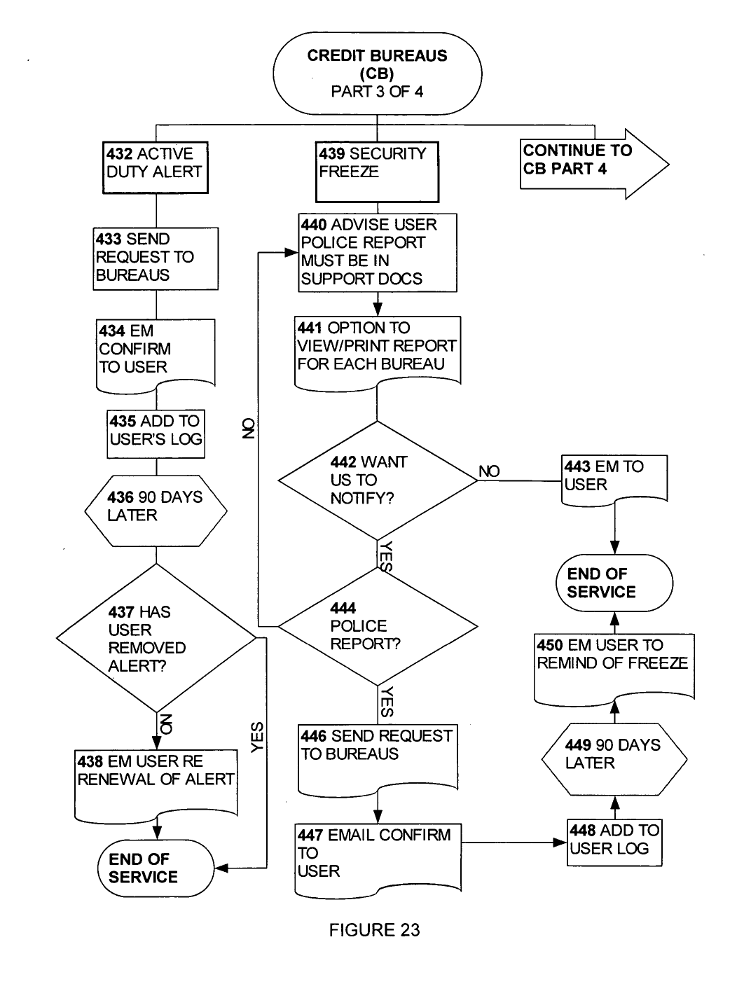

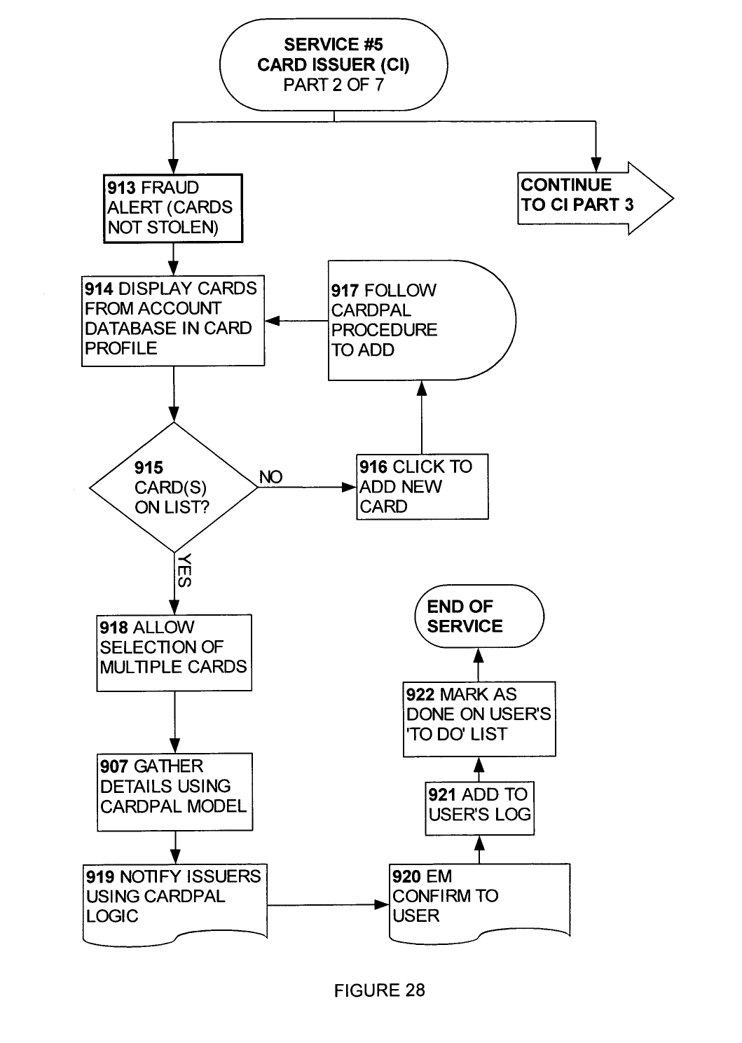

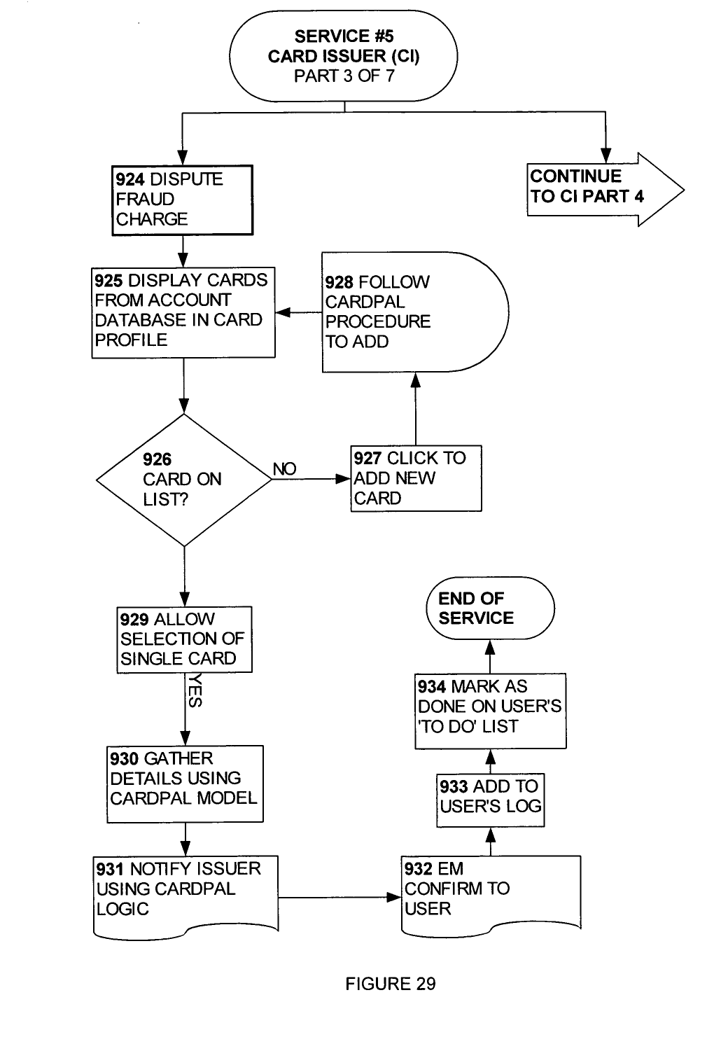

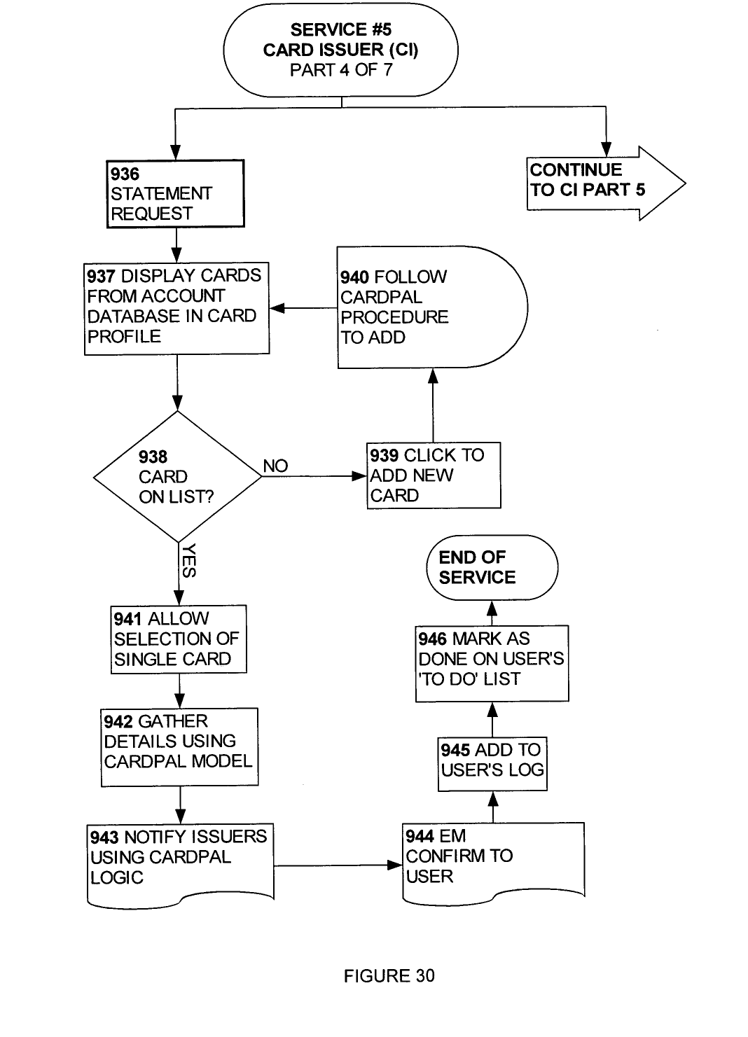

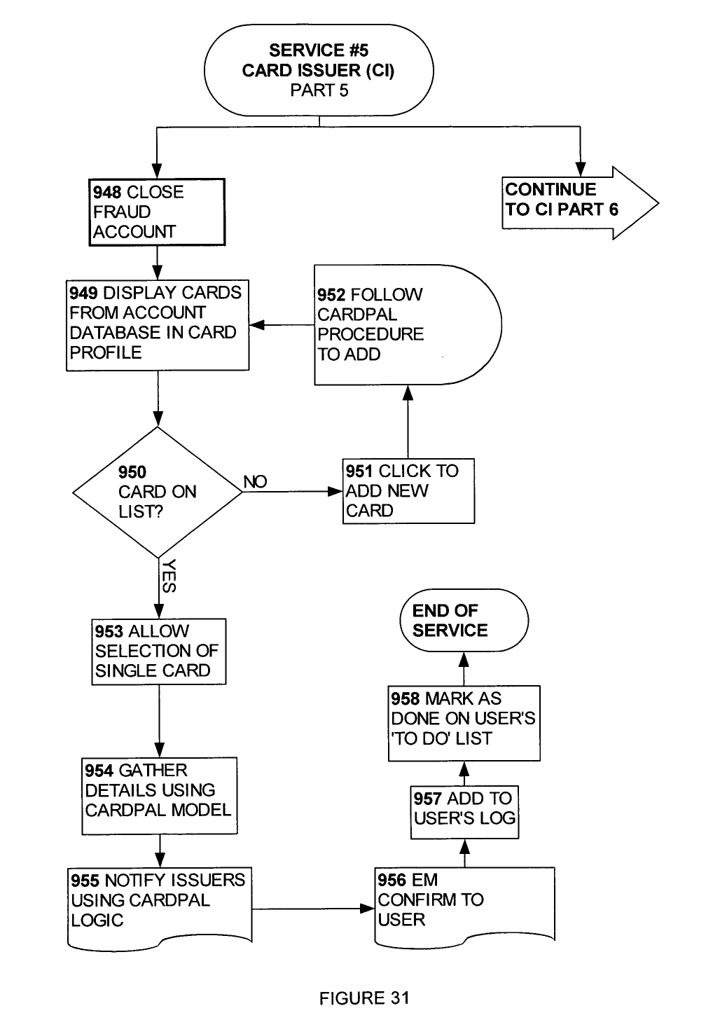

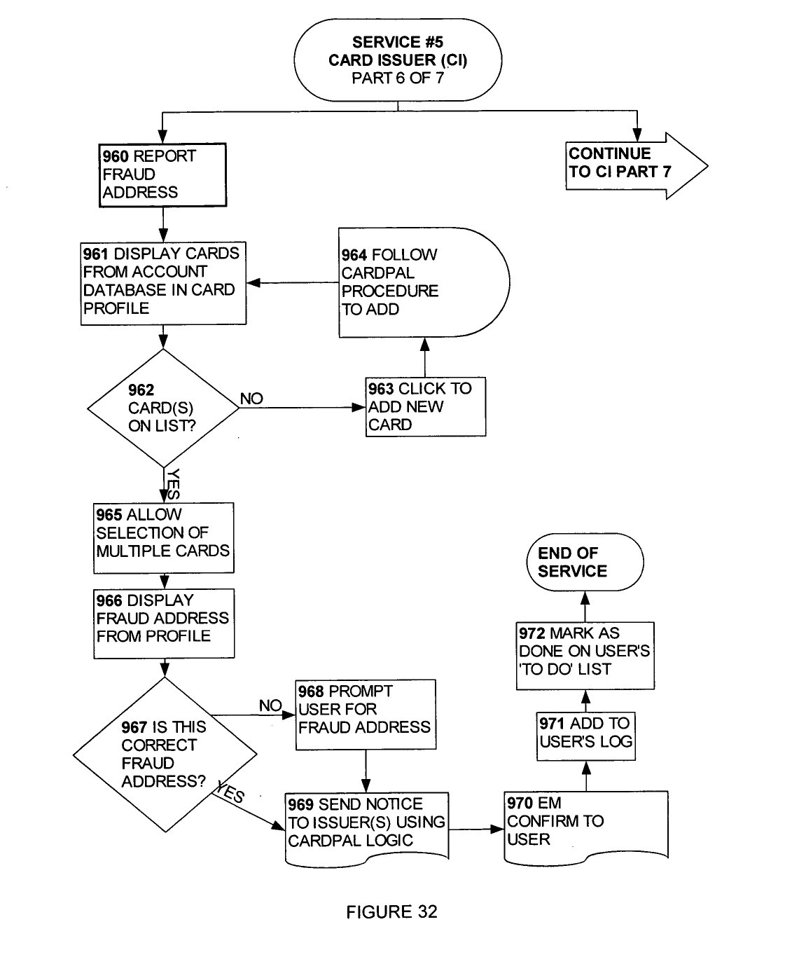

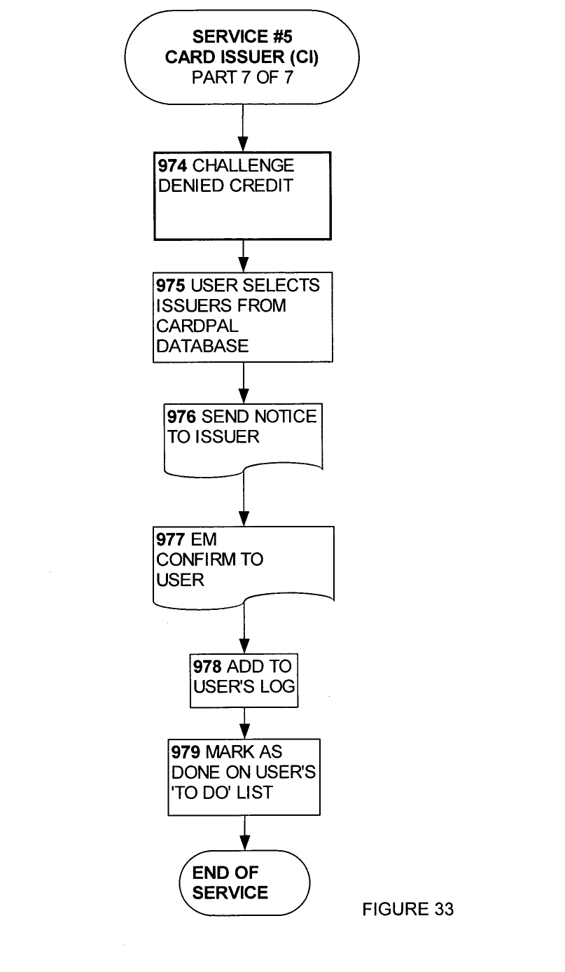

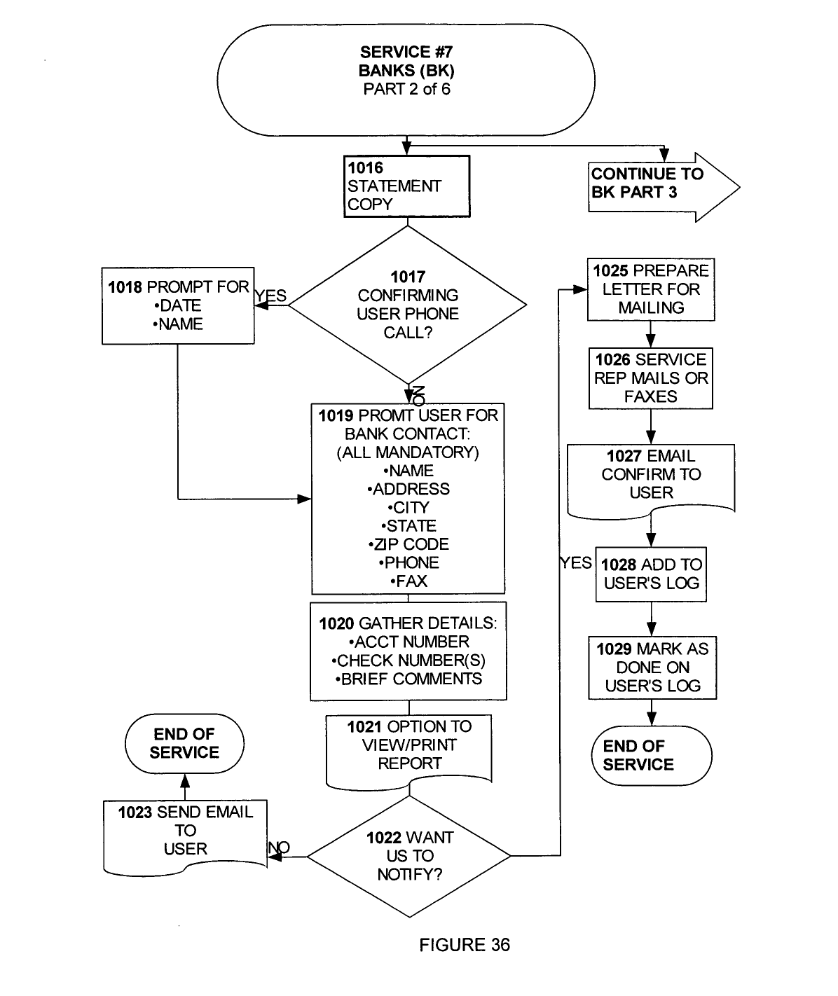

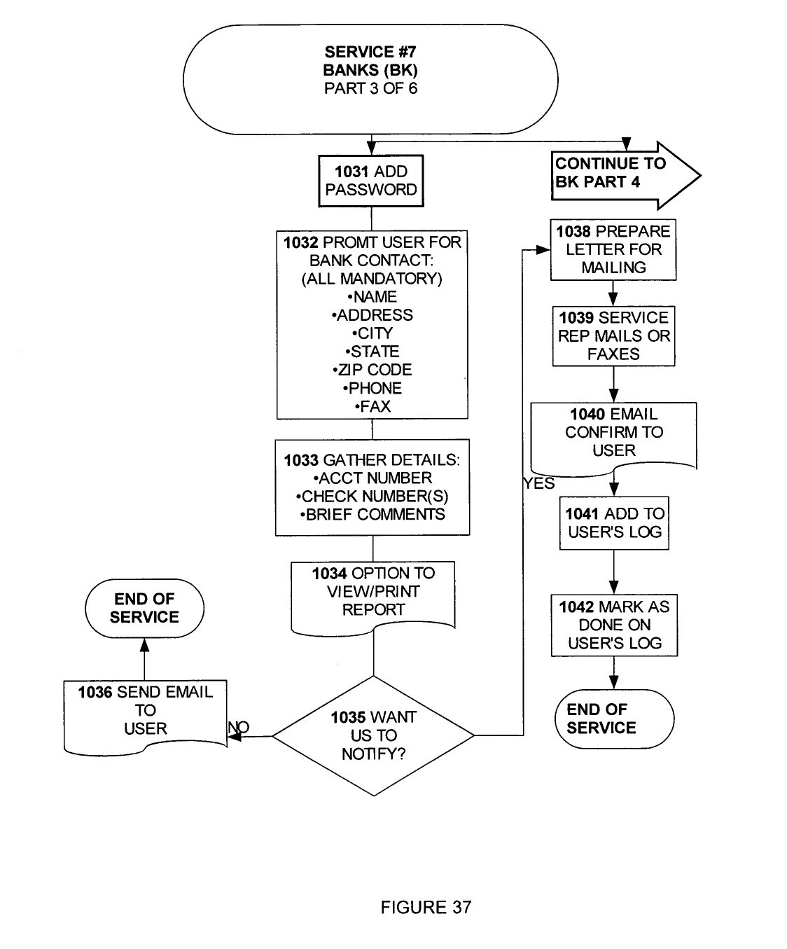

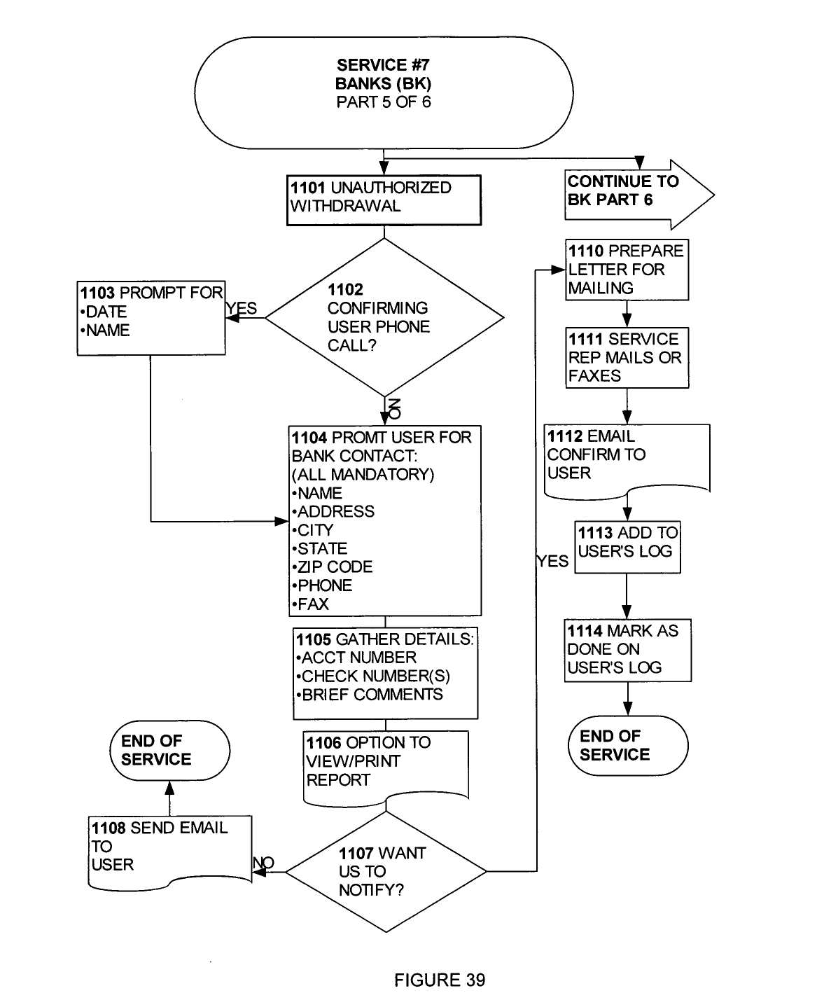

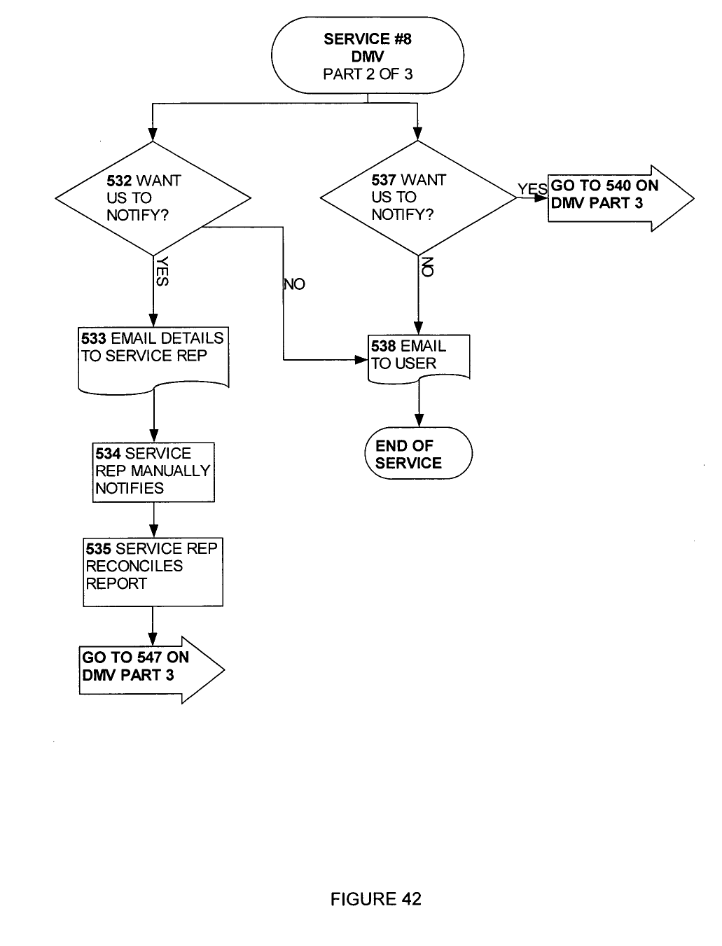

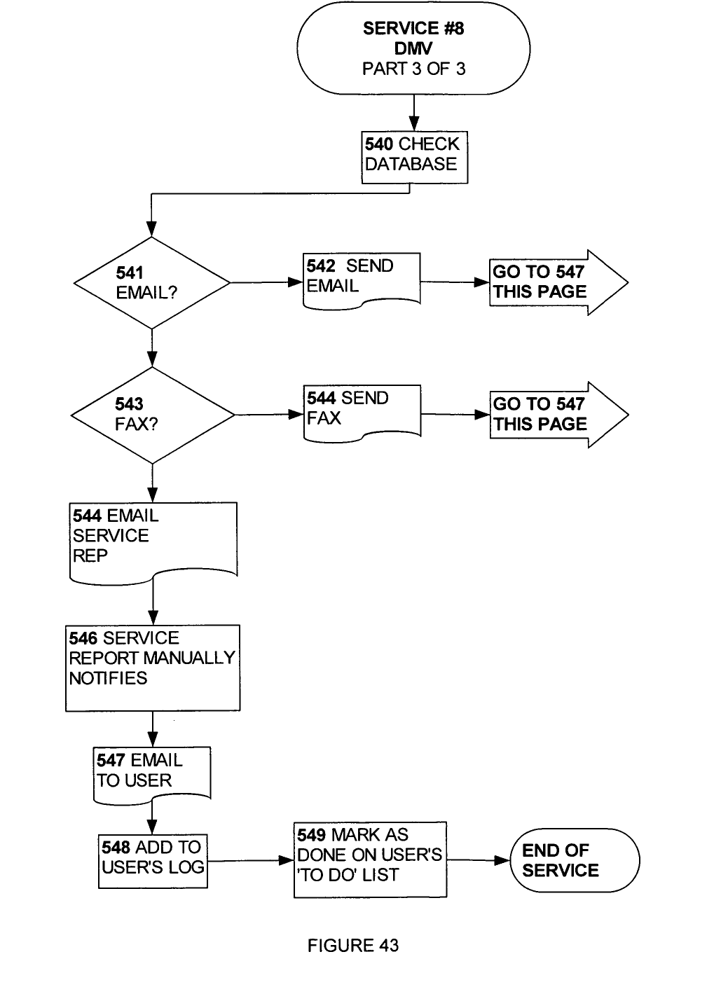

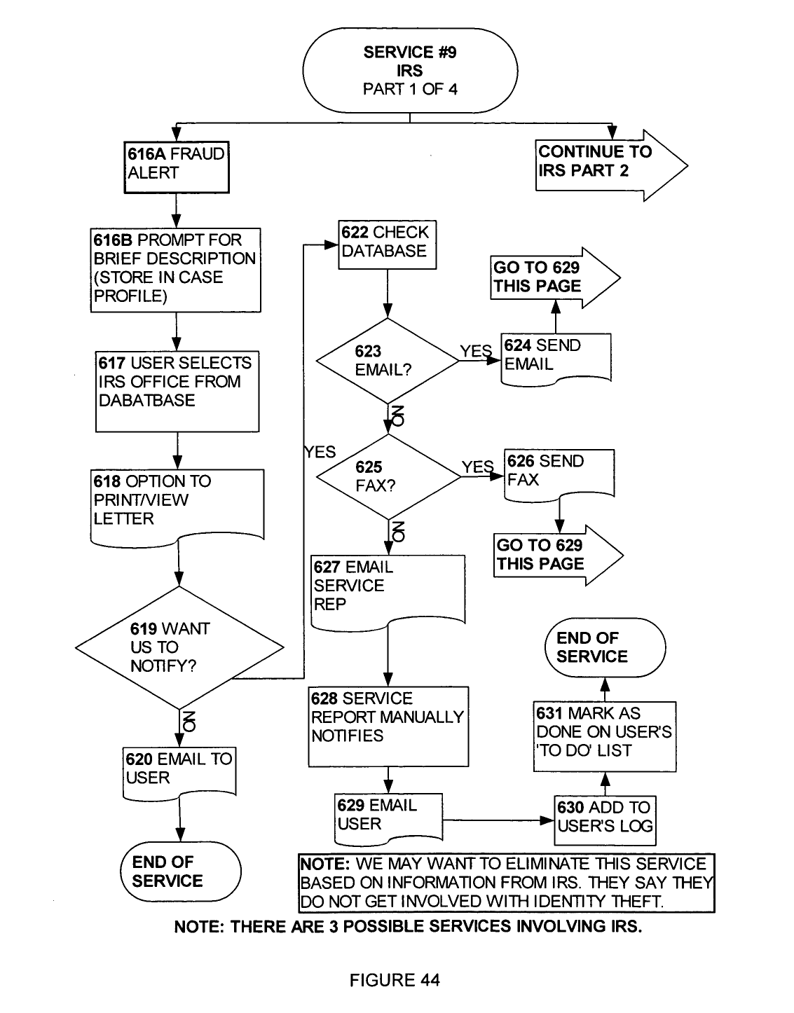

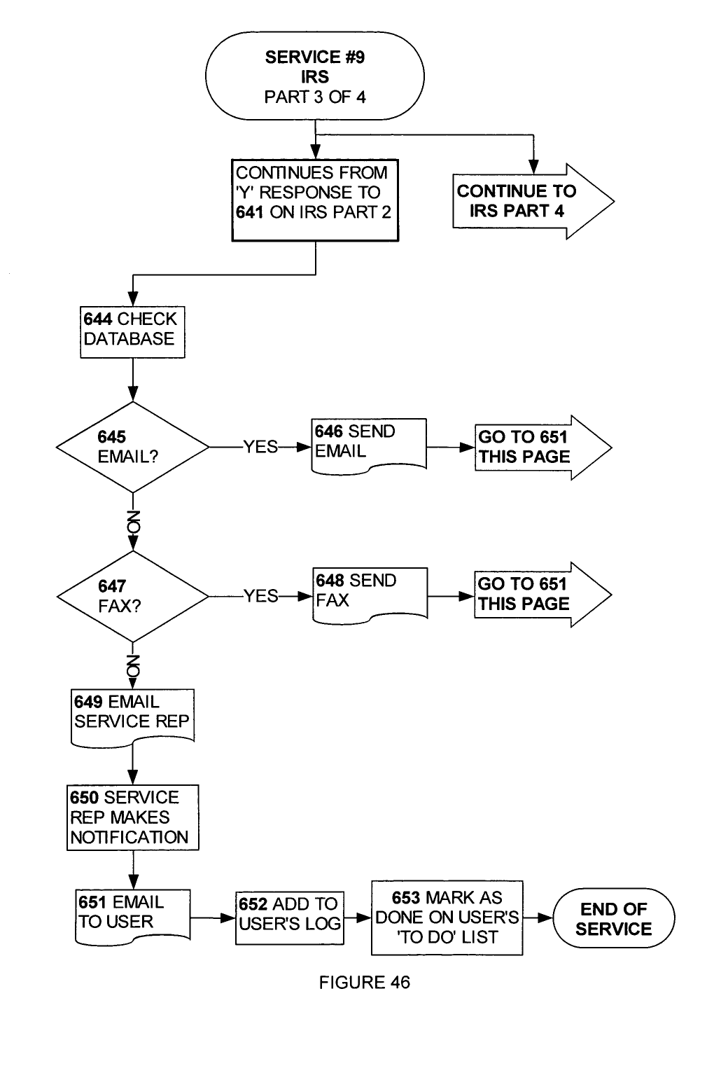

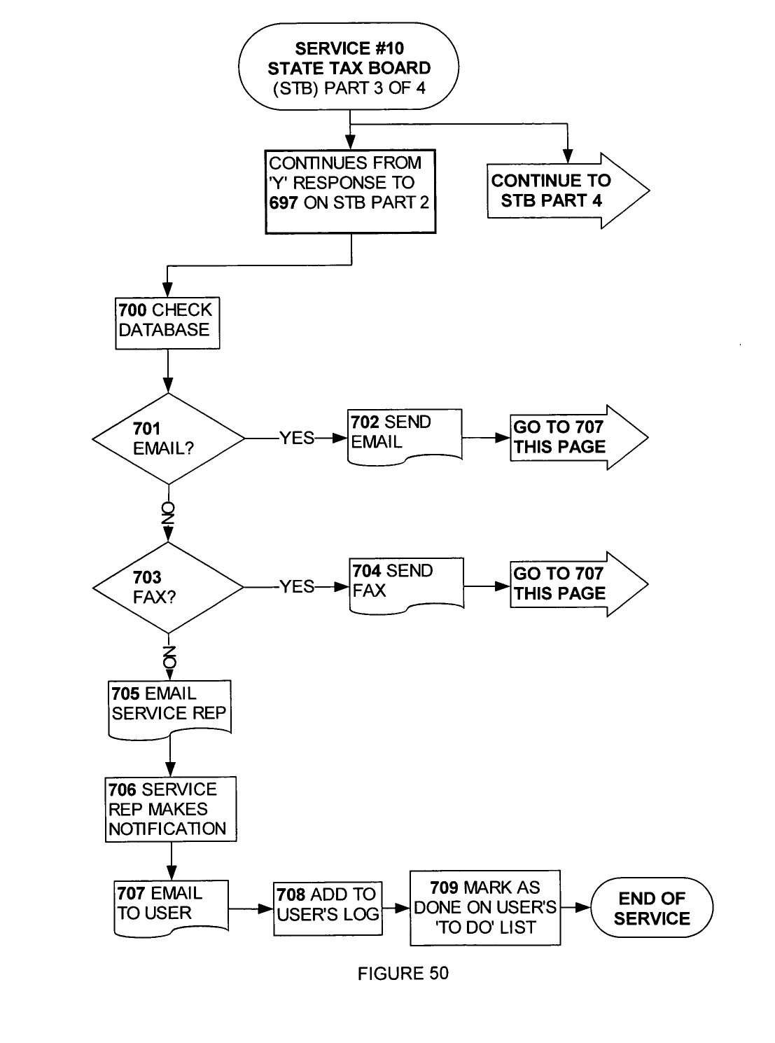

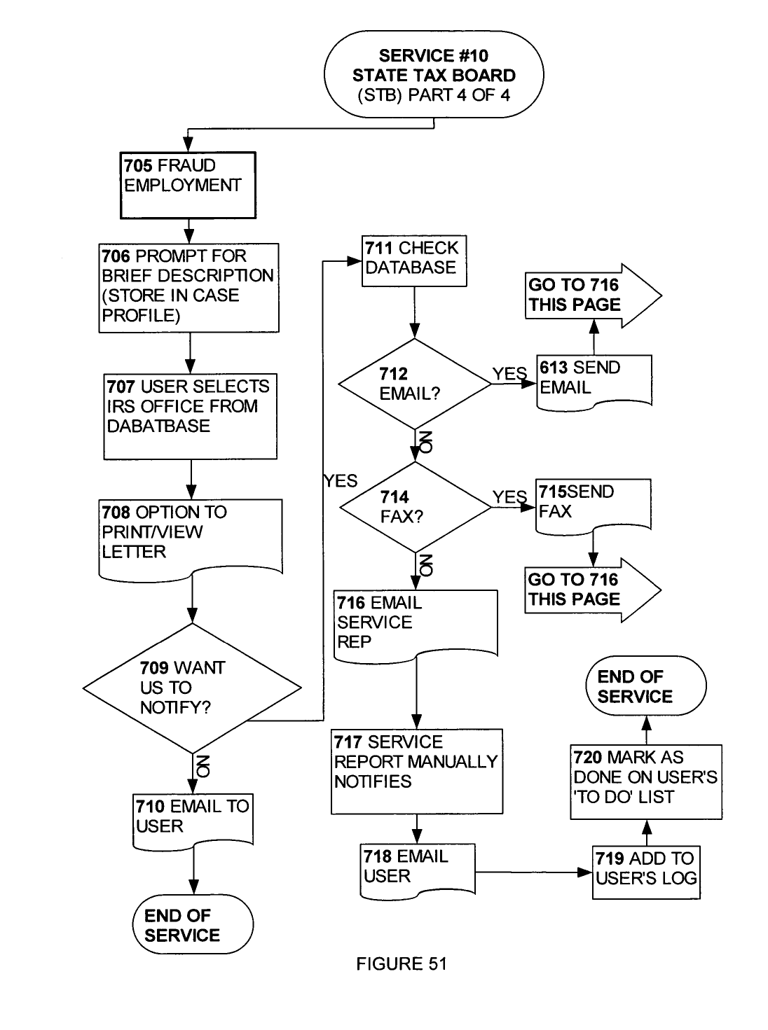

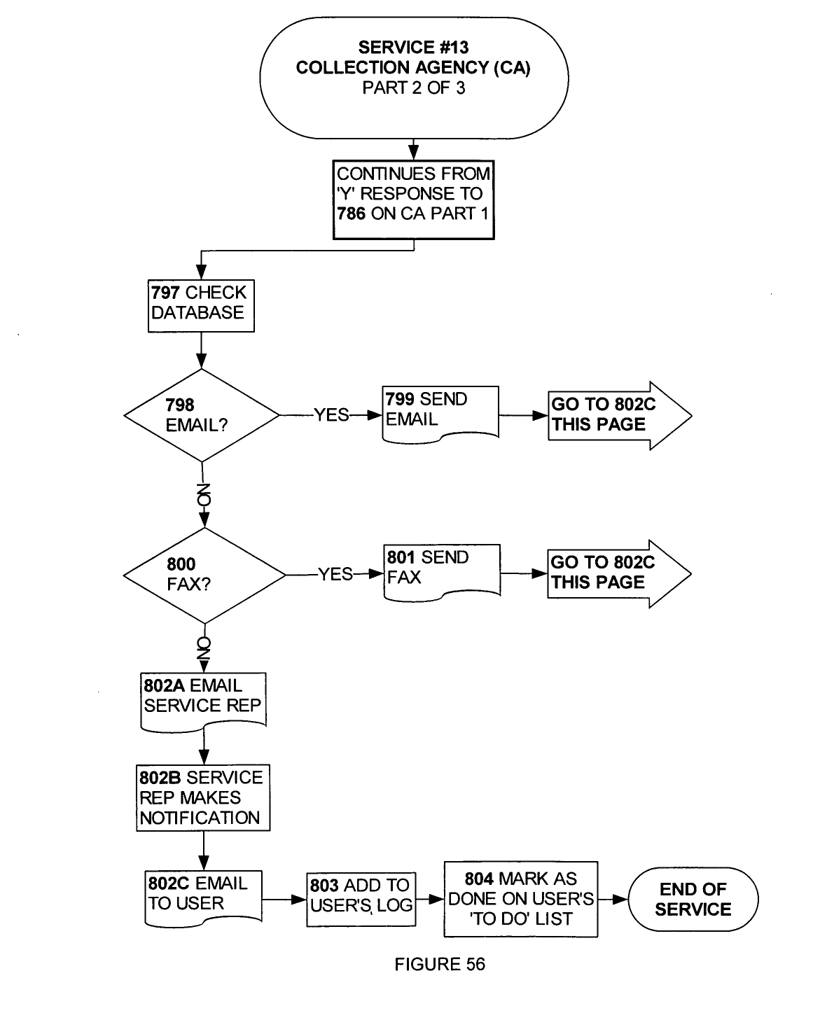

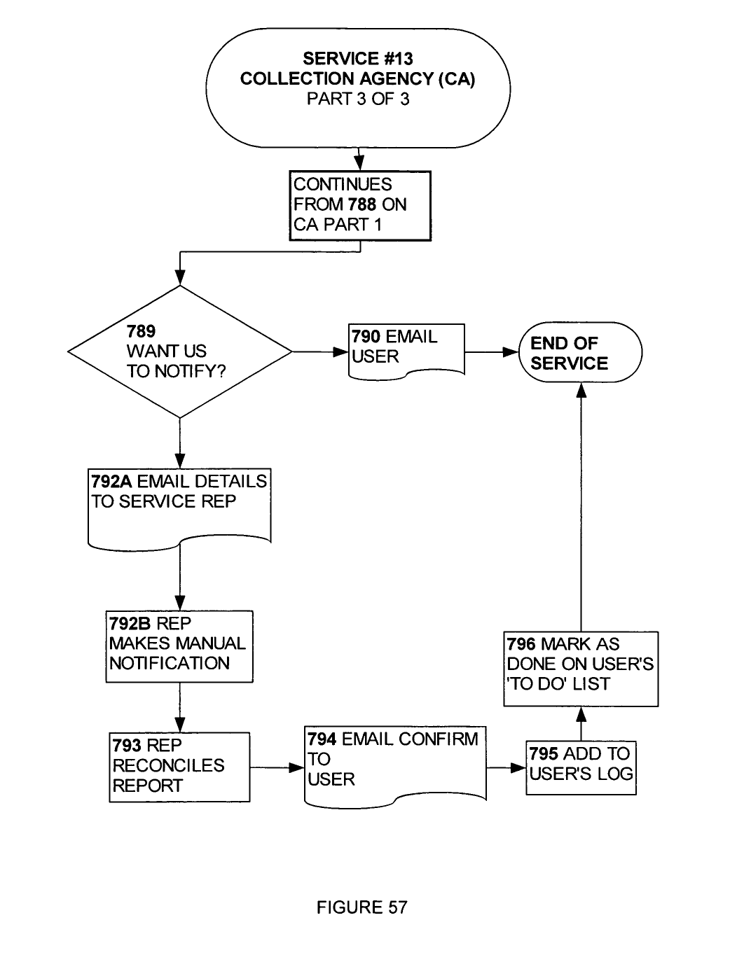

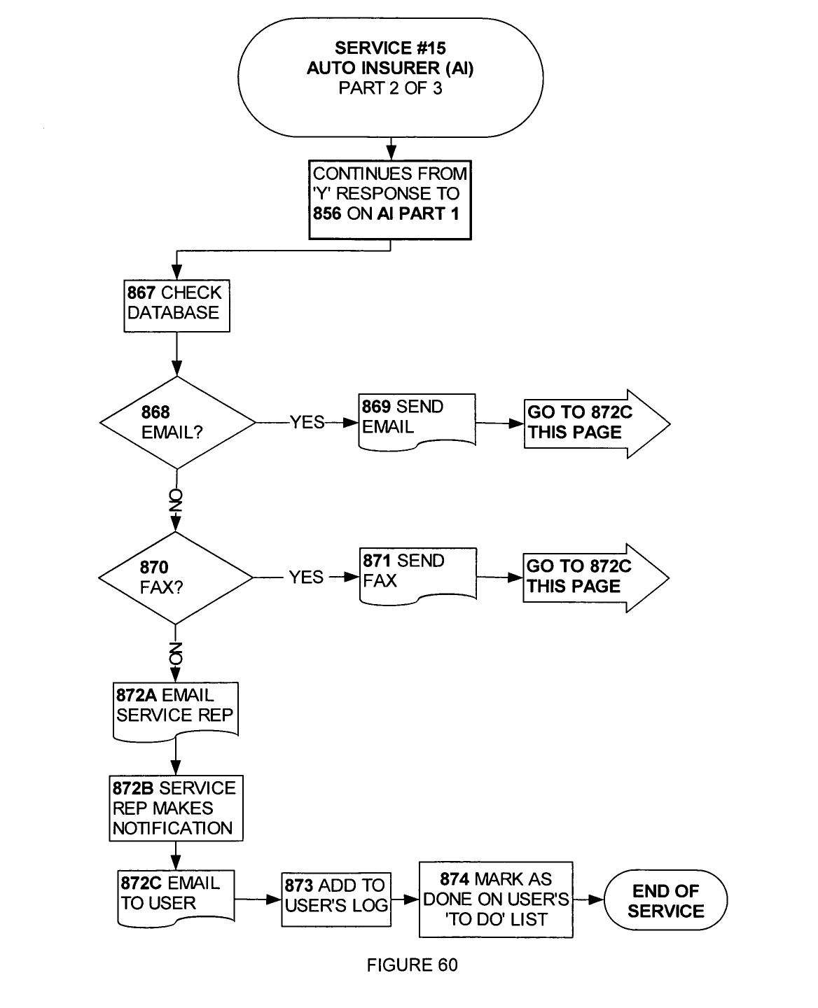

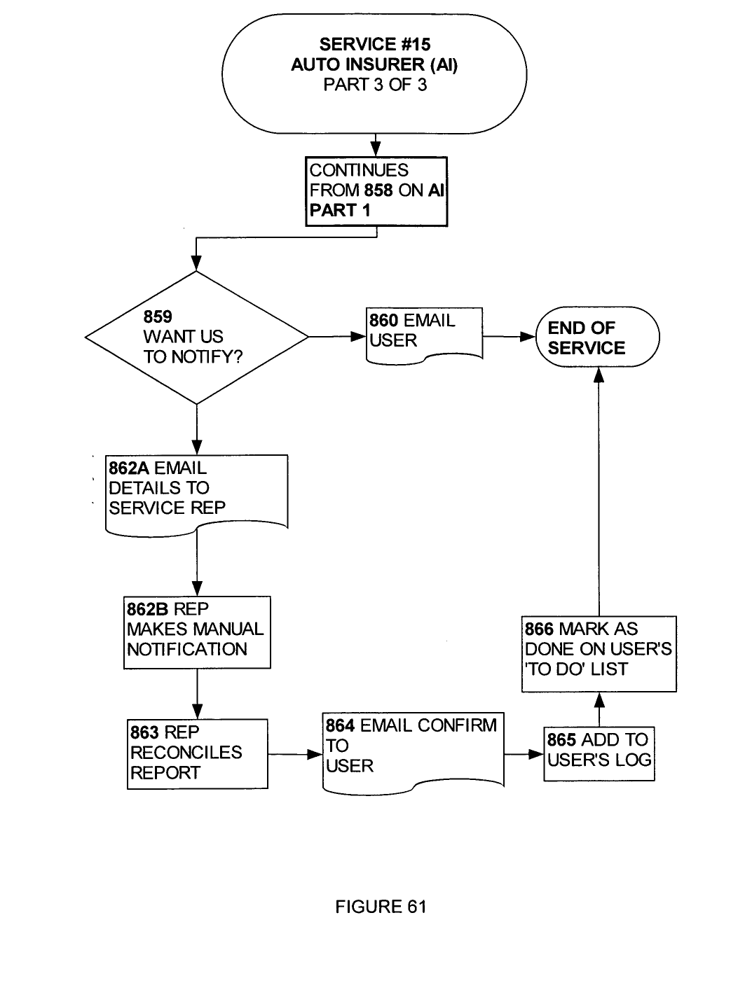

FIG. 18-63 show various Service entry web pages that the user will be shown once the user elects a particular service or is prompted by the System to notify the specific service entity regarding details of the fraudulent transaction(s). On each of these service web pages, the System will guide the user through a series of actions. These actions include, but are not limited to, informing the user to send a fax, letter, or email to the specific entity; sending the user an email confirmation when a transaction has been completed; presenting a standardized letter for the user to fill-in and send to the appropriate entity; providing a reminder to user after a predetermined number of days have gone by that action is still needed; providing a link to other relevant pages or web pages; and prompting user for more details.

FIG. 18 shows a police service report that a user may have to submit, of which part of it will now be described, depending upon user's earlier responses. Here the system prompts the user for details 303, to which the user responds 304. The user can then choose the option of having the System representative modify the details 306. At later stages the user can choose to email 323 or fax 325 the communication, and the System will send an email notification back to the user, followed by a follow-up email after a certain number of days 312.

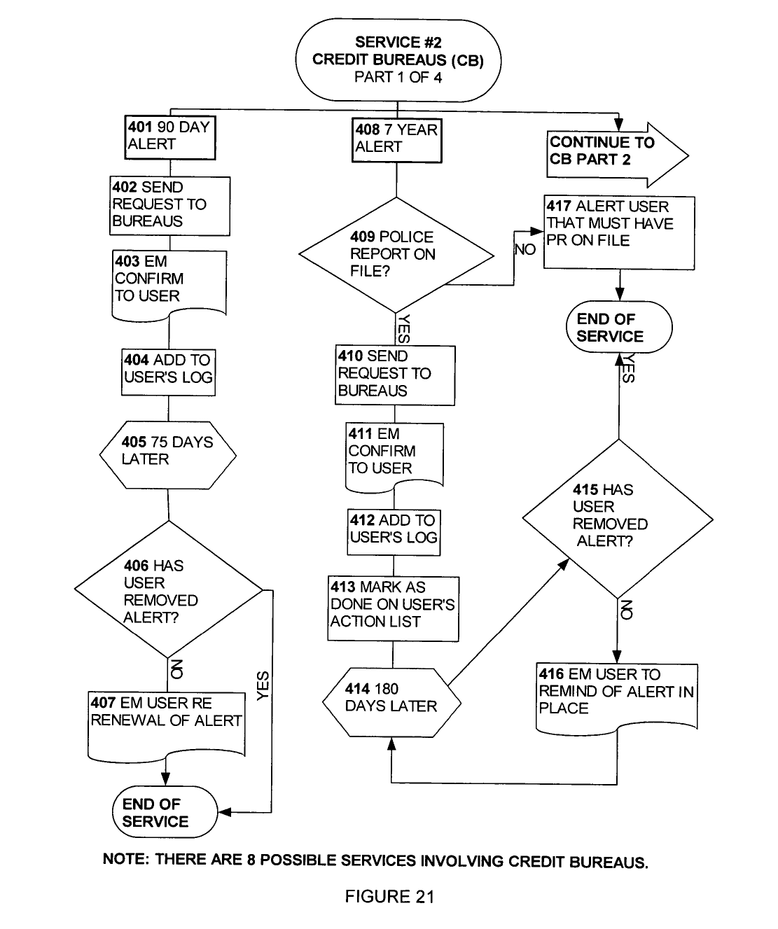

FIG. 21 shows a credit bureau service report that user may have to submit depending upon user's earlier responses. For instance, user can issue a 90 day alert to the credit bureau 401, receive email notification 403, and receive a reminder 75 days later to renew or remove this alert 407.

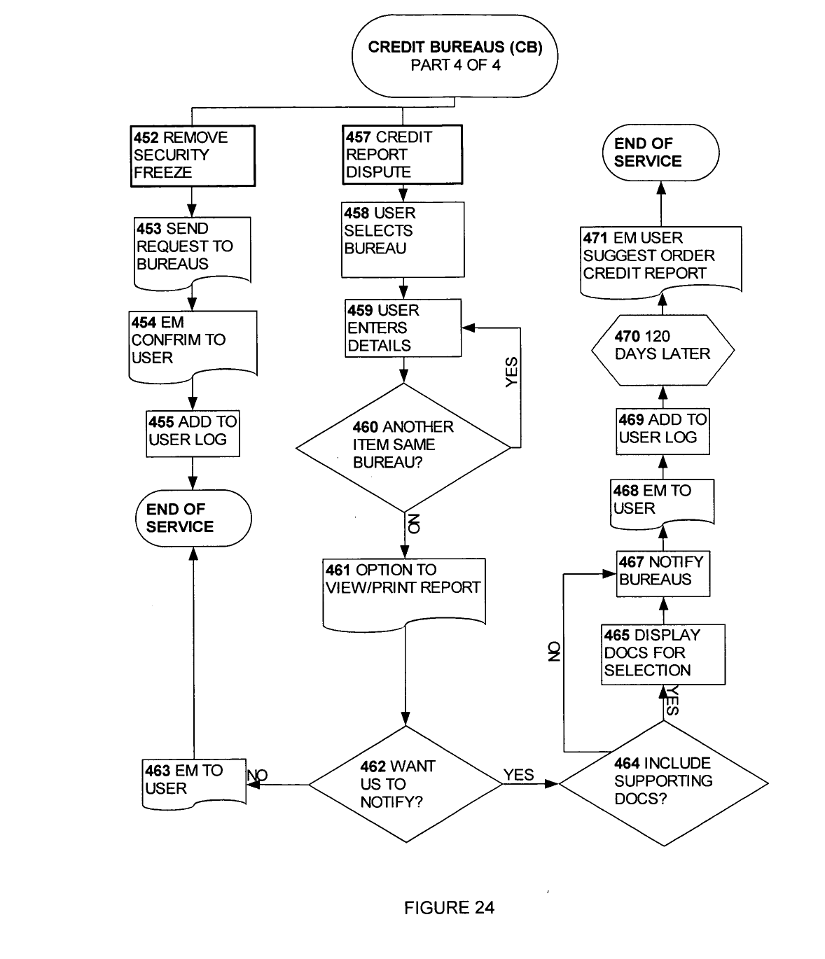

FIG. 24 shows another page of a credit bureau service report generated by the System that a user may choose to submit, of which part of it will now be described, depending upon user's earlier responses. For instance, the user can inform the system that s/he has a credit report dispute 457, select the appropriate bureau 458, display the user's supporting documents pertinent to this enquiry 465, send a notice to the bureau with the supporting documents 467, and get email confirmation of this transaction 468.

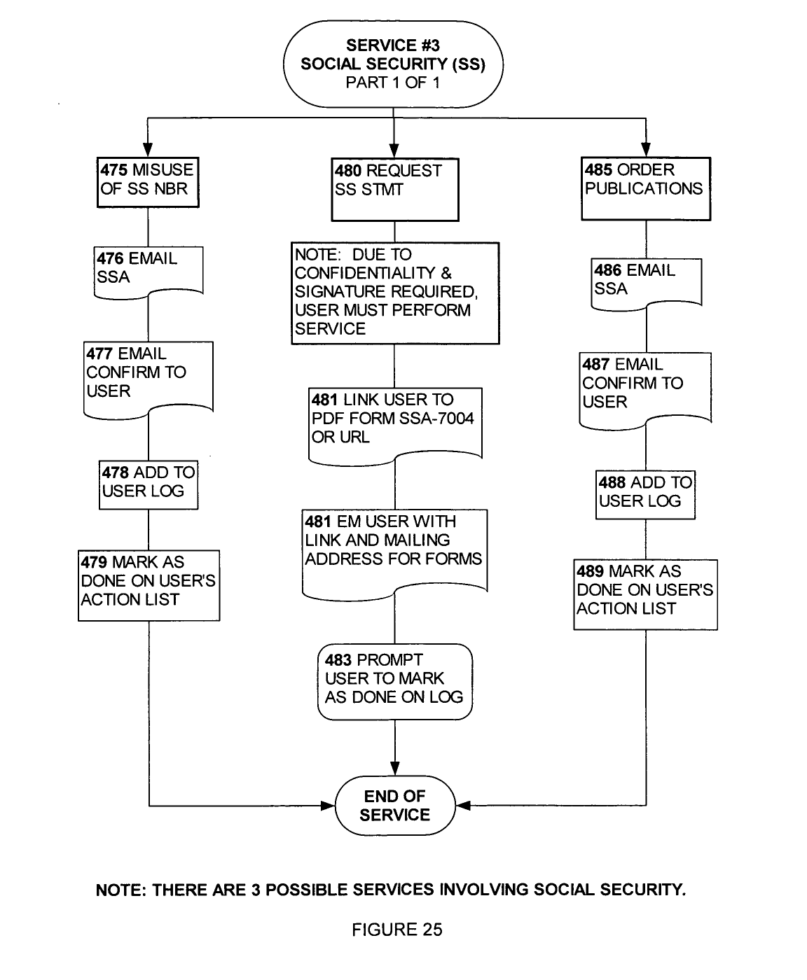

In FIG. 25 the user may choose to submit a service report to the Social Security Administration. For instance, the user can request a social security statement 480, be prompted by the System towards pertinent web links 481, be prompted to a page that allows the user to contact the Social Security Administration by email 486, and get an email confirmation back of this transaction 488.

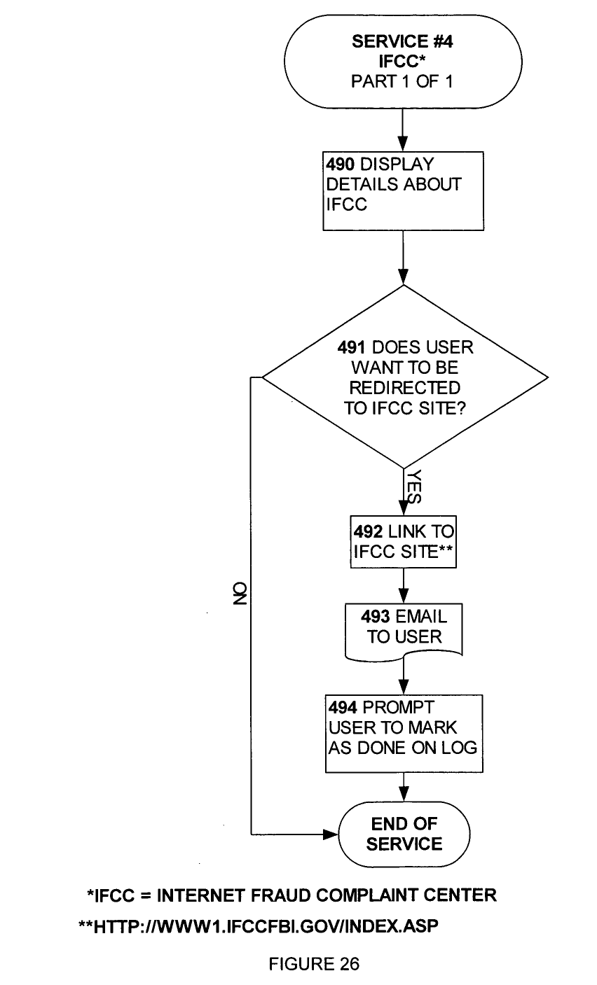

FIG. 26 shows an internet fraud complaint center service report that a user may use. For instance, the user can request to be shown details about the internet fraud complaint center 490, be directed to the internet fraud complaint center web site 492, and get an email confirmation sent back to the user 494 of these transactions.

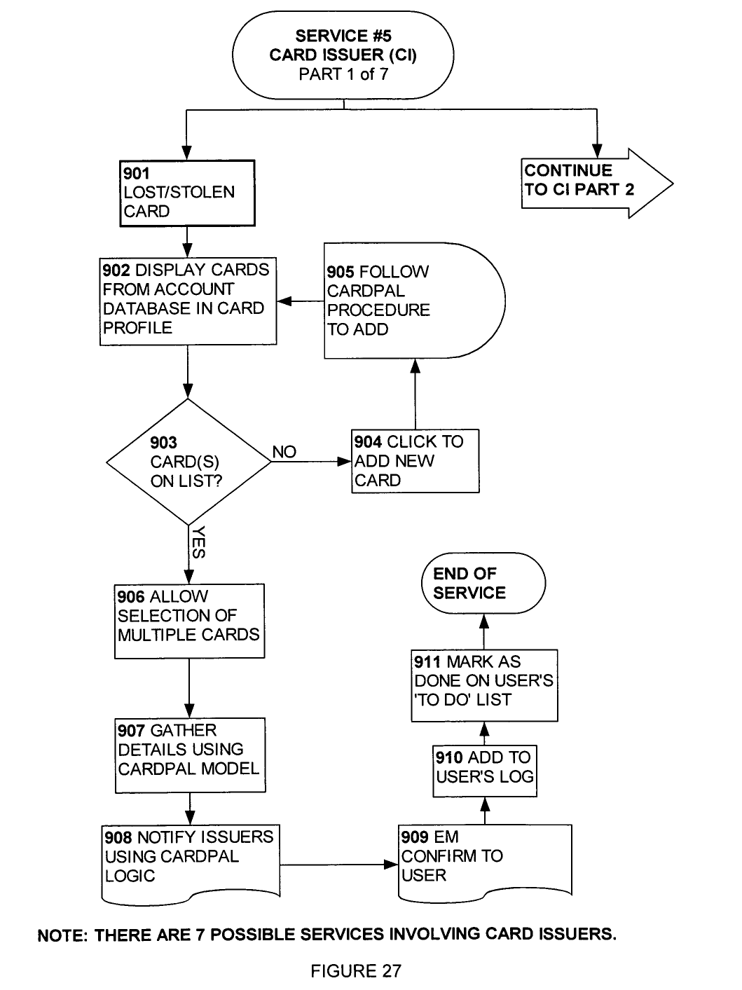

In FIG. 27 the user may have to submit a service report of the fraud to a card issuer. The user can report stolen credit cards 901, get a display list of credit cards from the Account Database in the System 902, send a notice to the issuer 908, and receive back an email confirmation of these transactions 909.

FIG. 33 shows that the System may be used by the user to submit to a card issuer a challenge of the denied credit requests 974, and send this challenge to the card issuer 976. Alternatively, the user can use this service to close a fraudulently opened account 948, or simply request a copy of the most recent statement 936.

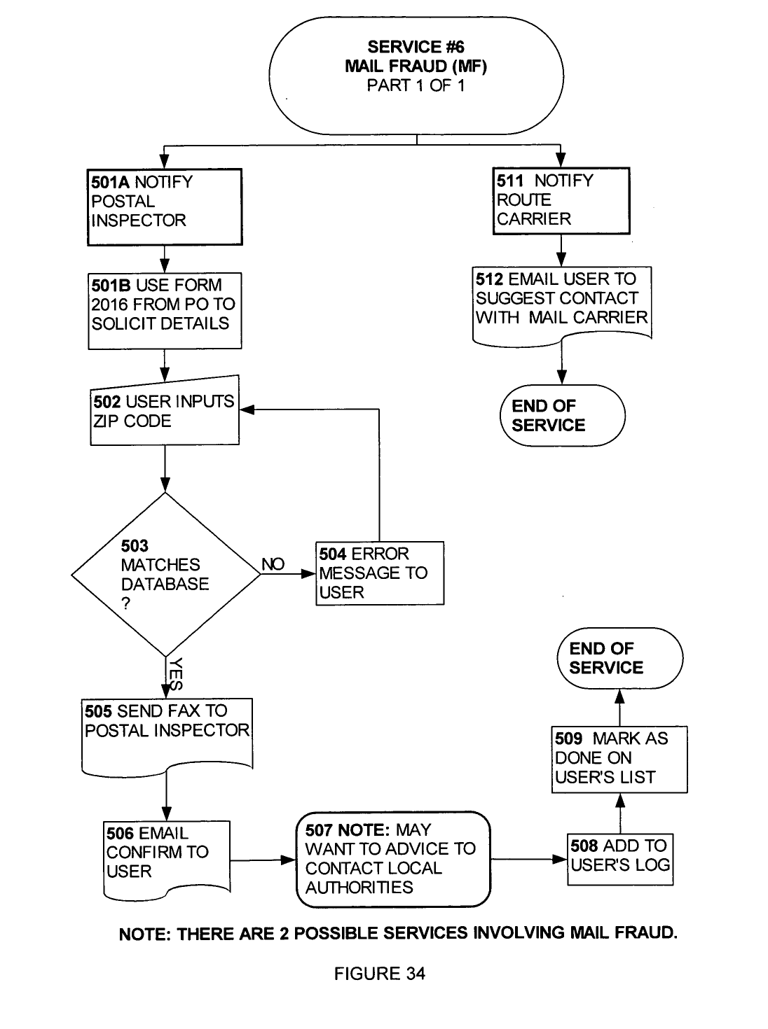

FIG. 34 shows a mail carrier service report that a user may use. For instance, the System will prompt user that s/he may choose to notify his or her route carrier 511 or notify the Postal Inspector 501a.

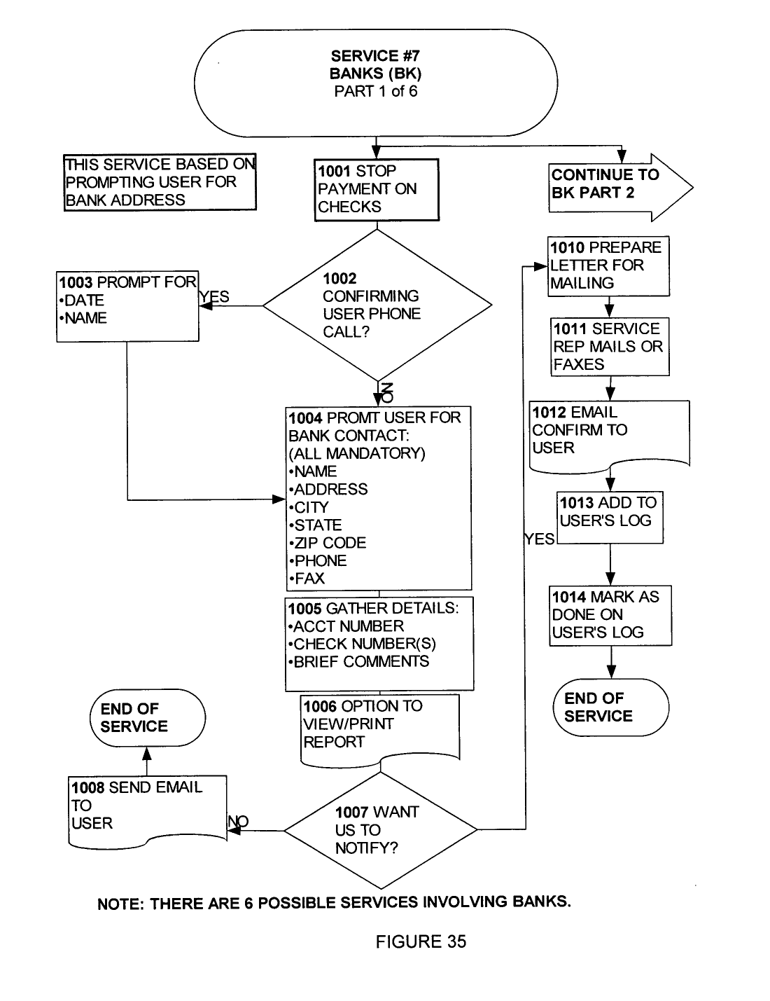

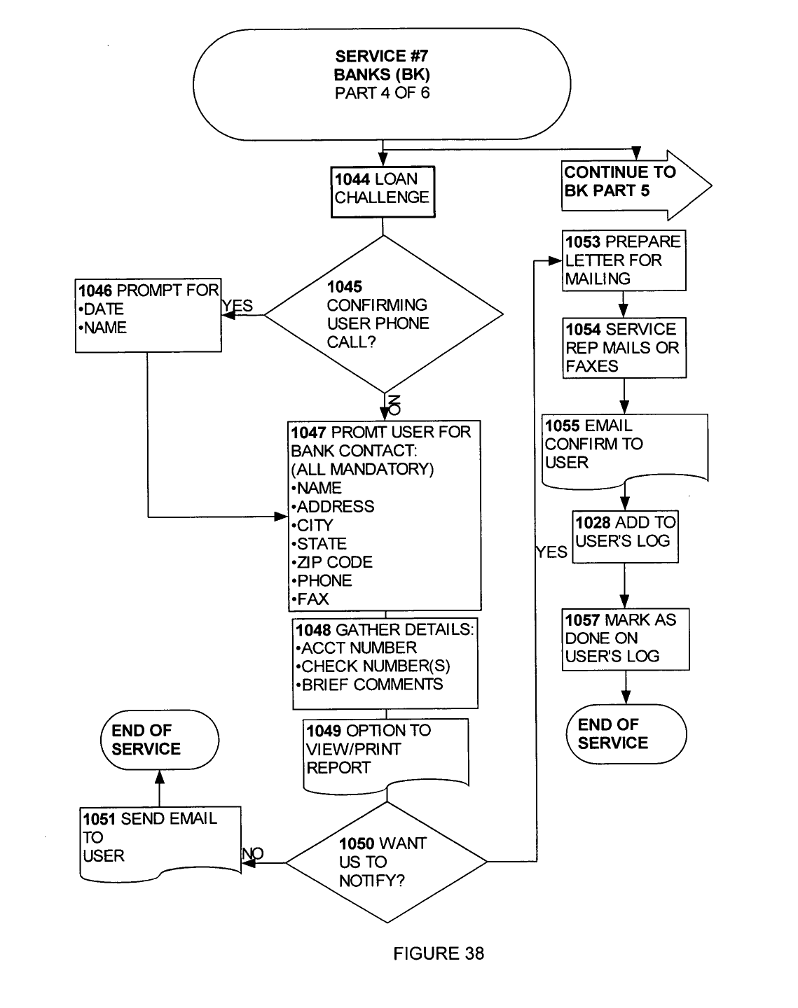

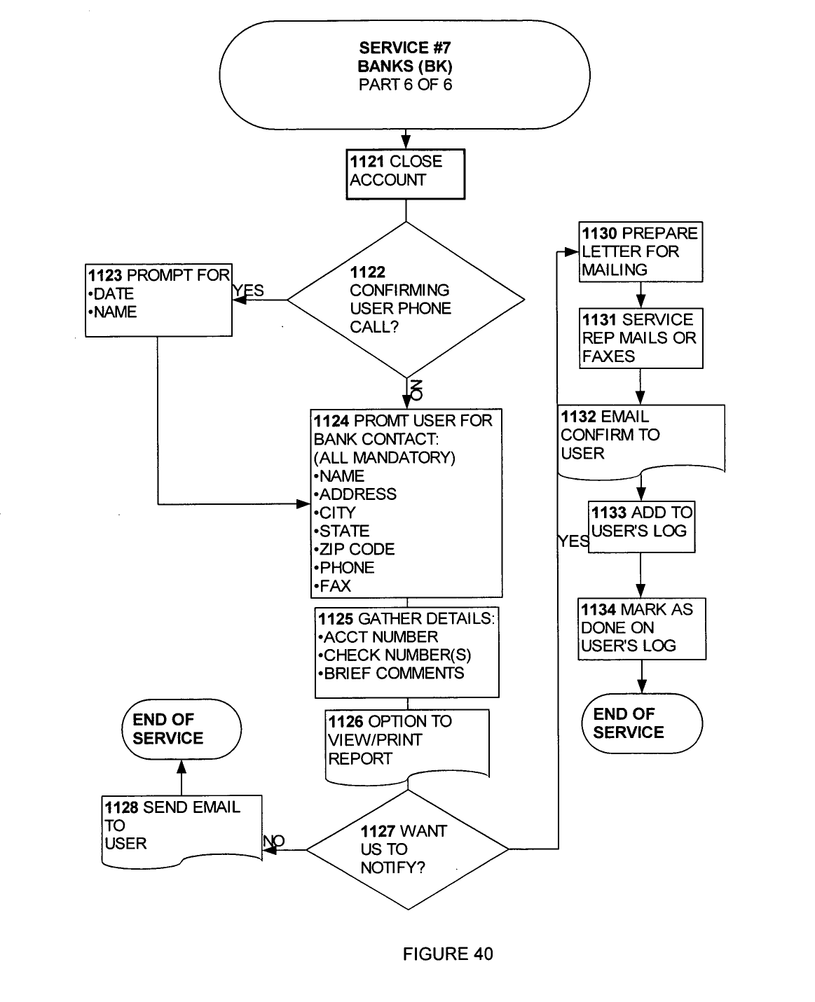

FIGS. 35-40 show bank service reports that a user may use depending upon the earlier responses. For instance, as shown on FIG. 35, the user can request a stop payment on checks 1001, prepare a letter for filing 1010, and receive email confirmation back 1012. As shown in FIG. 38, user may challenge a loan denial 1044, provide a brief explanation 1048, prepare a letter to send 1053, and receive email confirmation 1055. Accordingly, as shown in FIG. 40, user may choose to close the account 1121, prepare letters pertinent to this transaction 1130, and then get email confirmation 1132.

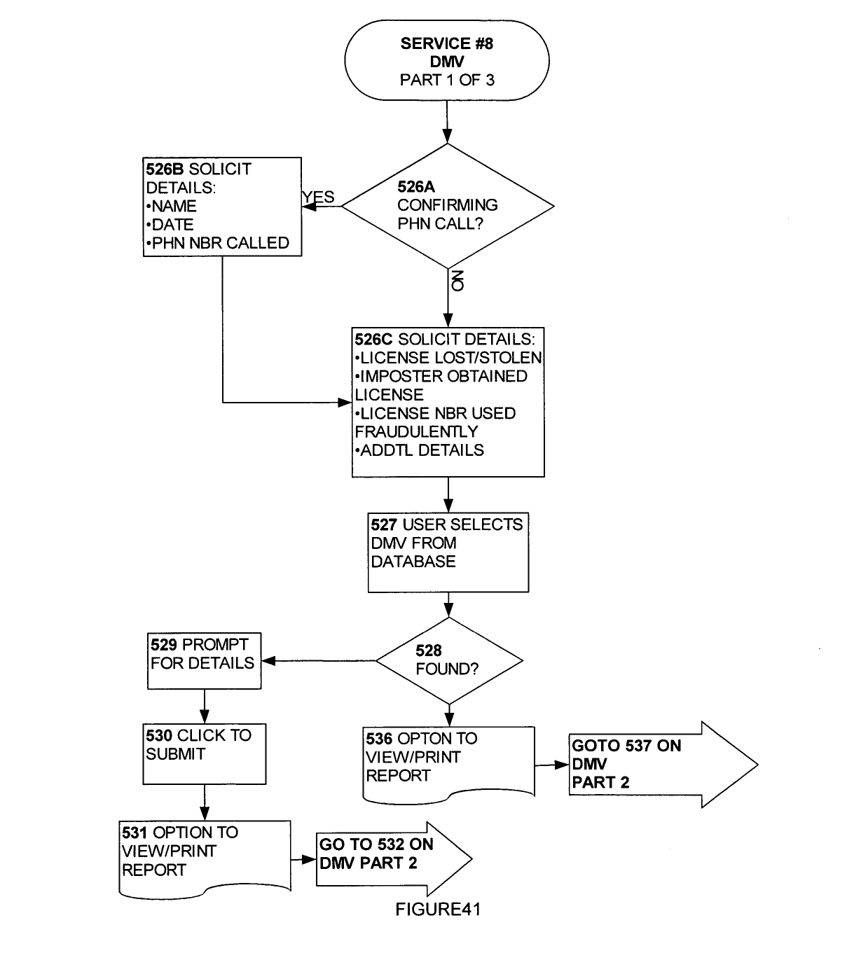

FIG. 41 shows that the System may be used by a user to submit a service report to the Department of Motor Vehicles (DMV). For instance, the user can report his license number lost and report additional details of the fraud 526c, request that the System modify the report 537, and receive back email confirmation of these transactions 547.

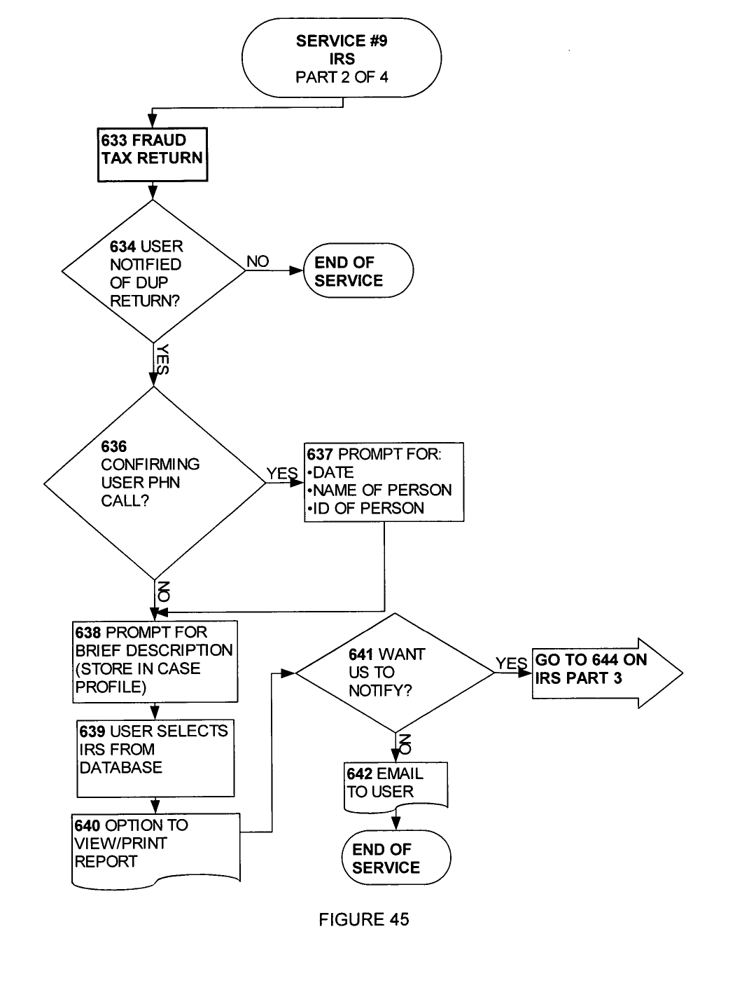

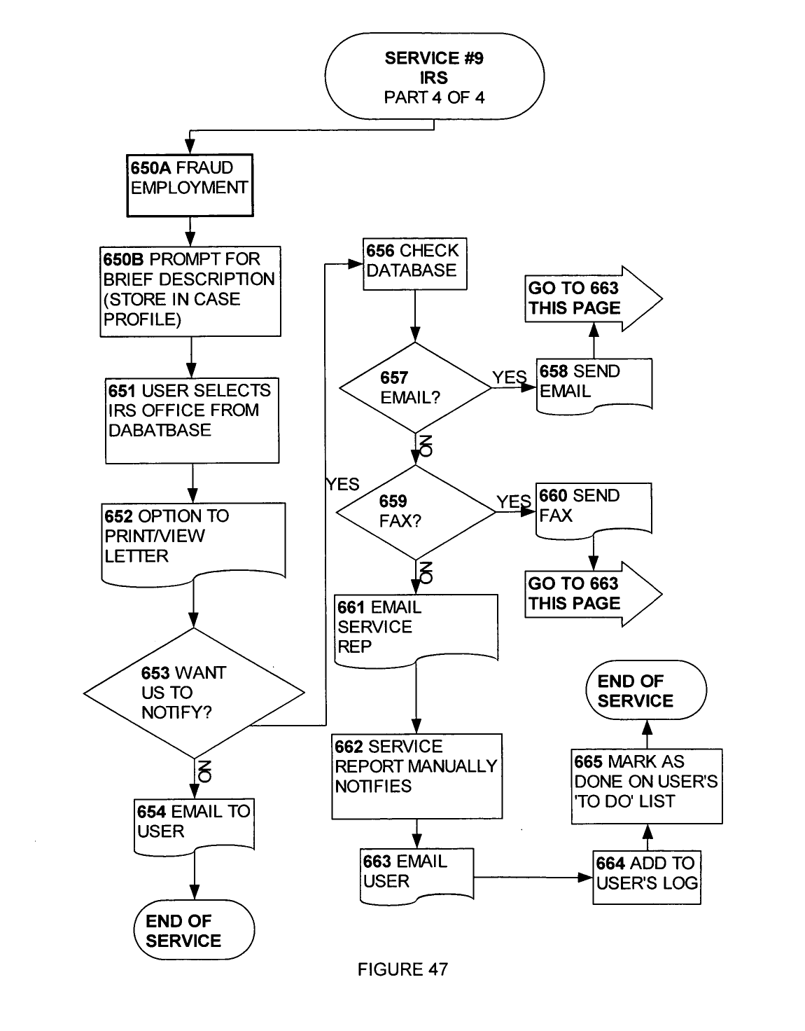

FIGS. 45, 46 and 47 show an Internal Revenue Service (IRS) service report that a user may submit. As shown in FIG. 45 user may select the IRS from the System database 639, submit a notification to the IRS 649, and receive email confirmation back from the System 651. Alternatively, in FIG. 47, the user may use the service to notify the IRS that there has been employment fraud 650a.

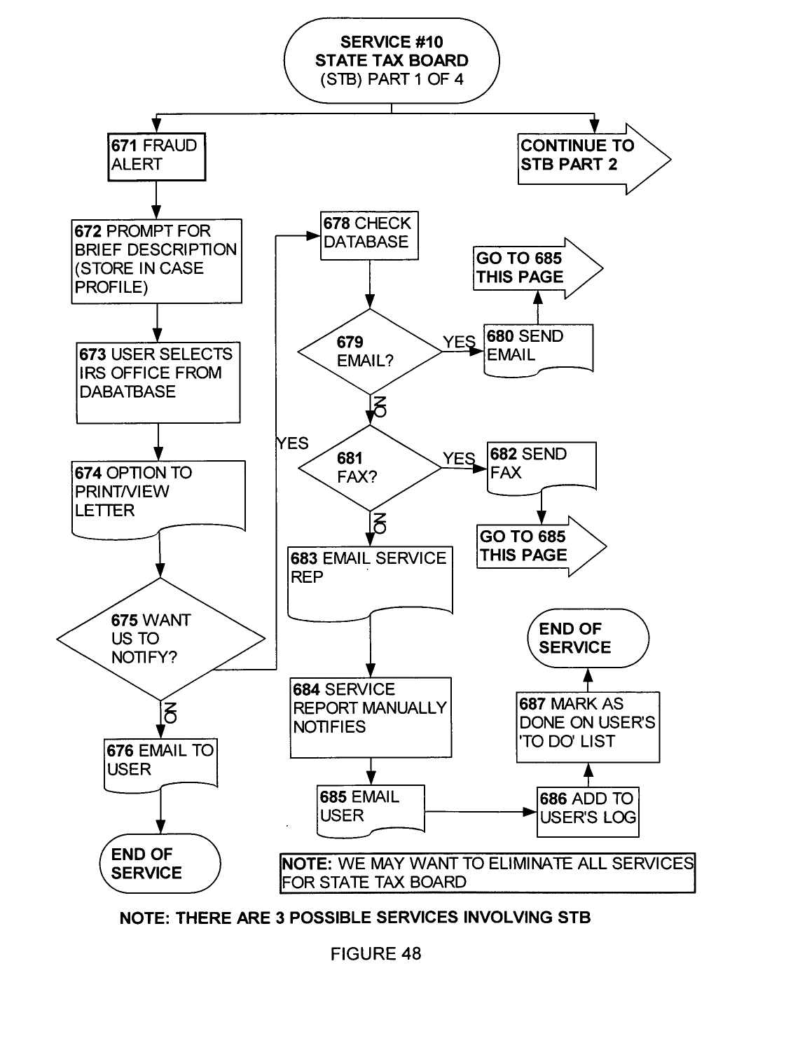

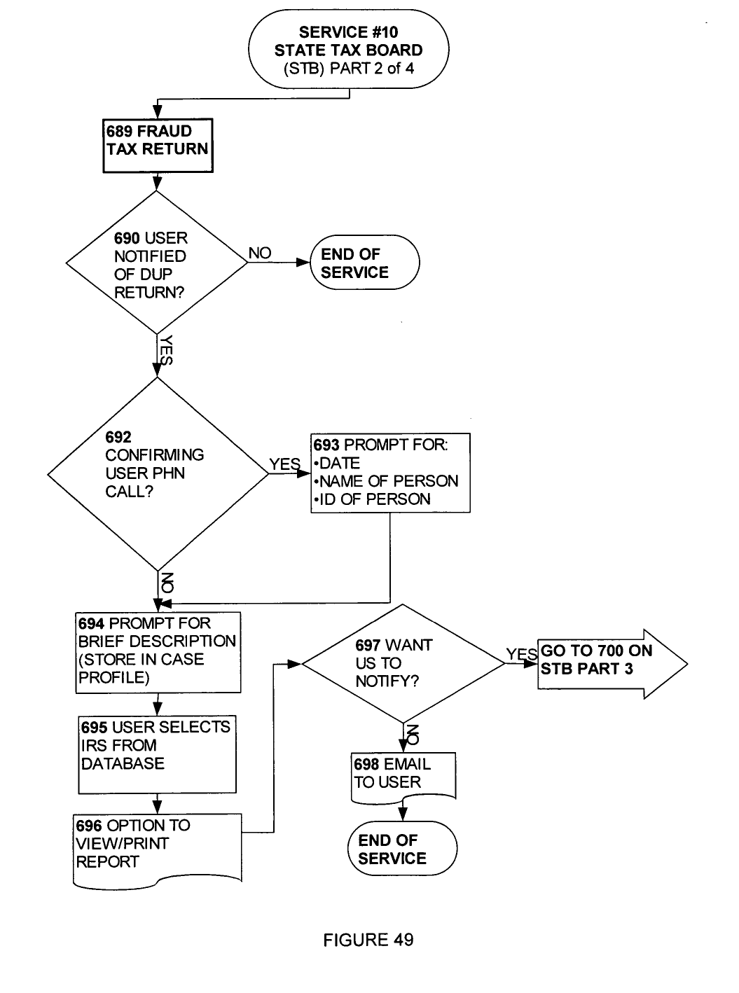

The user may use the System to notify the State Tax Board of any fraudulent activity, as shown in FIGS. 48, 49, 50 and 51. For instance in FIG. 49, the System will prompt user whether s/he has received notice of a duplicate tax return having been filed 690, and then user can input details of the fraud 694, send an email or a letter 702 to the Board, and receive email confirmation 707.

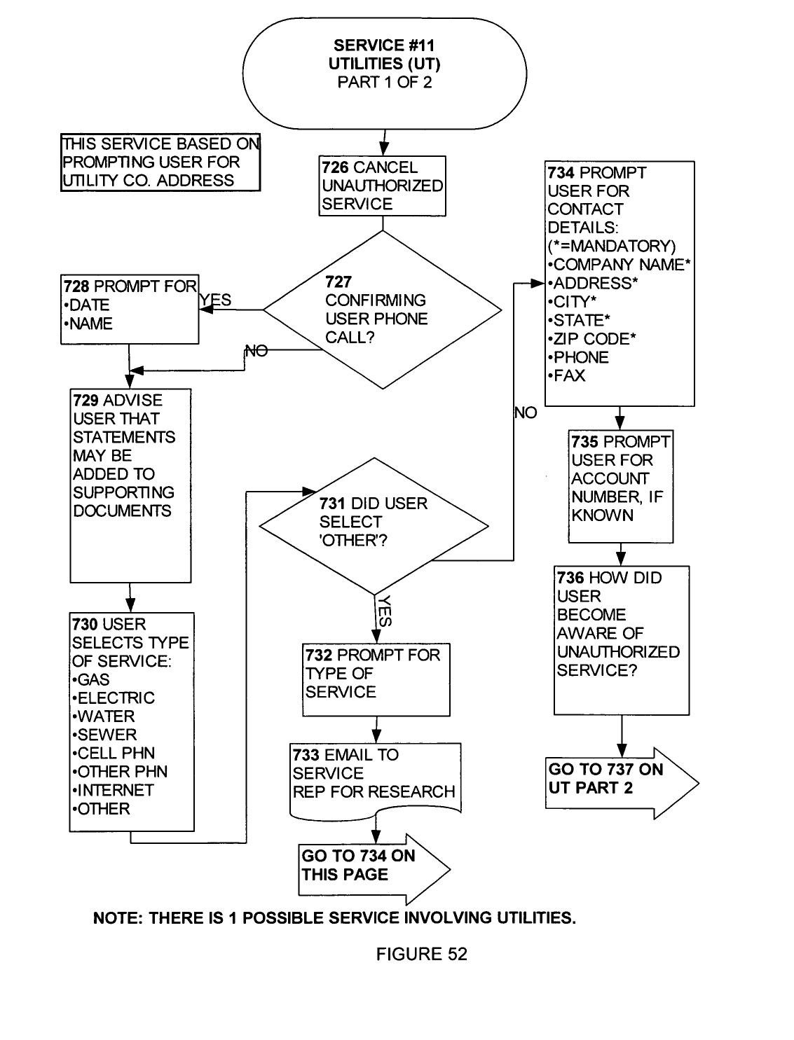

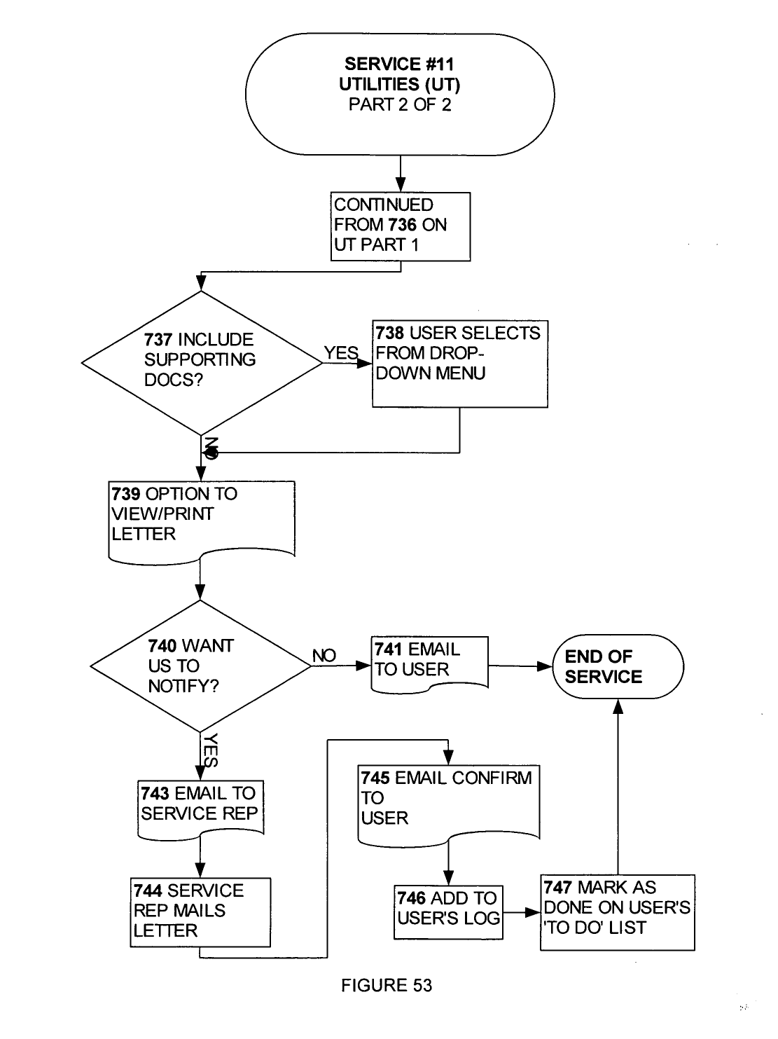

The user may also use the System to notify Utilities (gas, electric, telephone, water, etc.) of a fraud as shown in FIGS. 52 and 53. Here, user can cancel an unauthorized service 726, select the type of service to notify or cancel 730, print a letter 739, and receive email confirmation back from the System 745.

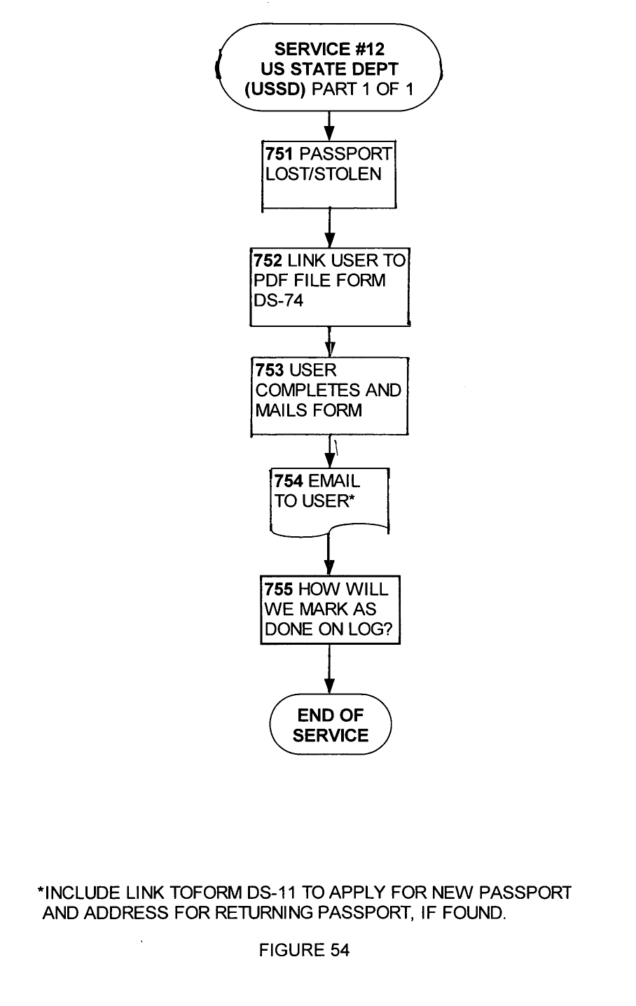

FIG. 54 shows a US State Department service report that a user may have to submit depending upon user's earlier responses. Using this report, the user can download the appropriate file using the link provided 752 and receive email confirmation 754.

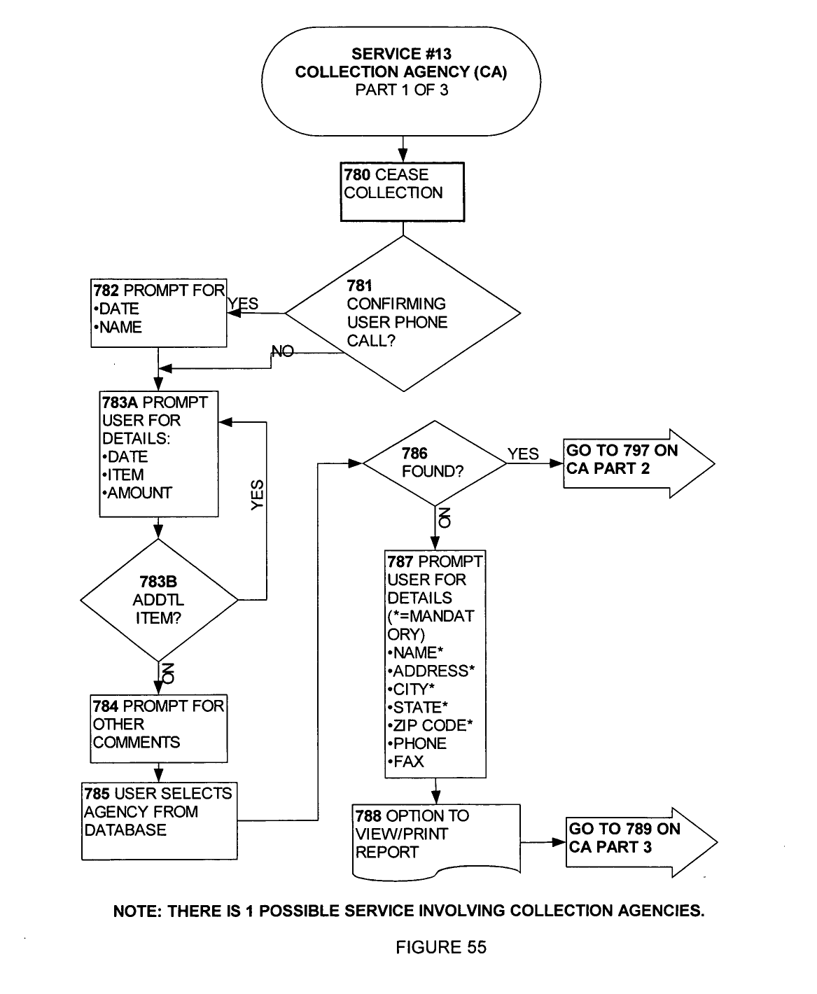

FIG. 55 shows a Collection Agency service report that a user may use. For instance, the user can input into the System that s/he has made a previous call to the Agency 781, supply the date and name of the person who was contacted 782, email or fax the agency 801, and receive email confirmation of the entire transaction 794.

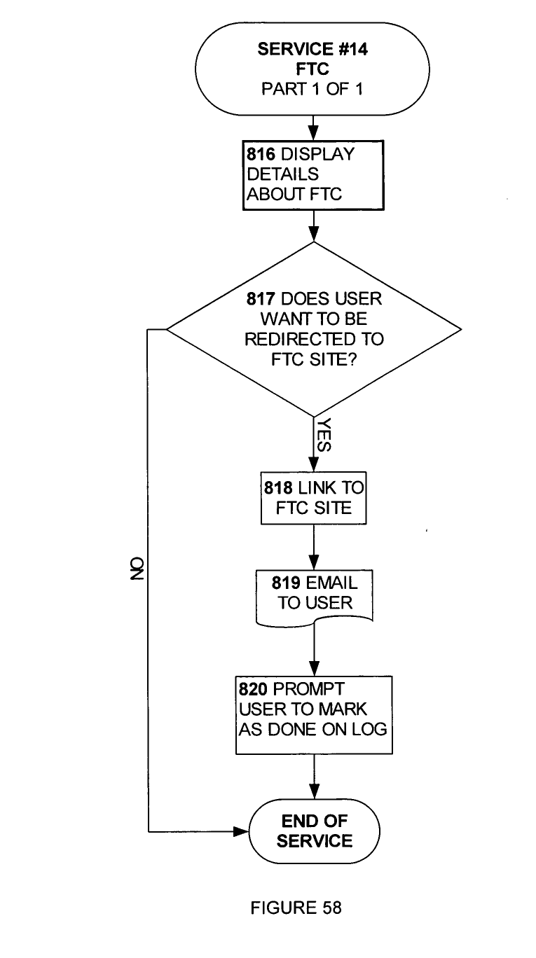

FIG. 58 shows a Federal Trade Commission (FTC) service report that a user may use. On this page the user may use this report to request a display of details about the FTC 816 and be linked directly to the FTC web site 818.

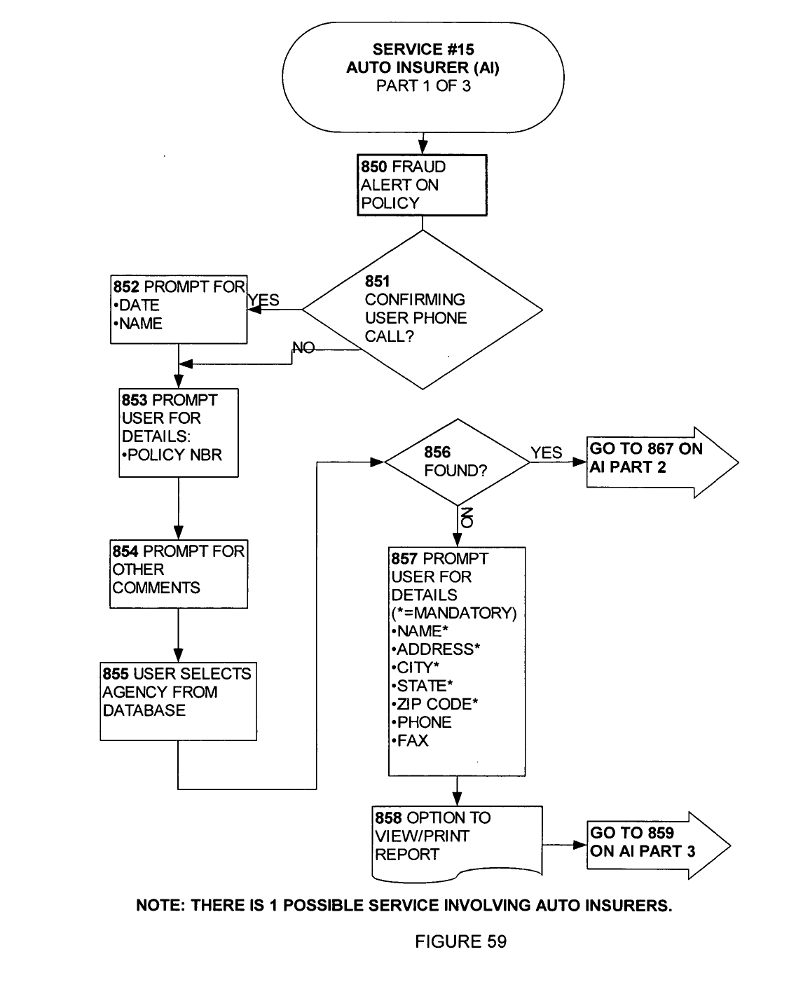

The user may use the System to notify the auto insurer of any fraudulent activity, as shown in FIG. 59. After the user is prompted for the insurer's details 857, the user may then write a report, print it 858, and fax it to the insurer 871.

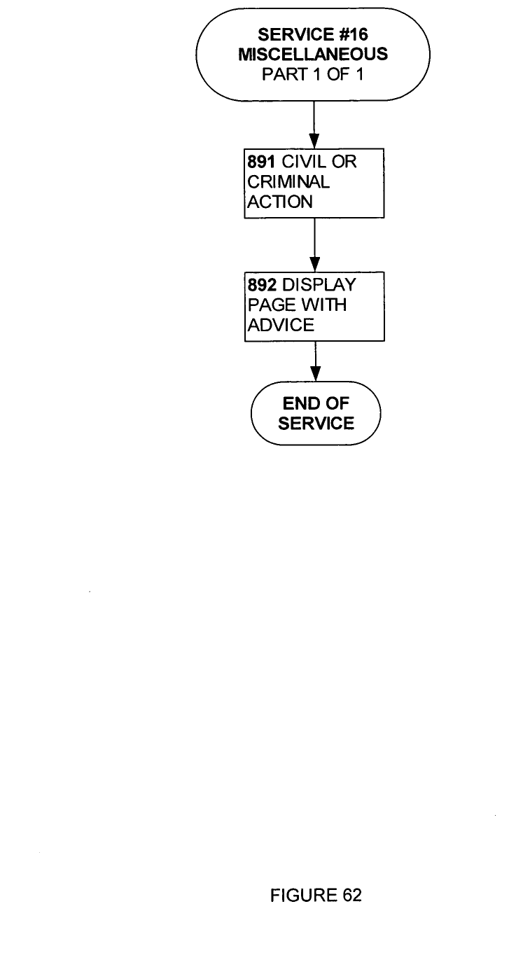

FIG. 62 shows that the user may also obtain from the System information as to whether the fraud committed constitutes a civil or criminal action, and the user may receive advice and web links pertinent to each area.

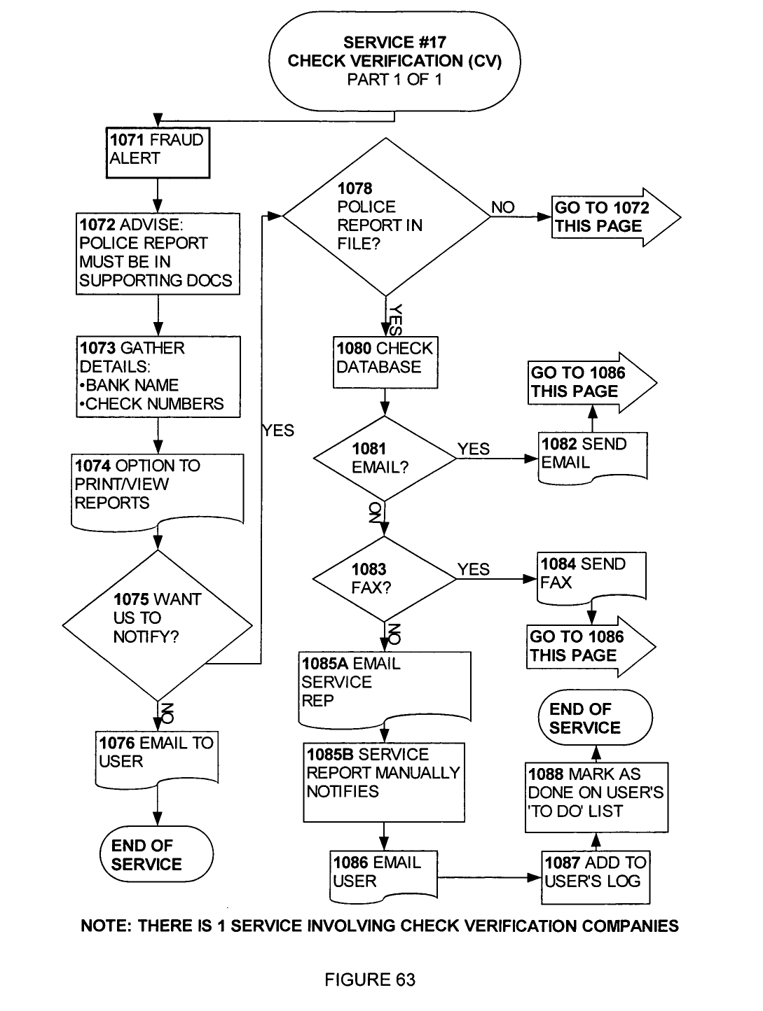

In FIG. 63, the System will permit the user to notify Check Verification companies. To do this, however, the user has to submit a police report 1072, and then fax the agency 1084 and receive email confirmation 1086.

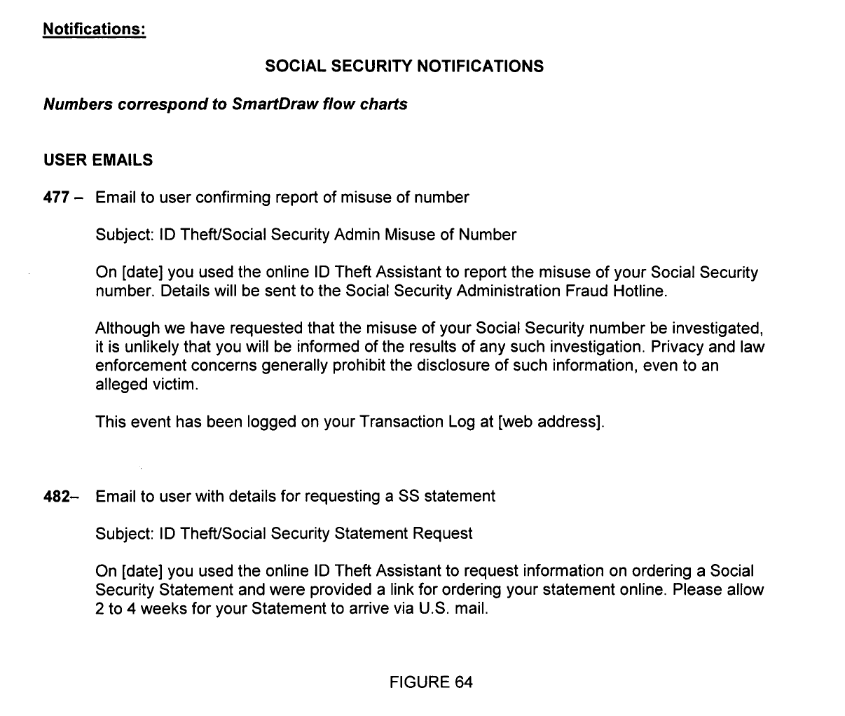

FIG. 64 shows boiler plate email notifications/confirmations that the user will receive back from the system at stages 477 and 482 of the process.

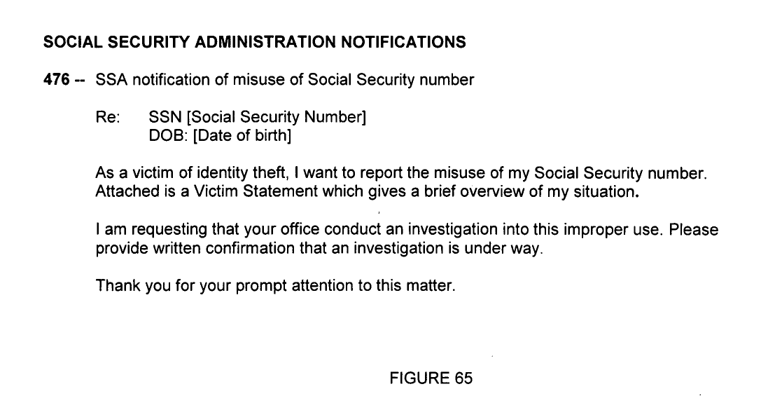

FIG. 65 shows a template letter to be sent out to the Social Security Administration when required by the user at stage 476 of the process. Personal information, such as the user's social security number and date of birth, will be added automatically to this template by the System 10.

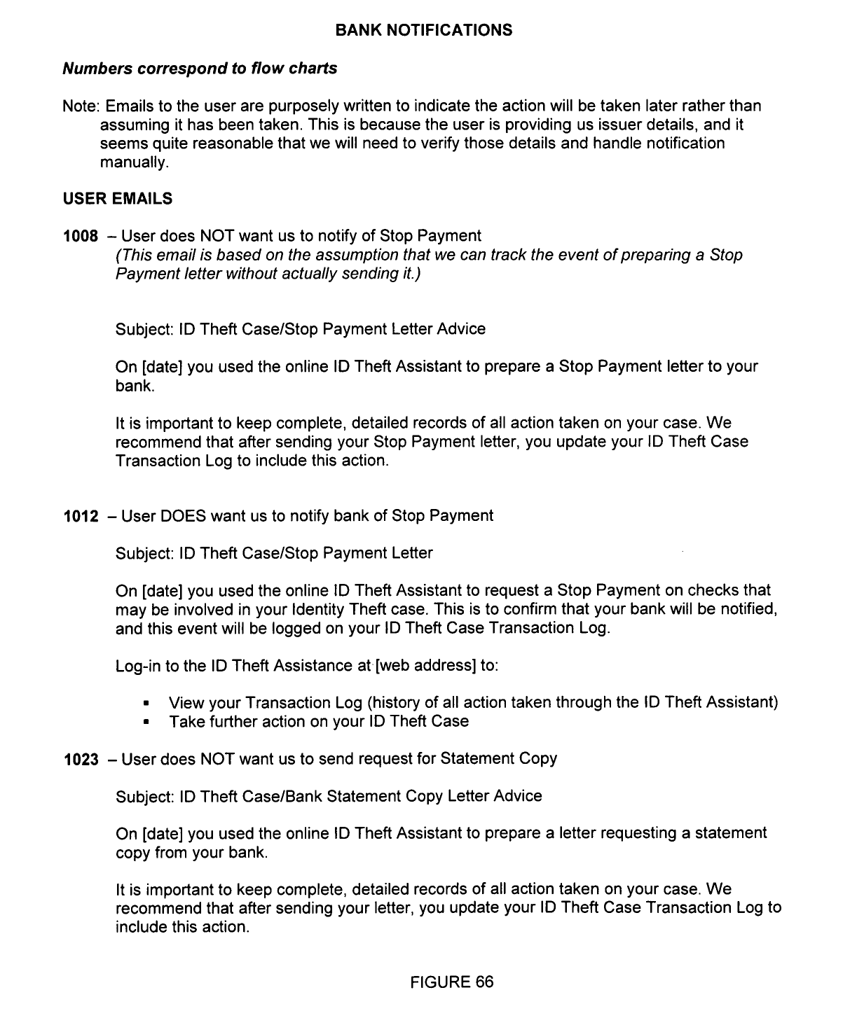

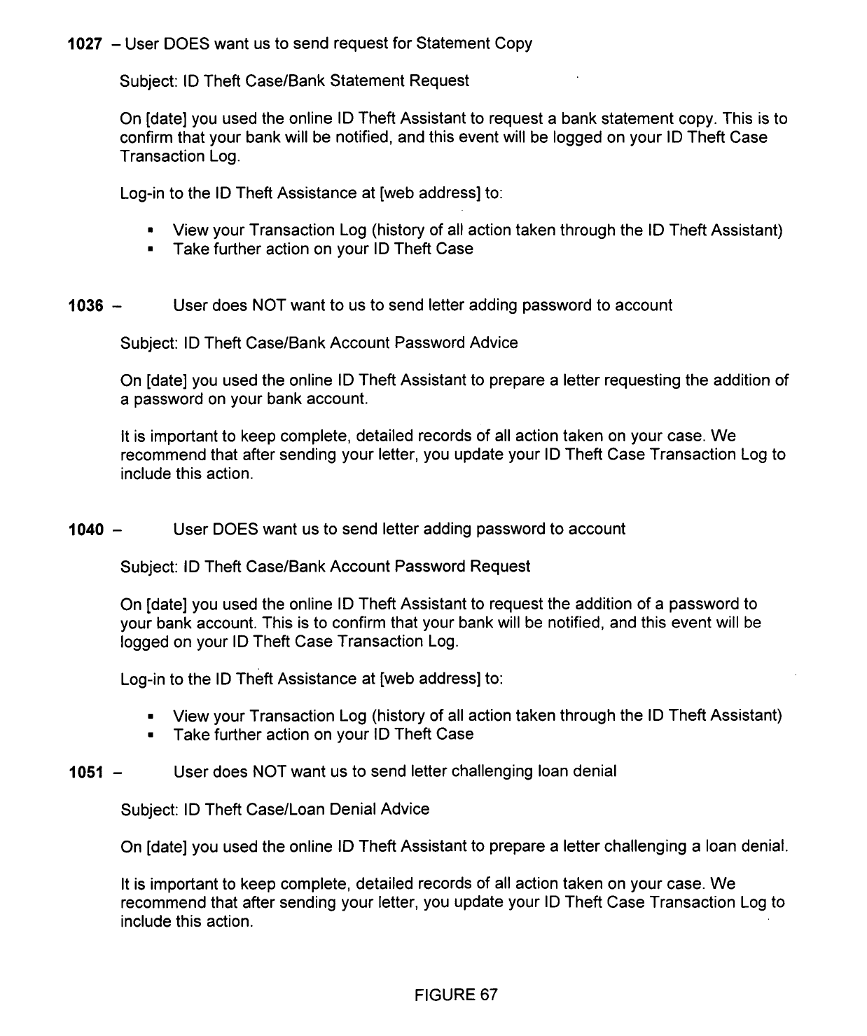

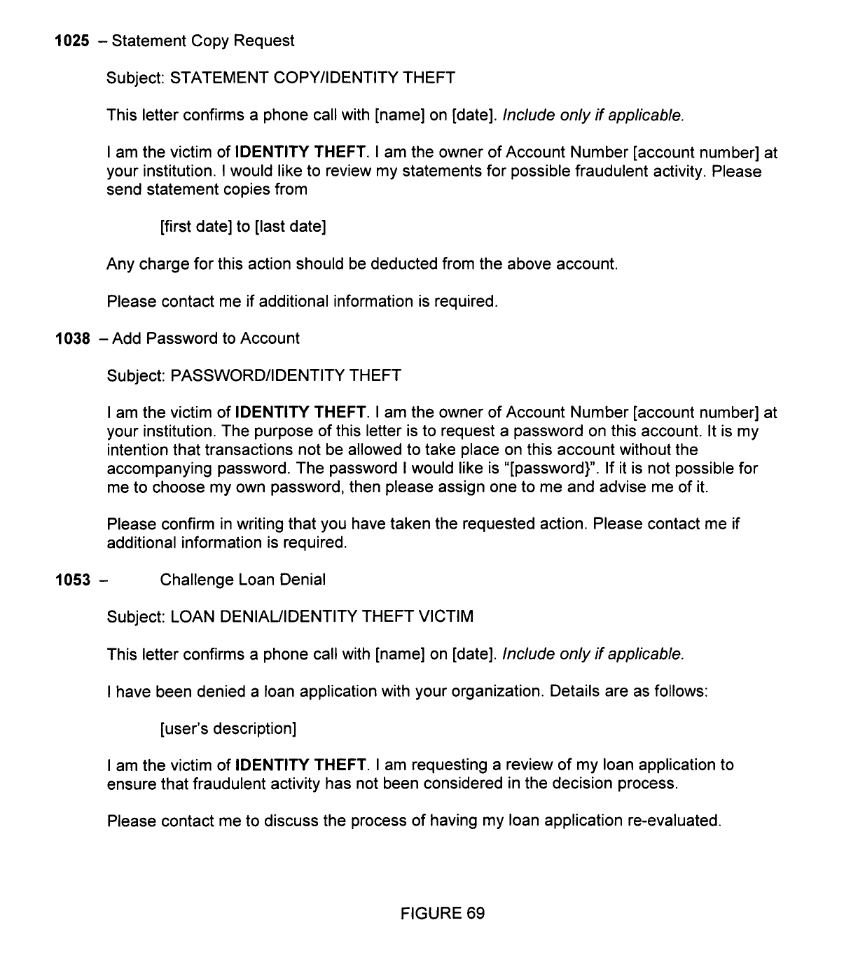

FIGS. 66-69 show user email notifications/confirmations during the bank notification process. For instance, in FIG. 66, the System email reminds the user to keep complete, detailed records of all action(s) taken and to update user's identity theft case transaction log to include any such action(s).

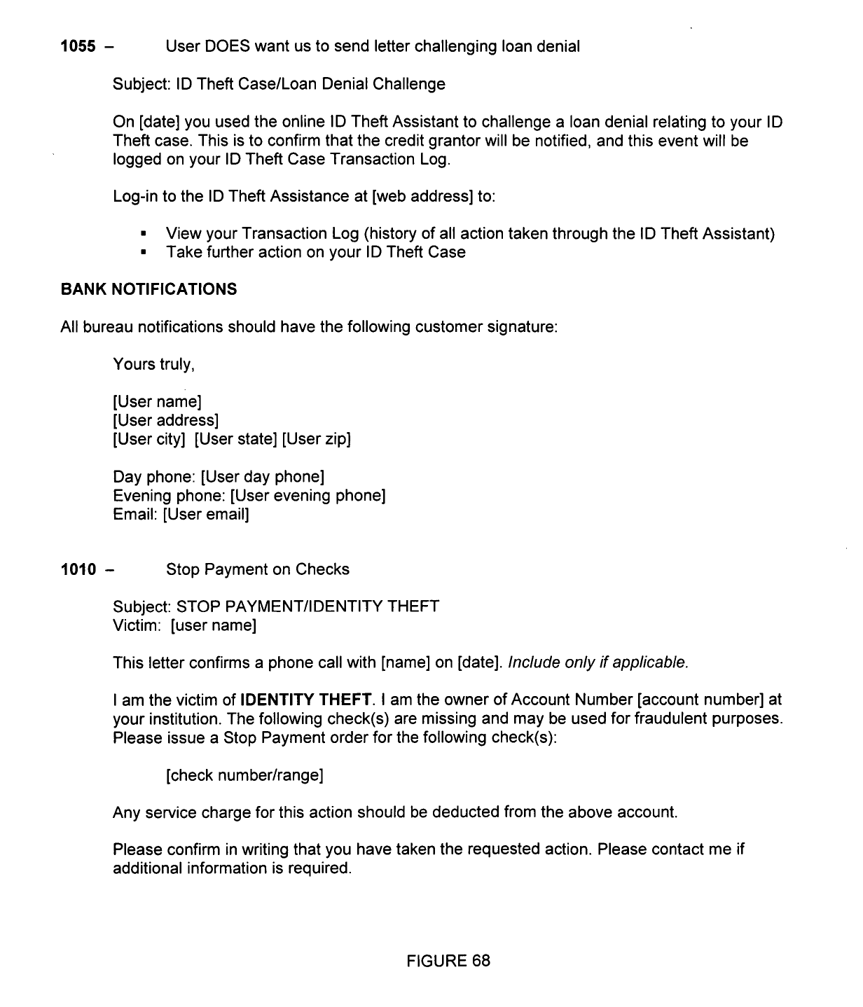

FIG. 68 shows the user signature block that the System will automatically generate at the bottom of every communication sent by the user to the banks in this process.

The System will also automatically generate template letters that the user can use to notify the appropriate agencies of the fraud. For instance, in FIG. 68 during step 1010, a letter will be generated informing the bank that the user is the victim of identity theft and instructing the bank to place a stop payment order on certain check numbers.

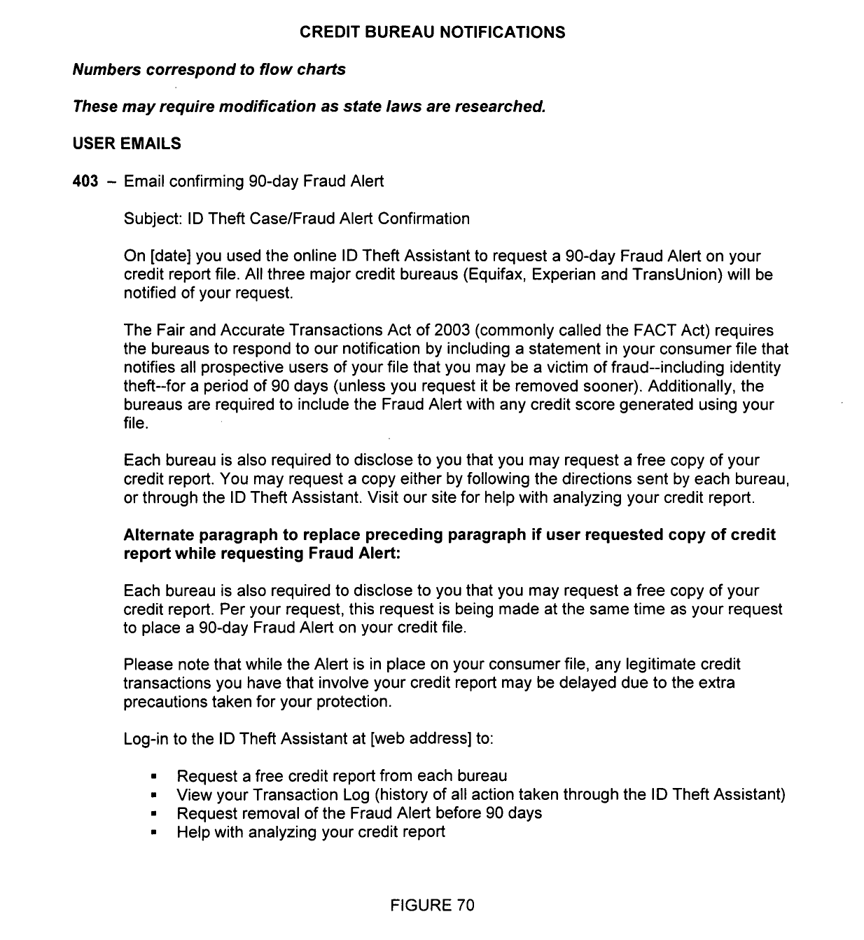

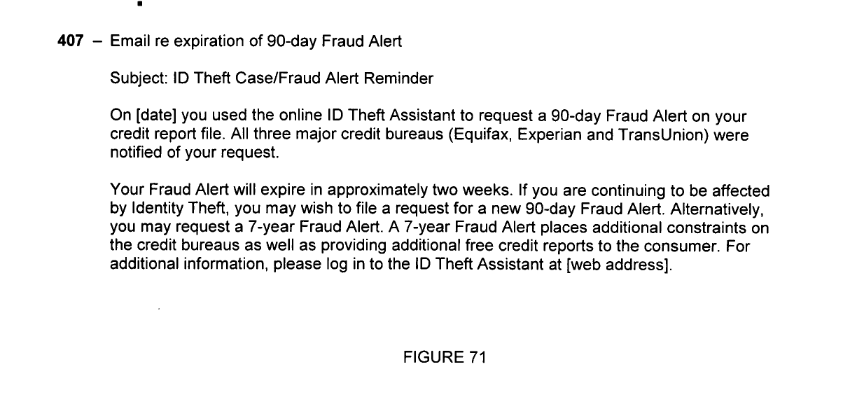

Regarding the credit bureau notification process, in FIG. 70 the System will send the user emails to confirm that a 90-day fraud alert was sent to all three major credit bureaus, and inform anyone using user's credit file that user may be a victim of fraud 403. At step 407, the System reminds the user that the 90-day fraud alert will expire in approximately two weeks and gives the user an opportunity to request a new 90-day fraud alert or alternatively, to issue a new seven year fraud alert.

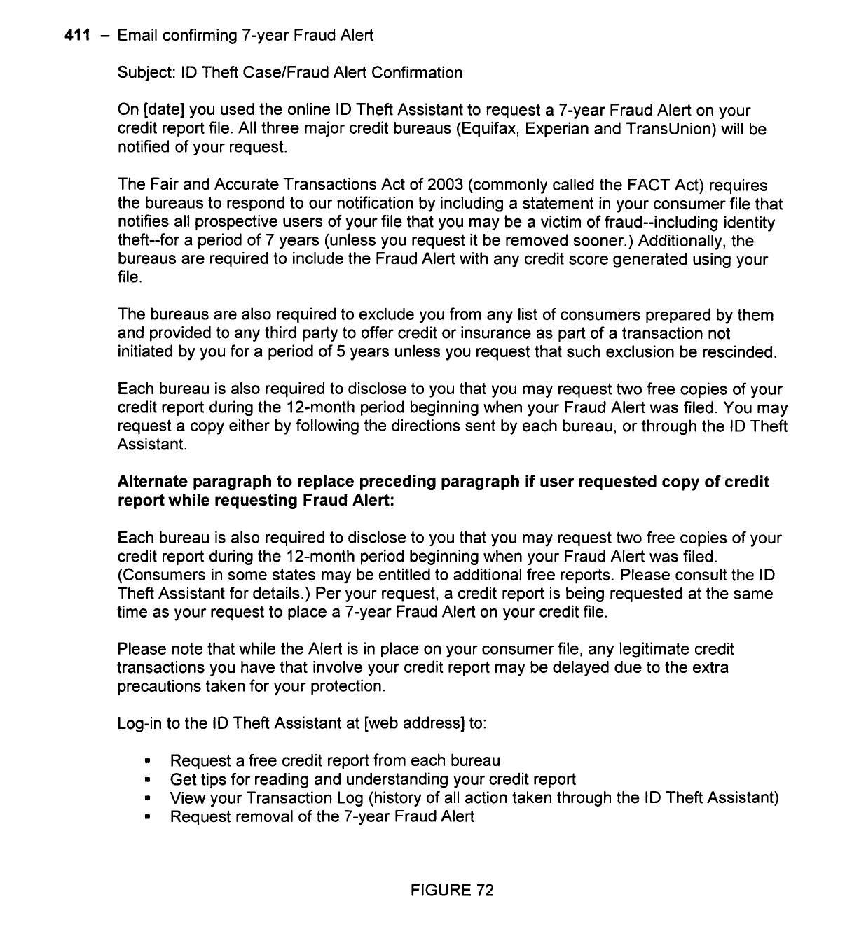

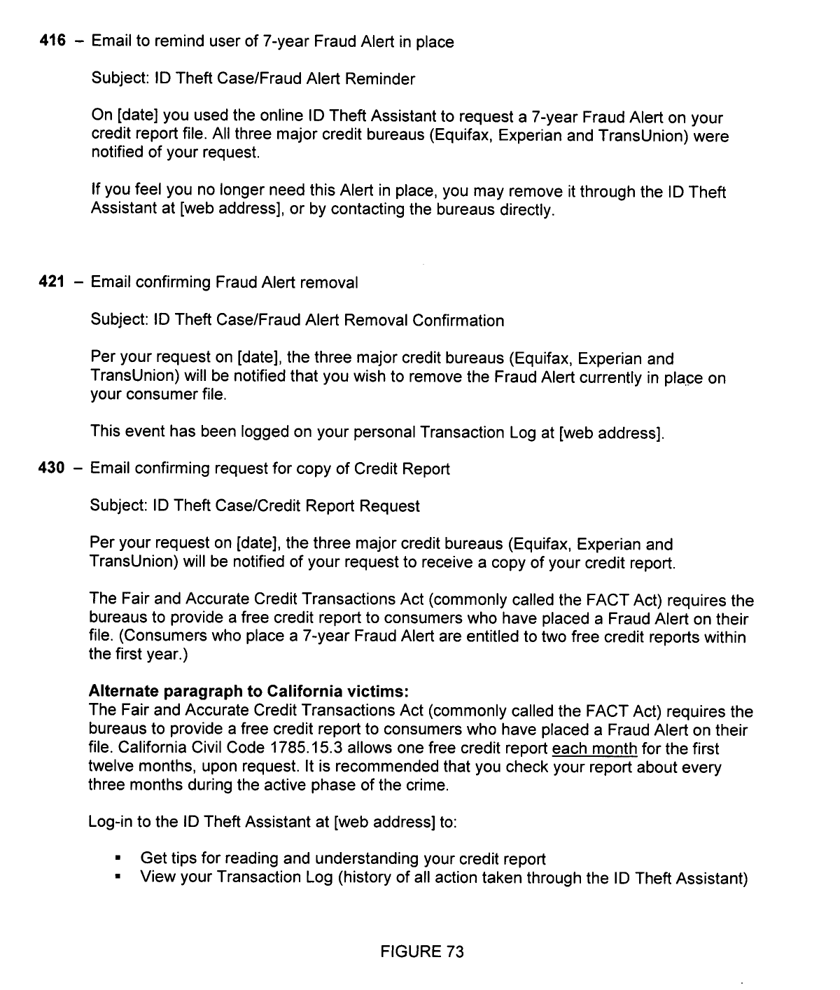

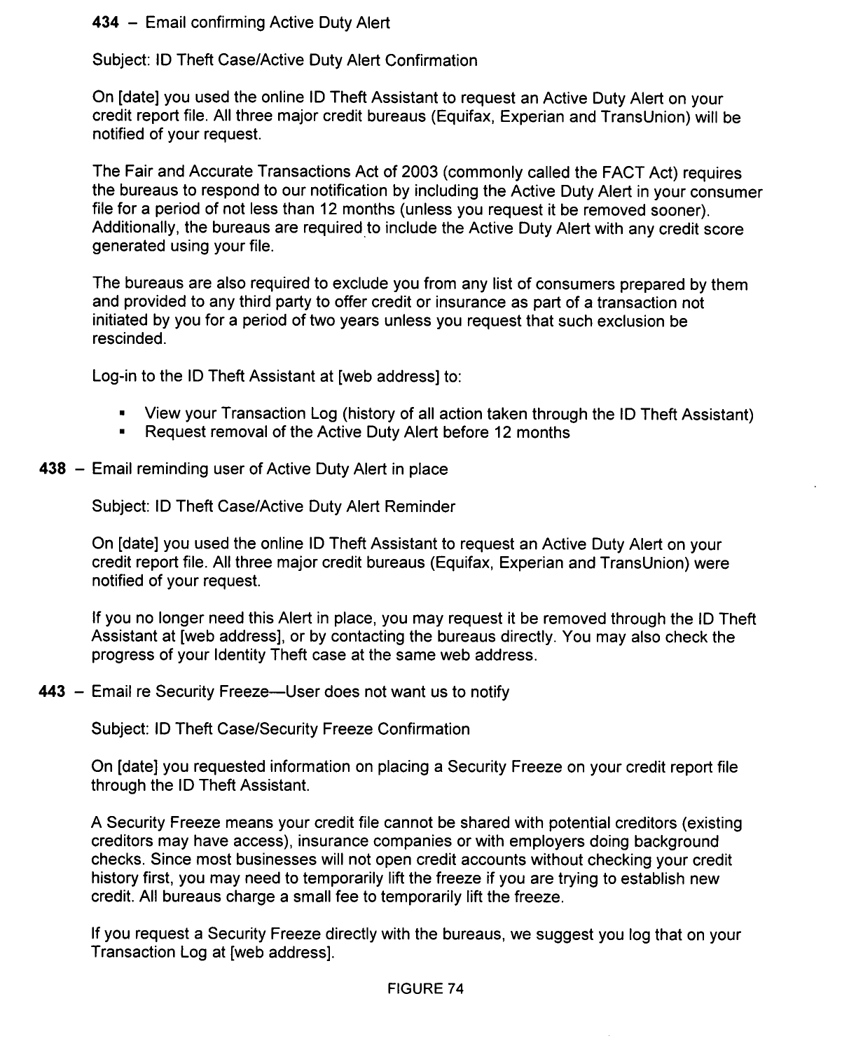

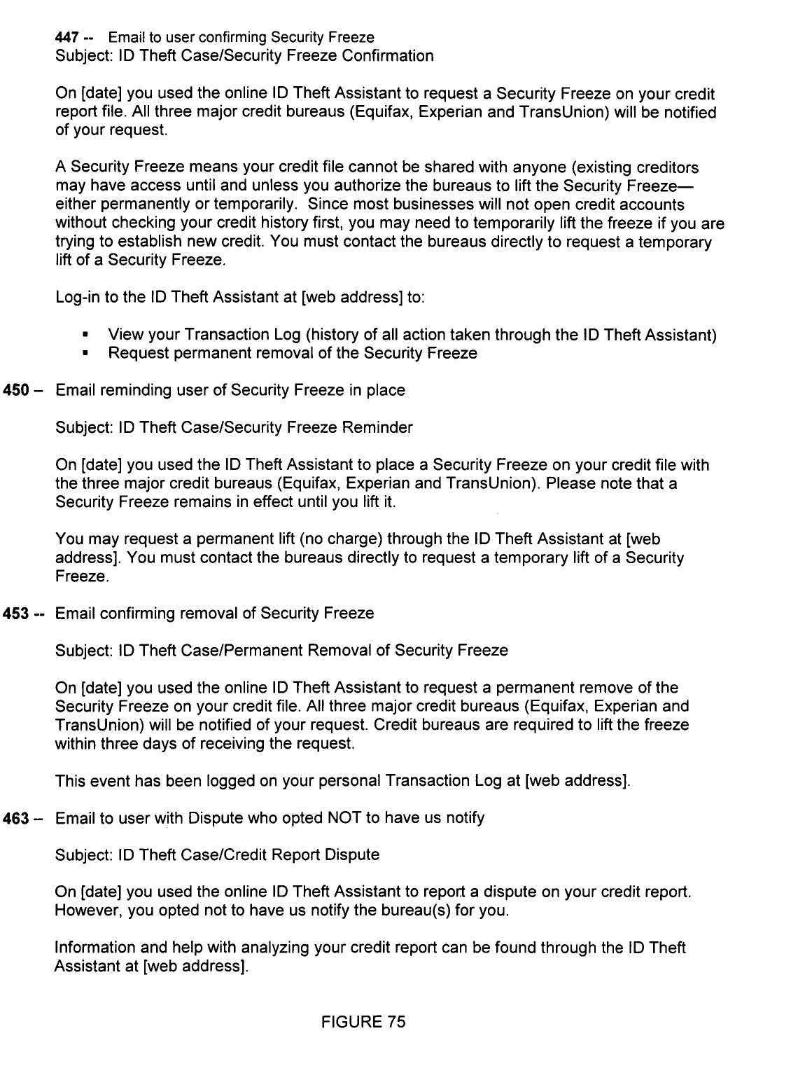

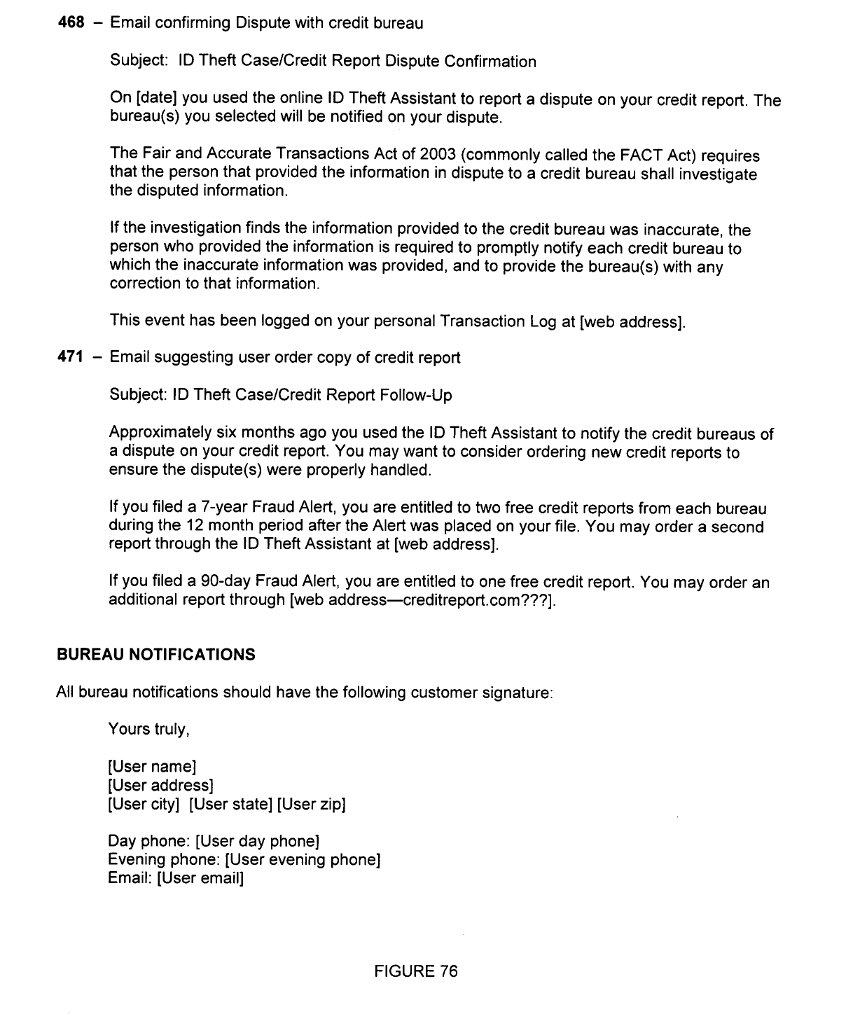

During the credit bureau notification process, the user will be sent email confirmations of the transaction, such as those shown in FIGS. 72-76 during steps 411, 416, 421, 430, 434, 438, 443, 447, 450, 453, 463, 468, and 471. Further, FIG. 76 shows the user the signature block that the System will automatically generate that will be used with all communications sent to the bureaus on behalf of the user.

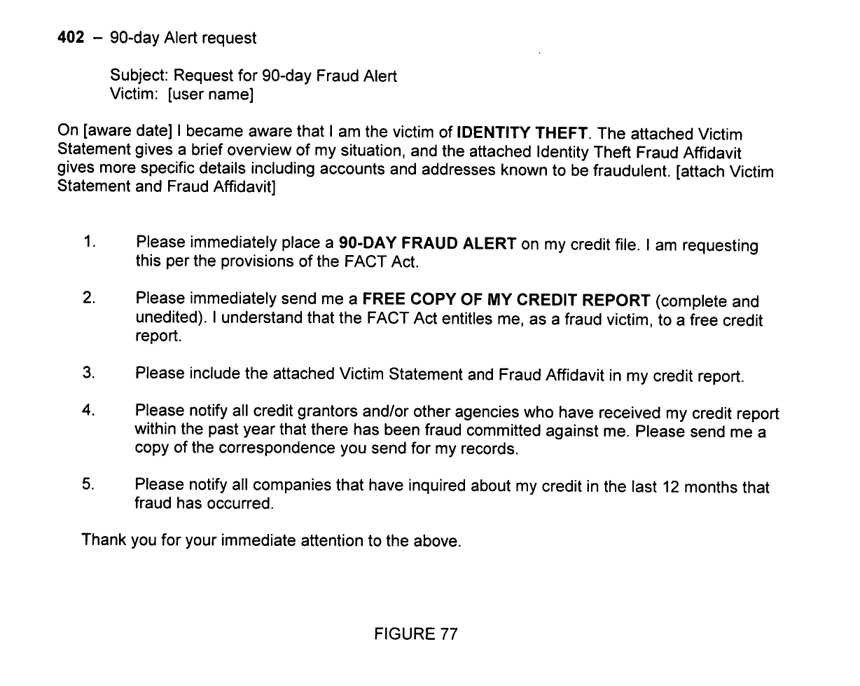

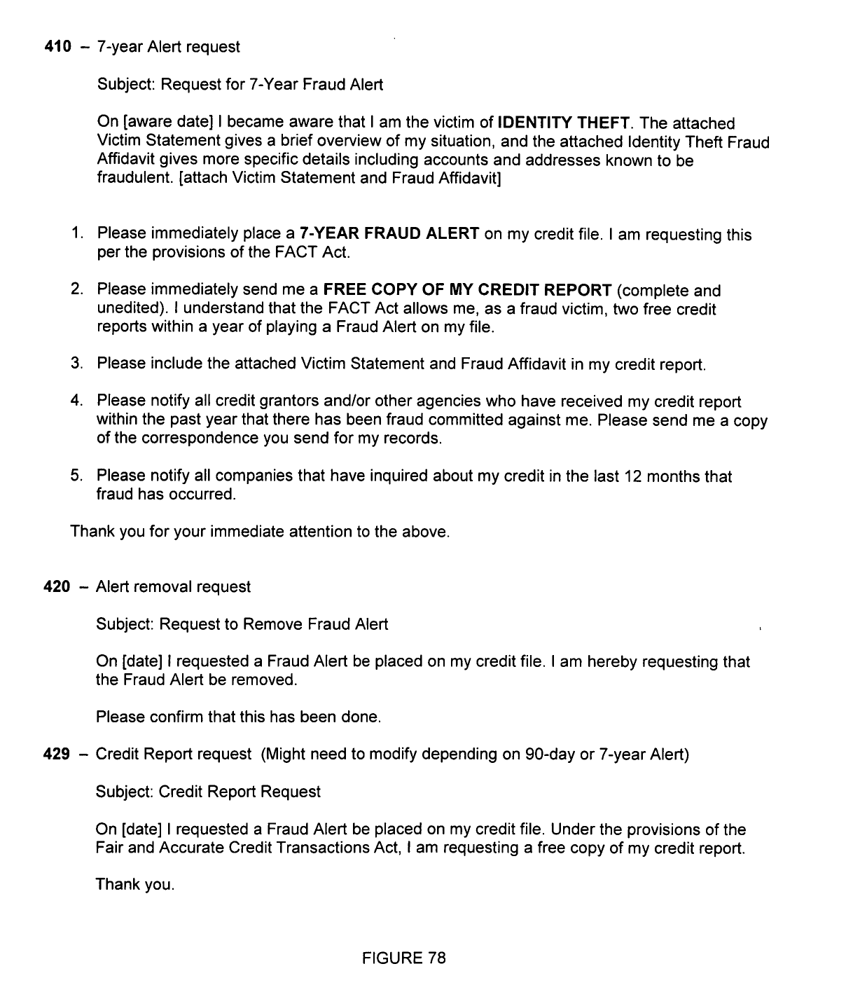

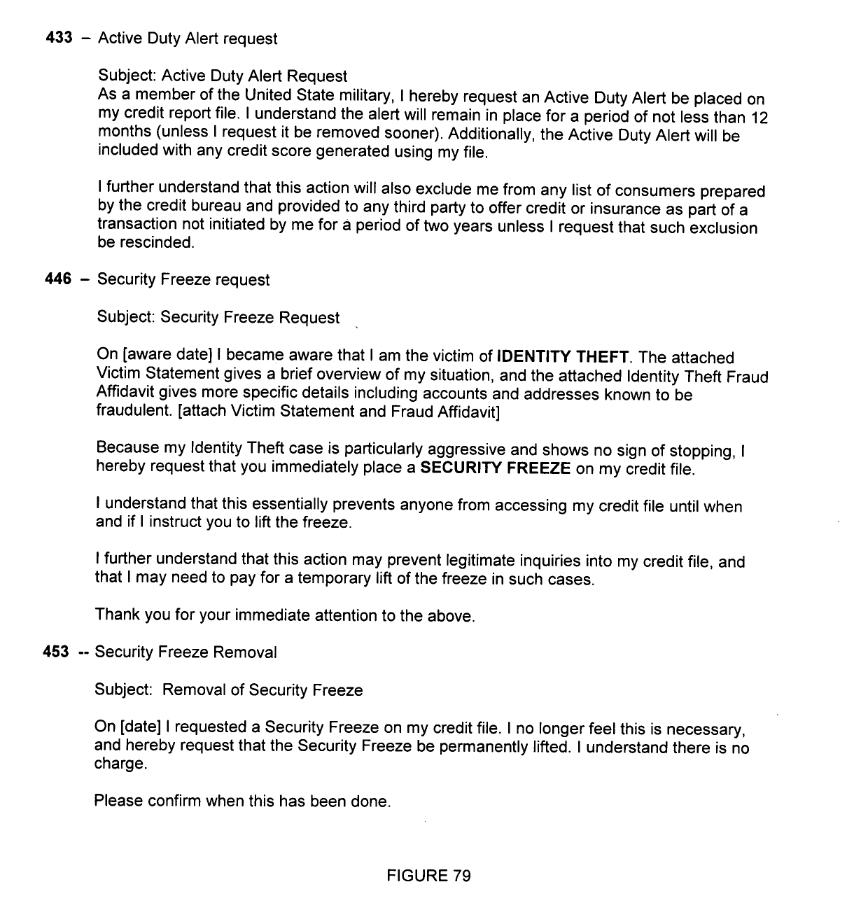

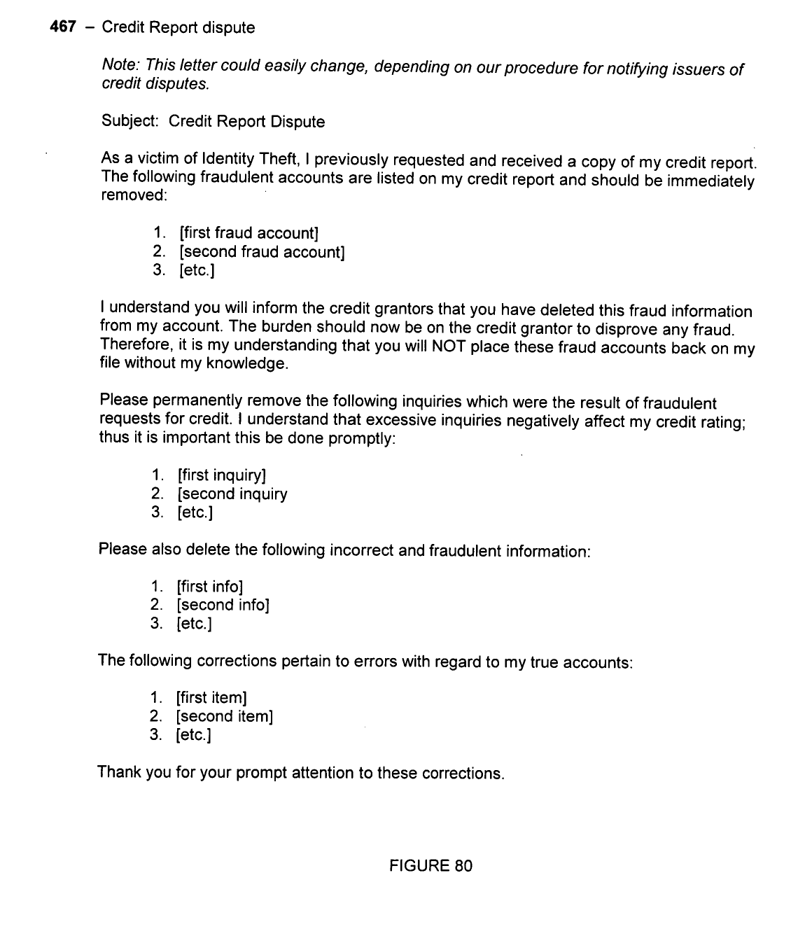

During the credit bureau notification process, as shown in FIG. 77, the System will generate template letters for the user to communicate with the bureaus. For instance, at step 402, the letter informs the bureau to immediately place a 90-day alert on user's credit file, and to immediately send user a free copy of their credit report. In addition, the letter asks the bureau to notify all credit grantors who have received user's credit report within the past year that there has been fraud committed against user. The user can also use the System to remove such fraud alerts, as shown FIG. 78. Further, the user may use the System to inform the bureaus to place a “security freeze” on their credit file (see FIG. 79). FIG. 80 shows a template letter that will be generated to the credit bureau which requests that they permanently remove inquiries that were the result of fraud.

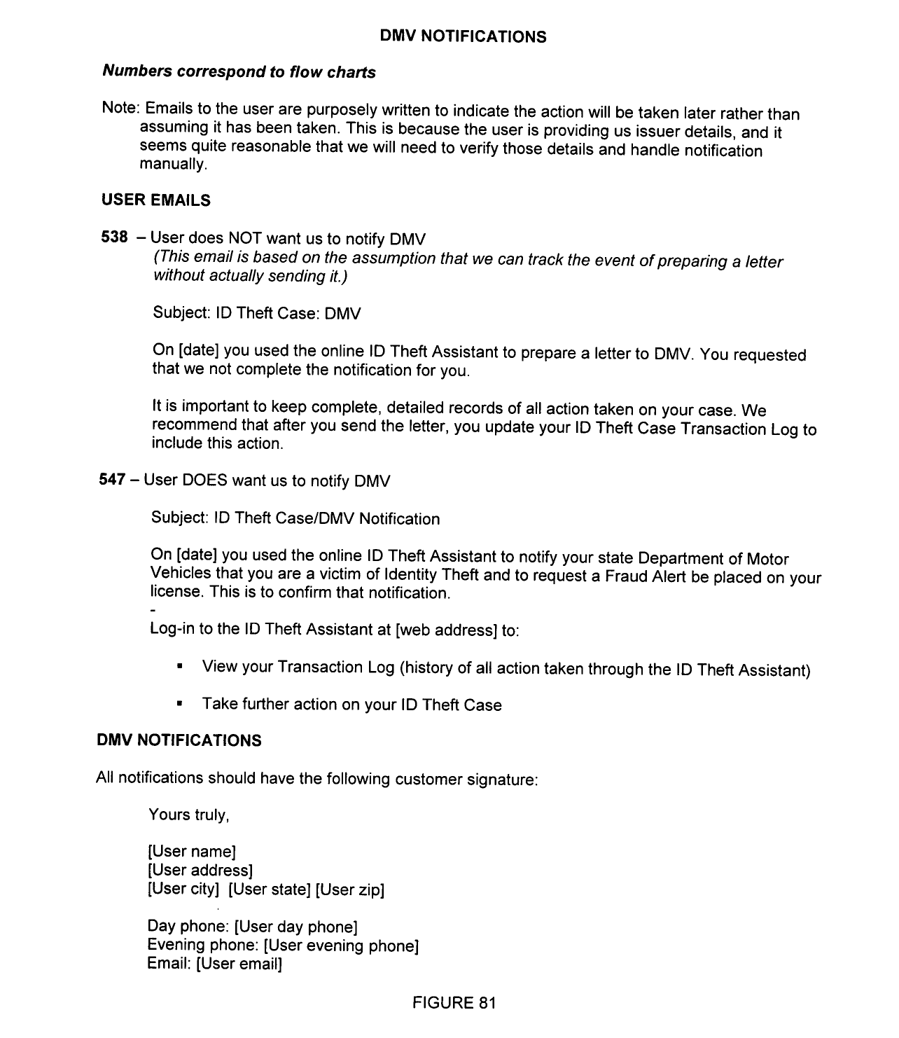

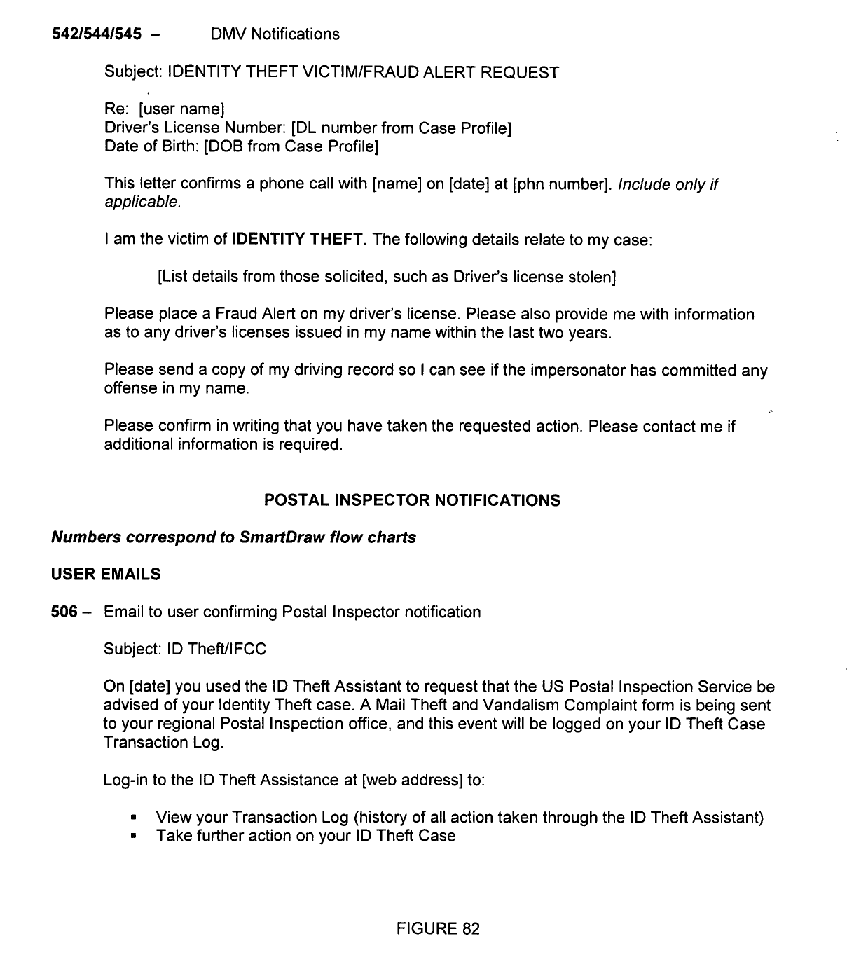

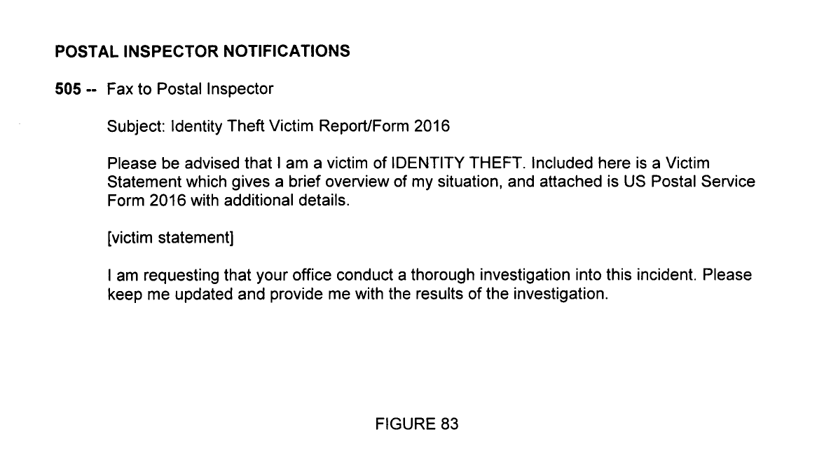

FIGS. 81 and 82 shows the DMV notifications, such as user email confirmations 538, 547, and 542/544/545, which are generated by the System. The system will also generate a signature block that will automatically be generated at the bottom of every communication sent by user in this process (see FIG. 81).

FIG. 82 shows a template email confirmation to be sent back to the user at step 506; while at step 505, the system generates a letter template that the user can use to notify the Postal Inspector.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A method of enabling a victim of identity theft to notify appropriate agencies, and to resolve and prevent future fraud comprising:
entering information into a system computer,
determining a case action plan, wherein said determination is made by said system based on said information,
displaying a case action plan onto a screen, wherein said case action plan is determined by said system,
selecting by a user a course of action to take based upon said case action plan,
completing, by said user, a service report, and
notifying an appropriate entity once said service report is transmitted back to said system.

2. The method of claim 1 further comprising the step of sending email notifications to said user when said user inputs certain information into said system computer.

3. The method of claim 2 further comprising the step of contacting a system representative by said user.

4. The method of claim 1 further comprising the step of displaying a plurality of web links pertinent to fraud on said system computer to said user.

5. The method of claim 1 further comprising the step of maintaining a plurality of transaction information persistent across multiple independent transaction sessions.

6. The method of claim 5 further comprising the step of uploading a plurality of documents onto said system.

7. The method of claim 5 further comprising the step of archiving said transactions.

8. The method of claim 6 further comprising the step of archiving said documents.

9. The method of claim 7 further comprising the step of printing said transactions.

10. The method of claim 4 further comprising the step of printing information found on said web links.

11. The method of claim 8 further comprising the step of printing said documents.

12. The method claim of 10 further comprising the step of printing information found on said web links.

13. A method of enabling a victim of identity theft to notify appropriate agencies, and to resolve and prevent future fraud comprising:
entering a plurality of information into a system computer via an internet connection,
determining a case action plan, wherein said determination is made by said system based on said information,
displaying a case action plan onto a web browser of a user, wherein said case action plan is determined by said system,
selecting by a user a course of action to take based upon said case action plan,
completing, by said user, a service report, and
notifying an appropriate entity once said service report is transmitted back to said system.

14. The method of claim 13, further comprising:
sending email notifications to said user when said user inputs certain information into said system computer, and
contacting a system representative by said user.

15. The method of claim 13, further comprising:
displaying a plurality of web links pertinent to fraud on said system computer to said user,
maintaining a plurality of transaction information persistent across multiple independent transaction sessions, and
uploading a plurality of documents onto said system.

16. A method of enabling a victim of identity theft to notify appropriate agencies, and to resolve and prevent future fraud comprising:
entering a plurality of information into a system computer via an internet connection,
determining a case action plan, wherein said determination is made by said system based on said information,
displaying a case action plan onto a web browser of a user, wherein said case action plan is determined by said system,
selecting by a user a course of action to take based upon said case action plan,
completing, by said user, a service report,
notifying an appropriate entity once said service report is transmitted back to said system.
sending email notifications to said user when said user inputs certain information into said system computer,
contacting a system representative by said user,
displaying a plurality of web links pertinent to fraud on said system computer to said user,
maintaining a plurality of transaction information persistent across multiple independent transaction sessions,
uploading a plurality of documents onto said system,
archiving said transactions and documents, and
printing said transactions and information on said web links.

17. An apparatus for enabling a victim of identity theft to notify appropriate agencies, and to resolve and prevent future fraud comprising:
a user;
a server communicating with the user via a communication link and including a database operative to store information from user and relating to identity theft;
a computer programmed to perform the following steps:
evaluate the information entered by the user into the database;
determine the appropriate response for user to take;
calculate the appropriate time for the user to take; and
notify the appropriate user and agency when required.

18. The apparatus of claim 17 wherein the user comprises a client computer.

19. The apparatus of claim 18 wherein the client computer comprises a wireless link.

20. The apparatus of claim 17 wherein the communication link connects server to the web.
